(19) United States
(12) Patent Application Publication
(10) Pub. No.: US 2009/0221341 A1
(43) Pub. Date: Sep. 3, 2009

(54) Gaming System with Interactive Feature and Control Method Thereof

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/358,691

(22) Filed: Jan. 23, 2009

Related U.S. Application Data
(60) Provisional application No. 61/028,085, filed on Feb. 12, 2008.

(51) Int. Cl. A63F 9/24; A63F 13/00

(52) U.S. Cl. 463/17; 463/30

(57) ABSTRACT

In a gaming system, a player's language is specified by a conversation with the player participating in a roulette game at a gaming terminal. Then, a game can be played interactively by using a conversation engine. In addition, in case where a message is transmitted from one gaming terminal to another gaming terminal, sound data of an utterance at the one gaming terminal are translated to the player's language of the other gaming terminal to be sent to the other gaming terminal and it is notified as sound data or text data. Therefore, message transmitting can be easily conducted between the gaming terminals at which different languages are used.

### CROSS-REFERENCE TO RELATED APPLICATION

This application is based upon and claims the benefit of U.S. Provisional Patent Application Ser. No. 61/028,085, filed on Feb. 12, 2008; the entire contents of which are incorporated herein by reference for all purposes.

### BACKGROUND OF THE INVENTION

1. Field of the Invention

The present invention relates to a gaming system including an engine for interactively advancing a game by a conversation with a player using sounds and texts as media, and a control method thereof.

2. Description of Related Art

United States patent application publication 2005/0059474, 2005/0282618 or 2005/0218590 discloses a gaming machine in which a player can participate in a game displayed on a communal display by operating a gaming terminal connected to the communal display via a network.

In such a gaming machine, the player operating the gaming terminal is accepted to participate in a game in synchronized timing with game procedures displayed on the communal display.

The present invention provides a new entertaining feature by making it easier for players using various languages to participate in a game.

### SUMMARY OF THE INVENTION

A first aspect of the present invention provides a gaming system that includes a host server and plural gaming terminals connected to the host server via a network. Each of the gaming terminals includes a display for displaying information on a game executed repeatedly, a microphone for being input an utterance by a player, a conversation engine for generating a reply to the input utterance by analyzing the utterance input into the microphone, a speaker for outputting the reply generated by the conversation engine, and a controller. The controller is operable to (A) get the conversation engine to specify a language used by the player based on a manual operation by the player or the input utterance, (B) execute a game according to a conversation with the player using the conversation engine corresponding to the language, (C) receive an input of a message to be sent to another gaming terminal and translate the input message into a language used in the other gaming terminal using a translating program, (D) send the translated message to the other gaming terminal and (E) provide a message sent from another gaming terminal to the player.

A second aspect of the present invention provides a gaming system that includes a host server and plural gaming terminals connected to the host server via a network. The host server is provided with a conversation database of plural languages and plural translating programs between each of the plural language and a reference language. Each of the gaming terminals includes a display for displaying information on a game executed repeatedly, a microphone for being input an utterance by a player, a conversation engine for generating a reply to the input utterance by analyzing the utterance input into the microphone with reference to the conversation database, a speaker for outputting the reply generated by the conversation engine, and a controller. The controller is operable to (A) get the conversation engine to specify a language used by the player based on a manual operation by the player or the input utterance, (B) execute a game according to a conversation with the player using the conversation engine corresponding to the language, (C) receive an input of a message to be sent to another gaming terminal and translate the input message into a language used in the other gaming terminal using the translating programs, (D) send the translated message to the other gaming terminal and (E) provide a message sent from another gaming terminal to the player.

A third aspect of the present invention provides a gaming system that includes a host server and plural gaming terminals connected to the host server via a network. The host server is provided with a conversation database of plural languages and plural translating programs between each of the plural language and a reference language. Each of the gaming terminals includes a display for displaying information on a game executed repeatedly, a storing unit for storing conversation data stored in the conversation database and the translating programs, a microphone for being input an utterance by a player, a conversation engine for generating a reply to the input utterance by analyzing the utterance input into the microphone with reference to the conversation database, a speaker for outputting the reply generated by the conversation engine, and a controller. The controller is operable to (A) get the conversation engine to specify a language used by the player based on a manual operation by the player or the input utterance, (B) read out conversation data and a translating program corresponding to the player's language from the host server and store the conversation data and the translating program in the storing unit, (C) execute a game according to a conversation with the player using the conversation engine, (D) receive an input of a message to be sent to another gaming terminal and translate the input message into a language used in the other gaming terminal using the translating programs, (E) send the translated message to the other gaming terminal and (F) provide a message sent from another gaming terminal to the player.

A fourth aspect of the present invention provides a control method of a gaming system that includes: specifying a language used by a player based on a manual operation or an input of an utterance into a microphone by a player at each of plural gaming terminals; executing, in each of the gaming terminals, a game interactively (in the game, the utterance input into the microphone is received, a reply to the input utterance is generated by a conversation engine and then the reply is output from a speaker as a sound in the game); and translating, in case where a message is to be sent from one gaming terminal to another gaming terminal, the message input in the one gaming machine into a language used in the other gaming machine and sending the translated message to the other gaming machine.

### BRIEF DESCRIPTION OF THE DRAWINGS

FIG. 1 is a flow chart showing a general process flow of game execution processing in a gaming system according to the present invention;

FIG. 2 is a perspective view showing a gaming terminal in an embodiment according to the present invention;

FIG. 3 is an apparent perspective view showing a general configuration of a roulette game machine in the embodiment according to the present invention;

FIG. 4 is a plan view of a roulette unit in the embodiment according to the present invention;

FIG. 5 is a screen image example displayed on a display of the gaming terminal shown in FIG. 2;

FIG. 6 is a block diagram showing an internal configuration of the roulette game machine in the embodiment according to the present invention;

FIG. 7 is a block diagram showing an internal configuration of the roulette unit in the embodiment according to the present invention;

FIG. 8 is a block diagram showing an internal configuration of the gaming terminal in the embodiment according to the present invention;

FIG. 9 is a functional block diagram showing a conversation controller according to an exemplary embodiment of the present invention;

FIG. 10 is a functional block diagram showing a speech recognition unit;

FIG. 11 is a timing chart showing processes of a word hypothesis refinement portion;

FIG. 12 is a flow chart showing process operations of the speech recognition unit;

FIG. 13 is a partly enlarged block diagram of the conversation controller;

FIG. 14 is a diagram showing a relation between a character string and morphemes extracted from the character string;

FIG. 15 is a table showing uttered sentence types, two-alphabet codes representing the uttered sentence types, and uttered sentence examples corresponding to the uttered sentence types;

FIG. 16 is a diagram showing details of dictionaries stored in an utterance type database;

FIG. 17 is a diagram showing details of a hierarchical structure built in a conversation database;

FIG. 18 is a diagram showing a refinement of topic identification information in the hierarchical structure built in the conversation database;

FIG. 19 is a diagram showing data configuration examples of topic titles (also referred as “second morpheme information”);

FIG. 20 is a diagram showing types of reply sentences associated with the topic titles formed in the conversation database;

FIG. 21 is a diagram showing contents of the topic titles, the reply sentences and next plan designation information associated with the topic identification information;

FIG. 22 is a diagram showing a plan space;

FIG. 23 is a diagram showing one example a plan transition;

FIG. 24 is a diagram showing another example of the plan transition;

FIG. 25 is a diagram showing details of a plan conversation control process;

FIG. 26 is a flow chart showing an example of a main process by a conversation control unit;

FIG. 27 is a flow chart showing a plan conversation control process;

FIG. 28 is a flow chart, continued from FIG. 27, showing the rest of the plan conversation control process;

FIG. 29 is a transition diagram of a basic control state;

FIG. 30 is a flow chart showing a discourse space conversation control process;

FIG. 31 is a flow chart showing gaming processings of a sever and the roulette unit in the roulette game machine of a first embodiment according to the present invention;

FIG. 32 is a flow chart showing gaming processings of a sever and the roulette unit in the roulette game machine of the first embodiment according to the present invention;

FIG. 33 is a flow chart showing game execution processing of the gaming terminal in the roulette game machine of the first embodiment according to the present invention;

FIG. 34 is a flow chart showing language confirmation processing shown in FIG. 33;

FIG. 35 is a flow chart showing betting period confirmation processing shown in FIG. 33;

FIG. 36 is a flow chart showing bet accepting processing shown in FIG. 33;

FIG. 37 is a screen image example displayed on the display;

FIG. 38 is a screen image example displayed on the display;

FIG. 39 is a screen image example displayed on the display;

FIG. 40 is a flow chart showing conversation database setting processing shown in FIG. 33;

FIG. 41 is a flow chart showing conversation translating program setting processing shown in FIG. 33;

FIG. 42 is a flow chart showing conversation sending processing shown in FIG. 33;

FIG. 43 is a flow chart showing confirmation processing of a destination terminal language shown in FIG. 42;

FIG. 44 is a flow chart showing conversation receiving processing shown in FIG. 33;

FIG. 45 is a flow chart showing another example of conversation receiving processing shown in FIG. 33;

FIG. 46 is a flow chart showing game execution processing of a gaming terminal in the roulette game machine of a second embodiment according to the present invention;

FIG. 47 is a flow chart showing conversation data download processing shown in FIG. 46;

FIG. 48 is a flow chart showing translating program download processing shown in FIG. 46;

FIG. 49 is a screen image example of a display 8;

FIG. 50 is a screen image example of the display 8;

FIG. 51 is a screen image example of the display 8;

FIG. 52 is a screen image example of the display 8;

FIG. 53 is a screen image example of the display 8;

FIG. 54 is a screen image example of the display 8; and

FIG. 55 is a screen image example of the display 8.

### DETAILED DESCRIPTION OF THE EMBODIMENT

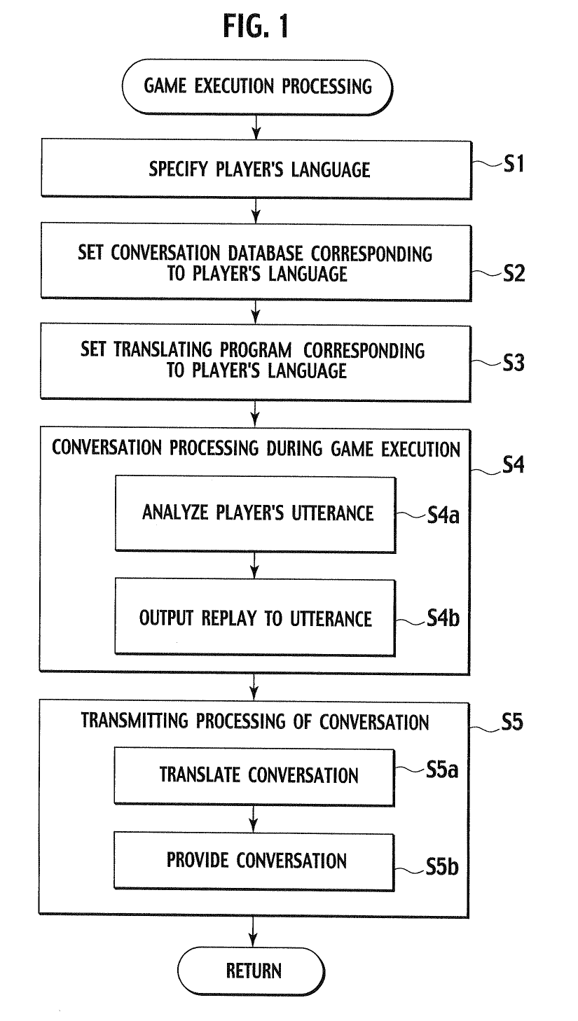

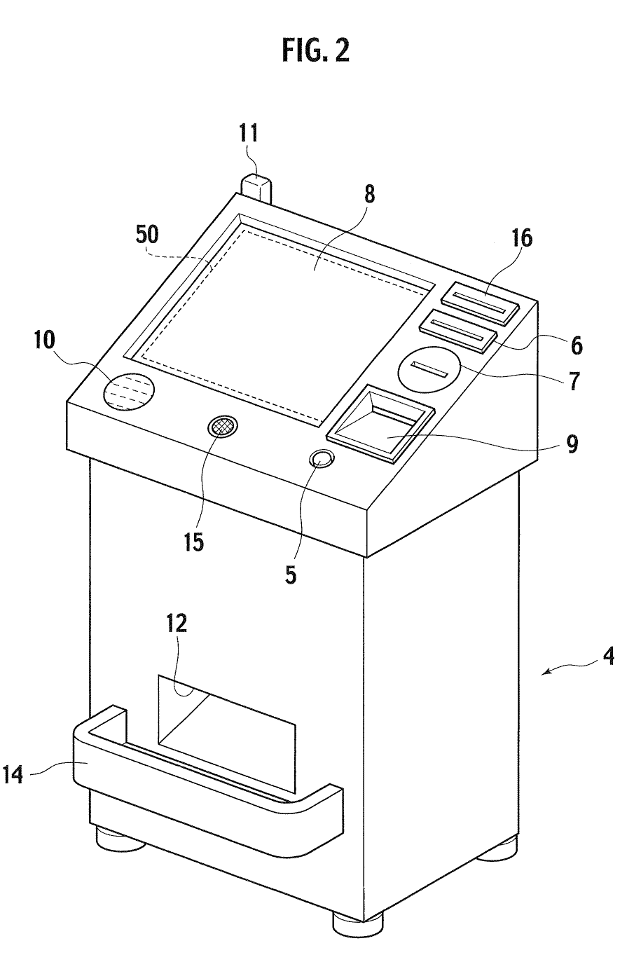

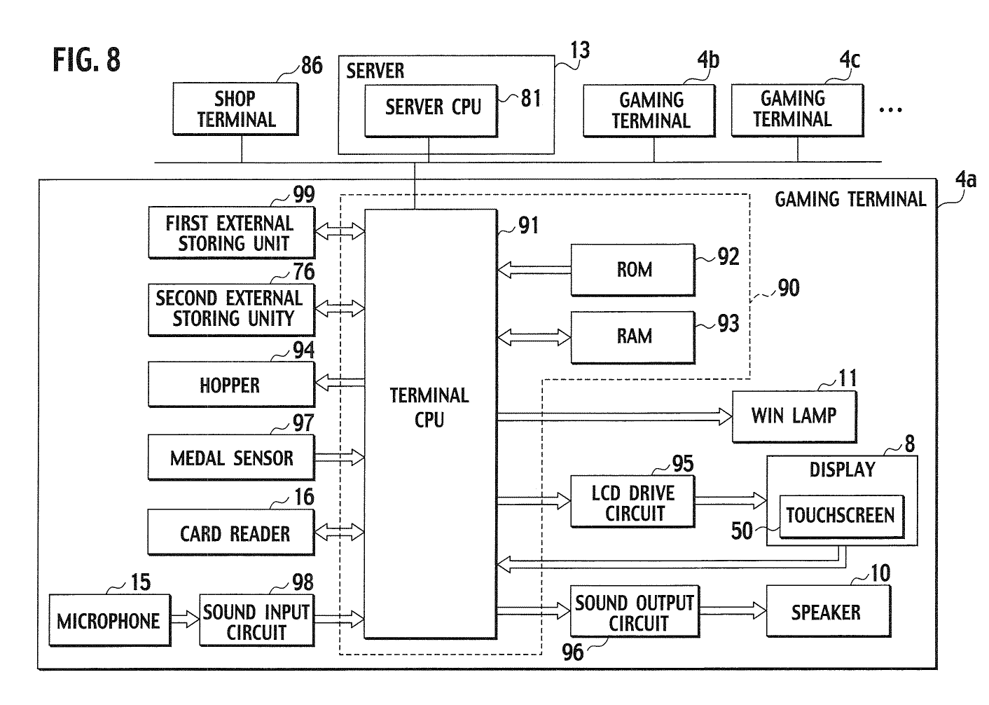

FIG. 1 is a flow chart showing a general process flow of game execution processing executed in a gaming system according to the present invention. FIG. 2 is a perspective view showing a gaming terminal 4 (4a to 4i) provided in a plurality in the gaming system according to the present invention. FIG. 8 is a block diagram showing an internal configuration of the gaming system. Hereinafter, the general process flow in the gaming system according to the present invention will be explained with reference to the drawings.

A terminal CPU 91 shown in FIG. 8 confirms a player's language on a gaming terminal 4a (here, the gaming terminal 4a is represented as an example) through a player's input operation or an after-mentioned conversation engine (step S1 in FIG. 1). A recognition processing of language will be explained later.

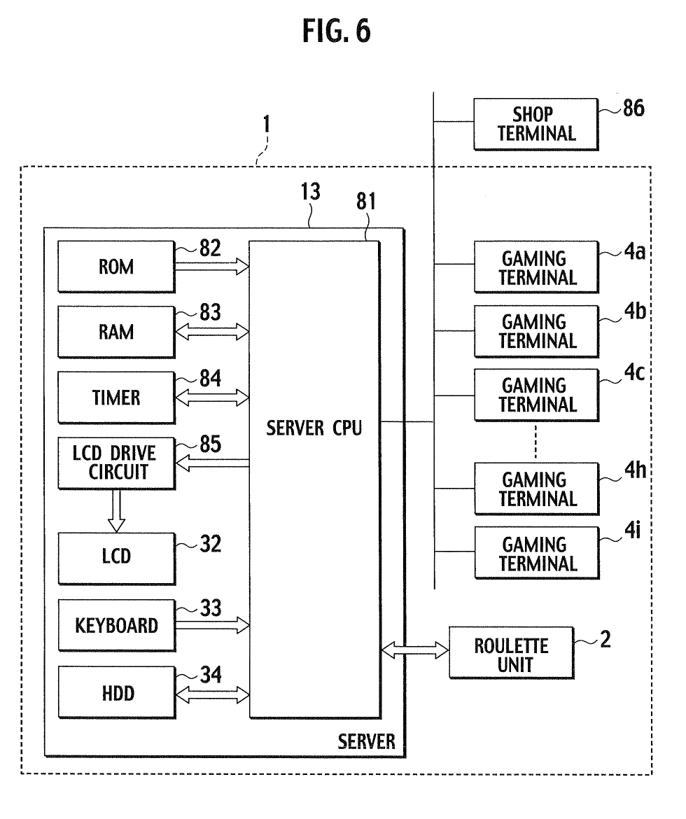

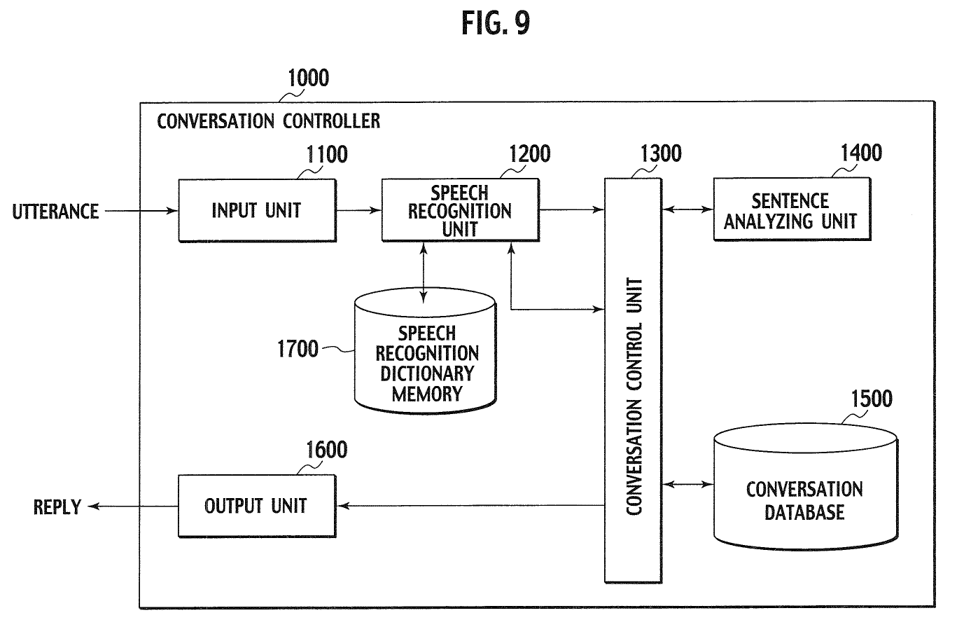

Next, the terminal CPU 91 configures a conversation database 1500 corresponding to the language confirmed in the process of step S1 among a conversation database 1500 (see FIG. 9) stored in a hard disc drive (HDD) 34 of a server 13 shown in FIG. 6 and corresponding to plural languages (step S2). For example, if the player's language is “Japanese”, a conversation database 1500 corresponding to “Japanese” is configured.

The terminal CPU 91 configures a translating program corresponding to the language confirmed in the process of step S1 from translating programs which are stored in the HDD 34 of the server 13 shown in FIG. 6 and correspond to plural languages (step S3). For example, if the player's language is “Japanese”, a “Japanese-English” translating program is configured.

Subsequently, the terminal CPU 91 executes a roulette game with conducting a conversation with the player using a conversation engine (step S4).

In a conversational processing during a roulette game execution, conversation data input into a microphone 15 of the gaming terminal 4a are analyzed (step S4a). Then, a reply to this conversation is generated by the conversation engine and the generated reply is output as sound from a speaker 10 (step S4b).

For example, if the player makes an utterance “Tell me how to place a bet! ” into the microphone 15, the conversation engine analyzes the utterance using the Japanese conversation database and outputs a reply sentence “please insert medals into a medal insertion slot or press bet buttons.” from the speaker 10 in Japanese. Since the terminal CPU 91 outputs the reply in the player's language, the player can easily understand the reply output from the gaming terminal 4a.

In addition, in the gaming system according to the present invention, utterance data can be transmitted from the gaming terminal 4a to another gaming terminal 4b (here, the gaming terminal 4b is represented as an example) (step S5). Specifically, in case where utterance data are transmitted to the gaming terminal 4b, the terminal CPU 91 acquires a player's utterance using the microphone 15 and further translates the utterance data into a player's language used at the gaming terminal 4b which is to be a destination (step S5a).

Then, the utterance data are converted into sound data and output from the speaker 10 in the gaming terminal 4b which received the utterance data. Alternatively, the utterance data are converted into document data and displayed on a display 8 (step S5b).

For example, if the player makes an utterance “Let me buy you something” at the gaming terminal 4a, the utterance data are translated into a player's language used at the gaming terminal 4b and then transmitted to the gaming terminal 4b. Therefore, players using different languages at respective gaming terminals 4 can easily have a conversation with each other.

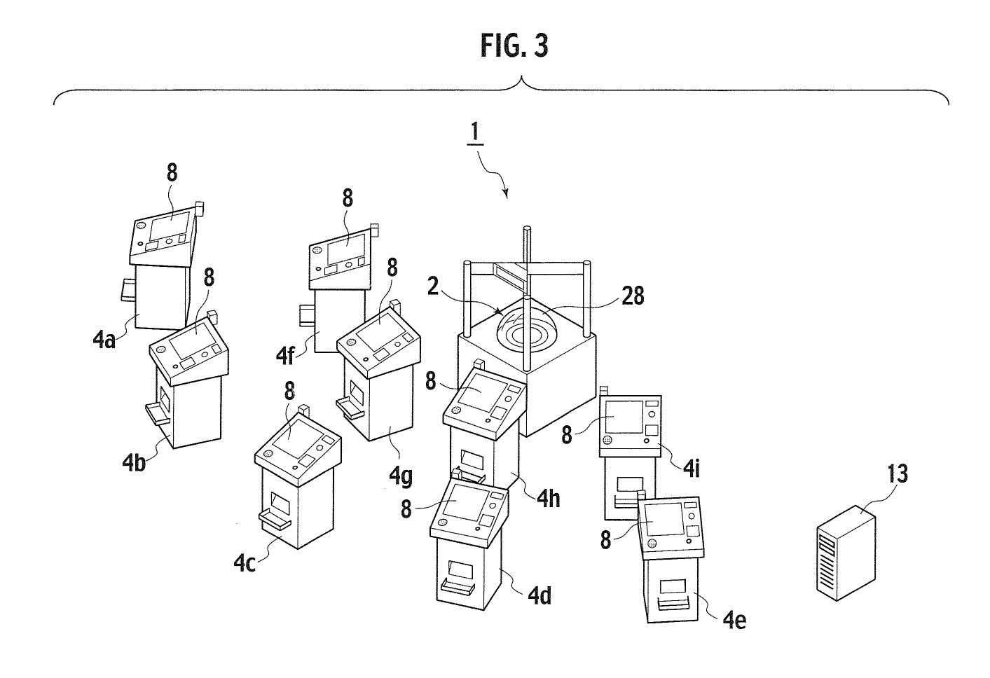

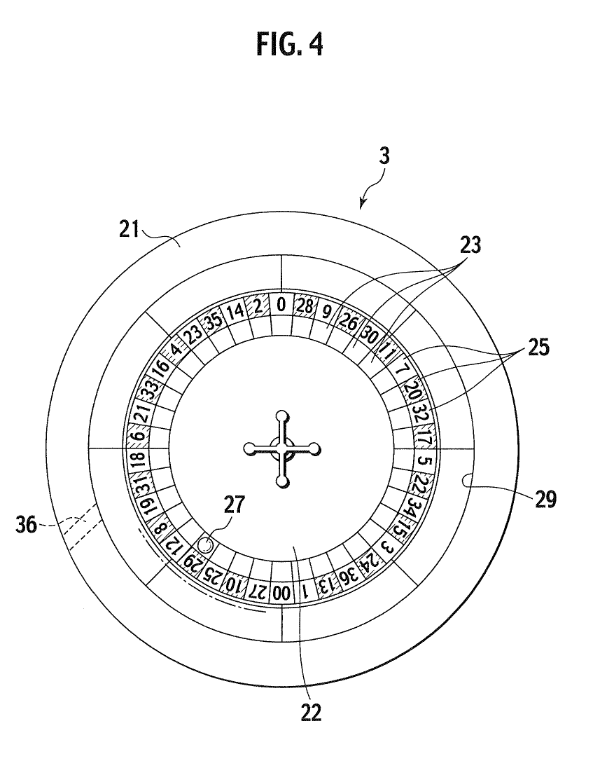

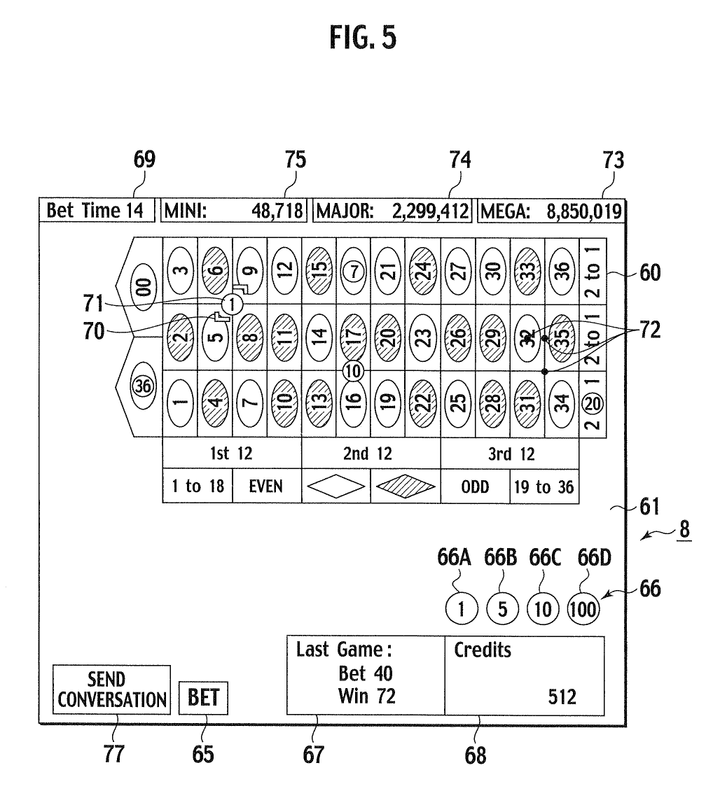

Next, a gaming system in an embodiment according to the present invention will be explained in detail. FIG. 2 is a perspective view showing a gaming terminal in a first embodiment according to the present invention. FIG. 3 is an apparent perspective view showing a general configuration of a roulette game machine 1 including the gaming terminal shown in FIG. 2, which is an example of the gaming system of the embodiment according to the present invention. FIG. 4 is a plan view of a roulette unit 2 provided in the roulette game machine 1. FIG. 5 is a screen image example displayed on a display of the gaming terminal shown in FIG. 2.

Plural (nine in the drawing) gaming terminals 4 (4a to 4i) in the first embodiment shown in FIG. 2 are provided as parts of the roulette game machine 1 shown in FIG. 3. In addition, the roulette game machine 1 includes the roulette unit 2 and a server (host server) 13. Each of the gaming terminals 4, the roulette unit 2 and the server 13 can be connected each other via a local network and so on. Furthermore, in the present embodiment, each of the gaming terminals 4 are connected with a shop terminal 86 (see FIG. 8) for serving beverages and foods to players via the local network.

At the roulette unit 2, the roulette game will be executed under the control of the server 13, and the game can be visible by players. Players use the gaming terminals 4 which are arranged around the roulette unit 2 to participate in a roulette game displayed by the roulette unit 2. In the present embodiment, the roulette game machine 1 includes the nine gaming terminals 4. Therefore, up to nine players can participate in a communal roulette game simultaneously.

A roulette game displayed on the roulette unit 2 is executed repeatedly at prescribed time intervals under the control of the server 13. Accordingly, a player who participates in a game play with each of the gaming terminals 4 can place a bet for a current roulette game. A display 8 is provided at each of the gaming terminals 4 for placing the bet on the current roulette game. A betting screen 61 (see FIG. 5) for betting on a roulette game is displayed on the display 8. Displayed contents on the betting screen 61 will be explained later in detail.

FIG. 4 is a plan view of the roulette unit provided in the roulette game machine shown in FIG. 3. As shown in FIG. 4, the roulette unit 2 includes a frame 21 and a roulette wheel 22 which is accommodated and supported rotatably inside the frame 21. Plural number pockets 23 (thirty-eight in total in the present embodiment) are formed on an upper surface of the roulette wheel 22. In addition, number plates 25 are provided on an upper surface of the roulette wheel 22 outside the number pockets 23 for displaying numbers “0”, “00” and “1” to “36” in correspondence to the respective number pockets 23.

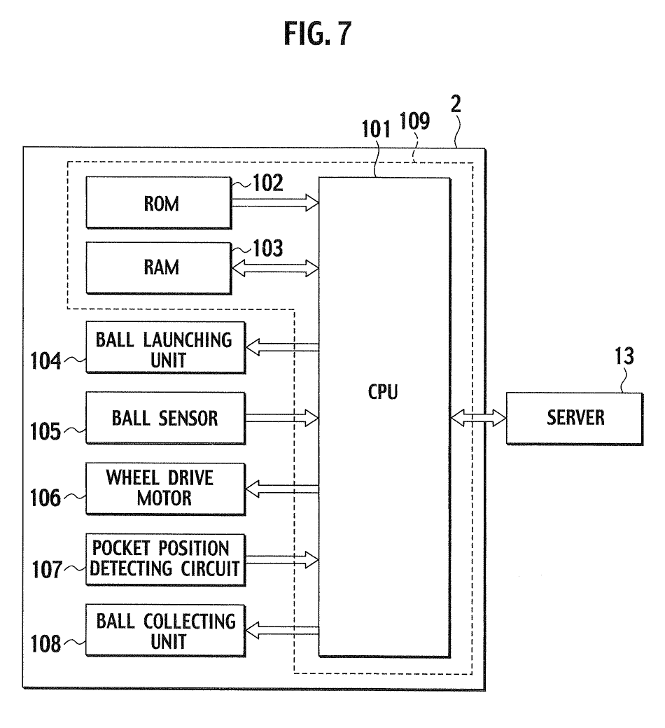

A ball launching port 36 is provided inside the frame 21. A ball launching unit 104 (see FIG. 7) is coupled with the ball launching port 36. With driving the ball launching unit 104, a ball 27 is launched from the ball launching port 36 onto the roulette wheel 22. In addition, the entire roulette unit 2 is covered by a hemispherical transparent acrylic cover 28 (see FIG. 3) covers over.

A wheel drive motor 106 (see FIG. 7) is provided beneath the roulette wheel 22. As the wheel drive motor 106 is driven, the roulette wheel 22 spins. Metal plates (not shown) are attached on a back surface of the roulette wheel 22 with space apart each other at prescribed intervals. A proximity sensor of a pocket position detecting circuit 107 (see FIG. 7) detects these metal plates to detect the positions of the number pockets 23.

The frame 21 is moderately inclined toward its inner side and the guide wall 29 is formed around an intermediate circumference of the frame 21. The guide wall 29 guides the launched ball 27 to spin with counter working a centrifugal force of the ball 27. The ball 27, as its velocity slows down, loses its centrifugal force and rolls down on the inclined surface of the frame 21. And then, the ball 27 reaches the spinning roulette wheel 22 and gets across the number plates 25. The ball 27 falls into one of the number pockets 23. As a result, the number of the number plate 25 corresponding to the number pocket 23 into which the ball 27 has fallen, is detected by a ball sensor 105 and determined as a winning number.

Next, the configuration of the gaming terminal 4 will be explained.

As shown in FIG. 2, the gaming terminal 4 includes at least a medal insertion slot 7 for inserting game media having currency values such as cash, chips, medals and so on, and the above-mentioned display 8 for displaying images related to the game on its upper surface. The gaming terminal 4 accepts a player's betting operation via the medal insertion slot 7 and the display 8. A player can advance a displayed game by operating a touchscreen 50 (see FIG. 8) provided on an upper surface of the display 8 and so on while watching the images displayed on the display 8. Note that, in the following explanation, the game media may be referred as their representative “medals”.

In addition to the medal insertion slot 7 and the display 8 described above, a payout button 5, a ticket printer 6, a bill insertion slot 9, a speaker 10, a microphone 15 and a card reader 16 are provided on the upper surface of the gaming terminal 4. A medal payout chute 12 and a medal tray 14 are provided on a front face of the gaming terminal 4.

The payout button 5 is a button for inputting a command for paying out credited medals from the medal payout chute 12 onto the medal tray 14. The ticket printer 6 prints out a bar code ticket including the data such as the credits, the date, and the identification number of the gaming terminal 4. A player can use the bar code ticket at another gaming terminal 4 to place a bet on a game at that gaming terminal 4 or can exchange the bar code ticket to bills and so on at a prescribed location in a gaming facility (for example, a cashier in a casino).

The bill insertion slot 9 judges the legitimacy of bills and accepts legitimate bills. The speaker 10 outputs music, effect sounds, sound messages for a player and so on. The microphone 15 collects sound messages uttered by a player.

A smart card can be inserted into the card reader 16. The card reader 16 reads data from the inserted smart card and writes data into the inserted card. The smart card is carried by a player and corresponds to the player's member's card, credit card or the like.

A smart card stores data about playing history played by a player (playing history data) together with data for identifying the player. Information on game kinds played, points provided in played games, language kind used by the player in game plays and so on are included in the playing history data. Data equivalent to coins, bills or credits may be stored in a smart card. Read-from/write-into method with a smart card may employ contact type or non-contact type (RFID type) Alternatively, a magnetic stripe card may be employed.

A WIN lamp 11 is provided on an upper portion of the display 8 of each gaming terminal 4. In the case where the number (“0”, “00” and “1” to “36” in the present embodiment) on which a bet has been placed at the gaming terminal 4 in a game comes to a winning number, the WIN lamp 11 of the winning gaming terminal 4 will be turned on. In addition, in the jackpot (referred hereafter also as JP) bonus game for awarding JP, the WIN lamp 11 of the JP winning gaming terminal 4 will be turned on similarly. Note that the WIN lamp 11 is provided at a position that is visible from all of the arranged gaming terminals 4 (nine in the present embodiment) so that other players playing at the same roulette game machine 1 can always check turning-on of the WIN lamp 11.

A medal sensor 97 (see FIG. 8) is provided inside the medal insertion slot 7. The medal sensor 97 identifies medals inserted into the medal insertion slot 7 and counts the inserted medals. In addition, a hopper 94 (see FIG. 8) is provided inside the medal payout chute 12. The hopper 94 payouts a prescribed number of medals from the medal payout chute 12.

FIG. 5 is a diagram showing a screen image example displayed on the display 8. A betting screen 61 shown in FIG. 5 is displayed on the display 8 on each of the gaming terminals 4. The betting screen 61 includes a table-type betting board 60. A player can place a bet by operating a touchscreen 50 (see FIG. 8) provided on a front surface of the display 8, by using own chips, which are credited as an electronic data in the gaming terminal 4.

Specifically, a player pointed out a bet area 72 (in a section of a number or a section of a number's mark, or on a grid line(s)) to place a chip for betting by a cursor 70. Then, a bet chip amount is set by bet buttons 66 and the bet chip amount is fixed by a bet fixing button 65. These setting and fixing are executed by player's fingers directly touching on the bet areas 72, the bet buttons 66 and bet fixing button 65 displayed on the display 8.

Note that the bet buttons 66 are provided with four kinds of buttons, a one-bet button 66A, a five-bet button 66B, a ten-bet button 66C and a one-hundred-bet button 66D for a bet chip amount capable of being placed by one operation.

A payout counter 67 displays a player's bet chip amount and a payout credits amount for a payout in the last game. In addition, a credit counter 68 displays the current credits owned by a player. Furthermore, a bet time counter 69 displays remaining time in which a player can place a bet.

Note that the next game starts at the time when the ball 27 launched onto the roulette wheel 27 fell into any one of the number pockets 23 and the current game has ended.

A MEGA counter 73 displaying a credit amount accumulated for a “MEGA” JP, a MAJOR counter 74 displaying a credit amount accumulated for a “MAJOR” JP and a MINI counter 75 displaying the number of credits accumulated for a “MINI” JP are provided at the right side of the bet time counter 69. If any one of the JP's is won in a JP bonus game, a credit amount is awarded according to the winning JP among the JP's displayed on the counters 73 to 75 and then an initial value (200 credits for “MINI”, 5000 credits for “MAJOR” and 50000 credits for “MEGA”) is displayed the corresponding counter.

In addition, a conversation send button 77 is provided on the display 8. A player at one of the gaming terminals 4a can send a message to another player at another of the gaming terminals 4 (for example, 4b) by touching the conversation send button 77. In this case, the message can be sent by an after-mentioned translating processing even though the languages used by the two players are different each other.

FIG. 6 is a block diagram showing an internal configuration of the roulette game machine 1 according to the present embodiment. As shown in FIG. 6, the roulette game machine 1 is configured with the server 13, the roulette unit 2 connected to the server 13 via the local network and the plural gaming terminals 4 (nine in the present embodiment). Further, the local network is laid in a hall and the shop terminal 86 provided in a shop for serving beverages and foods to players is connected thereto. Note that an internal configuration of the roulette unit 2 and an internal configuration of the gaming terminals 4 (4a to 4i) will be described later in detail.

The server 13 shown in FIG. 6 includes a server CPU 81 for executing the overall control of the server 13, a ROM 82, a RAM 83, a timer 84, an LCD (liquid crystal display) 32 connected via an LCD driving circuit 85, a keyboard 33 and the HDD 34.

The server CPU 81 executes various processings according to input signals supplied from the gaming terminals 4 and data and programs stored in the ROM 82 and the RAM 83. In addition, the server CPU 81 sends command signals to the gaming terminals 4 according to the processing results to control the gaming terminals 4 under its initiative. Specifically, the server CPU 81 transmits control signals to the roulette device 2 to control launching of the ball 27 and spinning of the roulette wheel 22.

The ROM 82 is configured by a semiconductor memory or the like and stores programs which implement basic functions of the roulette game machine 1, programs which execute notification of maintenance time and setting/management of notification condition, odds data of a roulette game (payout credits per one chip at winning), programs for controlling the gaming terminals 4 under their initiatives and so on.

In addition, the RAM 83 temporarily stores a chip-betting information supplied from each of the gaming terminals 4, a winning number of the roulette unit 2 detected by the sensor, an accumulated JP credits, data on results of processings executed by the server CPU 81 and so on.

Furthermore, the timer 84 for counting time is connected to the server CPU 81. Time information of the timer 84 is transmitted to the server CPU 81. The server CPU 81 executes controls of spinning the roulette wheel 22 and launching the ball 27 based on the time information of the timer 84.

The HDD 34 stores translating programs between English, which is set as a reference language, and various other languages. For example, plural translating programs are stored such as a “Japanese-English” translating program, a “Chinese-English” translating program or a “French-English” translating program. Note that, although an example case is explained in the present embodiment where “English” is represented as the reference language, the reference language is not limited to English but may be any other language. In addition, translating programs between two languages except the reference language may be prepared such as “Japanese-Chinese”.

Furthermore, the HDD 34 stores conversation data to be used in the conversation engine explained later. In other words, the HDD 34 includes a function as the conversation database 1500 shown in FIG. 9. The conversation database stores conversation data used at generating a reply sentence to a player by the conversation engine and is provided for each of the plural languages. For example, a conversation database for English, a conversation database for Japanese, a conversation database for Chinese and so on are provided.

FIG. 7 is a block diagram showing an internal configuration of the roulette unit 2 according to the present embodiment. As shown in FIG. 7, the roulette unit 2 includes a controller 109, the pocket position detecting circuit 107, the ball launching unit 104, the ball sensor 105, the wheel drive motor 106 and a ball collecting device 108.

The controller 109 includes a CPU 101, a ROM 102 and a RAM 103. The CPU 101 controls launching the ball 27 and spinning the roulette wheel 22 based on control commands supplied from the server 13 and data and programs stored in the ROM 102 and the RAM 103.

The pocket position detecting circuit 107 includes the proximity sensor to detect spinning position of the roulette wheel 22 by detecting the metal plates attached onto the roulette wheel 22.

The ball launching unit 104 is a unit for launching the ball 27 onto the roulette wheel 22 from the ball launching port 36 (see FIG. 4). The ball launching unit 104 launches the ball 27 at the initial speed and the timing set in a control data.

The ball sensor 105 is a unit for detecting the number pocket 23 into which the ball 27 has fallen. The wheel drive motor 106 is a unit for spinning the roulette wheel 22 and it stops its spinning when a motor driving time set in the control data has elapsed since a start of the driving.

FIG. 8 is a block diagram showing an internal configuration of the gaming terminal according to the present embodiment. Note that each of the nine gaming terminals 4 (4a to 4i) has an identical configuration basically and the gaming terminal 4a will be explained as the representative hereinafter.

As shown in FIG. 8, the gaming terminal 4a includes a terminal controller 90 configured by a terminal CPU 91, a ROM 92 and a RAM 93. The ROM 92 is configured by a semiconductor memory or the like. The ROM 92 stores programs which implement basic functions of the gaming terminal 4a, various programs which are necessary for controlling the gaming terminal 4a, data tables and so on. In addition, the RAM 93 is a memory for temporarily storing various data calculated by the terminal CPU 91, a credit amount currently owned by the player (deposited at the gaming terminal 4a), a player's betting status, a flag F for indicating whether or not during the betting period and so on.

A payout button 5 (see FIG. 2) is connected to the terminal CPU 91. The payout button 5 is a button to be pressed by a player usually when the game is over. Medals will be paid out from the medal payout chute 12 according to credits which have been provided in games and currently owned by the player (usually one medal for one credit) when the payout button 5 is pressed by the player.

In addition, the terminal CPU 91 receives command signals from the sever CPU 81 and controls peripheral devices constituting the gaming terminal 4a, so as to proceed with the game at the gaming terminal 4a. Furthermore, the terminal CPU 91 executes various processings according to the above-mentioned input signals and data and programs stored in the ROM 92 and the RAM 93 depending on the processing contents. The terminal CPU 91 controls the peripheral devices constituting the gaming terminal 4a according to the processing results, so as to proceed with the game.

In addition, the hopper 94 is connected to the terminal CPU 91. The hopper 94 payouts a prescribed number of medals from the medal payout chute 12 (see FIG. 3) according to a command signal from the terminal CPU 91.

Furthermore, the display 8 is connected to the terminal CPU 91 via an LCD drive circuit 95. The LCD drive circuit 95 includes a program ROM, an image ROM, an image control CPU, a work RAM, a VDP (Video Display Processor) and a video RAM. The program ROM stores image control programs and various selection tables for displaying on the display 8. The image ROM stores dot data for forming images to be displayed on the display 8, for example. The image control CPU determines images to be displayed on the display 8 among the dot data in the image ROM according to the image control programs stored in the program ROM based on parameters set up in the terminal CPU 91. The work RAM is provided as a temporary memory unit during an execution of the image control programs by the image control CPU. The VDP forms screen images according to the display contents determined by the image control CPU and outputs them to the display 8. Note that the video RAM is provided as a temporary memory unit during the VDP forming screen images.

In addition, the touchscreen 50 is attached on the front surface of the display 8. Information of a player's operation onto the touchscreen 50 is sent to the terminal CPU 91. A player's chip-betting operation is done via the bet screen 61 (see FIG. 5) on the touchscreen 50. Specifically, the player's operation onto the touchscreen 50 is done for the selection of the bet area 72, the input via the bet buttons 66 and the bet fixing button 65 and so on. The information of a player's operation is sent to the terminal CPU 91 when the touchscreen 50 has been operated. Then, the player's current betting information (the bet area and the bet amount placed via the bet screen 61) is stored into the RAM 93 sequentially according to that information. Furthermore, this betting information is sent to the server CPU 81 and stored in a betting information storing area in the RAM 83.

In addition, a sound output circuit 96 and the speaker 10 are connected to the terminal CPU 91. The speaker 10 outputs various effect sounds when various effects are generated and interactive conversation messages to a player for proceeding a game interactively based on output signals from the sound output circuit 96.

In addition, a sound input circuit 98 and the microphone 15 are connected to the terminal CPU 91. The microphone 15 transmits player's reply message sound in response to interactive message sound output from the speaker 10 to the terminal CPU 91 via the sound input circuit 98.

Furthermore, a second external storage unit 76 is connected to the terminal CPU 91. A conversation database of a language (Japanese, for example) of a player who is playing at the gaming terminal 4 is downloaded to the second external storage unit 76. Additionally, a translating program between the player's language and the reference language, i.e. English, is downloaded. The second external storage unit 76 is configured by an HDD unit. Its details will be described later.

In addition, the medal sensor 97 is connected to the terminal CPU 91. The medal sensor 97 detects medals inserted from the medal insertion slot 7 (see FIG. 3) and counts the inserted medals to send the counting result data to the terminal CPU 91. The terminal CPU 91 increases the player's credit amount stored in the RAM 93 according to the data.

Furthermore, the WIN lamp 11 is connected to the terminal CPU 91. The terminal CPU 91 lights up the WIN lamp 11 in a prescribed color when credits bet via the bet screen 61 has won or when a JP winning has been awarded.

In addition, a first external storage unit 99 is connected to the terminal CPU 91. The first external storage unit 99 is configured by an HDD unit. The terminal CPU 91 reads/writes data from/to the first external storage unit 99 if needed.

The gaming terminal 4 having the terminal control unit 90 includes the conversation engine. At least some of the roulette game procedures on the gaming terminal 4 are executed by the conversation engine interactively with the player by using the display 8, the speaker 10 and the microphone 15 as interfaces. Therefore, message sound for the player is output from the speaker 10 via the sound output circuit 96 in certain situations according to the roulette game procedures. In addition, contents of player's message sound input via the microphone 15 and the sound input circuit 98 are construed.

Such a conversation engine can be realized using a conversation controller described in, for example, United States patent application publication 2007/0094007, United States patent application publication 2007/0094008, United States patent application publication 2007/0094005 or United States patent application publication 2005/0094004. As will be explained hereinafter, such a conversation controller can be realized using the display 8, the speaker 10, the microphone 15, the terminal controller 90 and the first external storage unit 99 of the gaming terminal 4.

Here, a configuration of the conversation controller described in United States patent application publication 2007/0094007, which can be applied as the conversation engine installed in the gaming terminal 4 of the present embodiment, will be explained with reference to FIGS. 9 to 30. FIG. 9 is a functional block diagram showing a configuration example of the conversation controller.

As shown in FIG. 9, the conversation controller 1000 comprises an input unit 1100, a speech recognition unit 1200, a conversation control unit 1300, a sentence analyzing unit 1400, a conversation database 1500, an output unit 1600 and a speech recognition dictionary memory 1700.

### [Input Unit]

The input unit 1100 receives input information (user's utterance) input by a user. The input unit 1100 outputs a speech corresponding to contents of the received utterance as a voice signal to the speech recognition unit 1200. Note that the input unit 1100 may be a character input unit such as a keyboard and a touchscreen. In this case, the after-mentioned speech recognition unit 1200 doesn't need to be provided.

### [Speech Recognition Unit]

The speech recognition unit 1200 specifies a character string corresponding to the uttered contents based on the uttered contents obtained via the input unit 1100. Specifically, the speech recognition unit 1200 that has received the voice signal from the input unit 1100 compares the received voice signal with the conversation database 1500 and dictionaries stored in the speech recognition dictionary memory 1700 based on the voice signal to output a speech recognition result estimated based on the voice signal to the conversation control unit 1300. In a configuration example shown in FIG. 9, the speech recognition unit 1200 requests acquisition of memory contents of the conversation database 1500 to the conversation control unit 1300 and then receives the memory contents of the conversation database 1500 which the conversation control unit 1300 retrieves according to the request from the speech recognition unit 1200. However the speech recognition unit 1200 may directly retrieves the memory contents of the conversation database 1500 for comparing with the voice signal.

### [Configuration Example of Speech Recognition Unit]

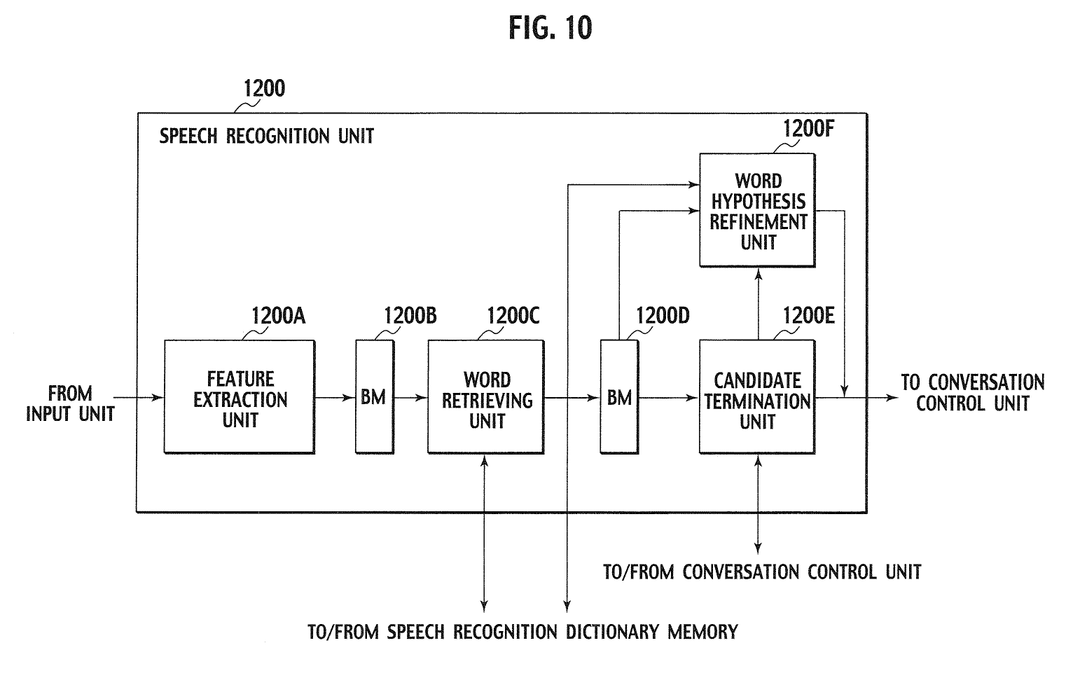

FIG. 10 is a functional block diagram showing a configuration example of the speech recognition unit 1200. The speech recognition unit 1200 includes a feature extraction unit 1200A, a buffer memory (BM) 1200B, a word retrieving unit 1200C, a buffer memory (BM) 1200D, a candidate determination unit 1200E and a word hypothesis refinement unit 1200F. The word retrieving unit 1200C and the word hypothesis refinement unit 1200F are connected to the speech recognition dictionary memory 1700. In addition, the candidate determination unit 1200E is connected to the conversation database 1500 via the conversation control unit 1300.

The speech recognition dictionary memory 1700 connected to the word retrieving unit 1200C stores a phoneme hidden Markov model (hereinafter, the hidden Markov model is referred as the HMM). The phoneme HMM is described with various states and each of the states includes the following information. It is configured with (a) a state number, (b) an acceptable context class, (c) lists of a previous state and a subsequent state, (d) parameters of an output probability density distribution, and (e) a self-transition probability and a transition probability to a subsequent state. The phoneme HMM used in the present embodiment is generated by converting a prescribed Speaker-Mixture HMM in order to specify which speakers respective distributions are derived from. An output probability density function is a Mixture Gaussian distribution with a 34-dimensional diagonal covariance matrix. The speech recognition dictionary memory 1700 connected to the word retrieving unit 1200C further stores a word dictionary. The word dictionary stores symbol strings each of which indicates a reading represented as a symbol per each word in the phoneme HMM.

A speaker's speech is input into a microphone or the like and then converted into a voice signal to be input to the feature extraction unit 1200A. The feature extraction unit 1200A converts the input voice signal from analog to digital and then extracts a feature parameter from the voice signal to output the feature parameter. There are various methods for extracting and outputting the feature parameter. For example, an LPC analysis is executed to extract a 34-dimensional feature parameter including a logarithm power, a 16-dimensional cepstrum coefficient, a Δ-logarithm power and a 16-dimensional Δ-cepstrum coefficient. The time series of the extracted feature parameters are input to the word retrieving unit 1200C via the buffer memory (BM) 1200B.

The word retrieving unit 1200C retrieves word hypotheses with a one-pass Viterbi decoding method based on the feature parameters input from the feature extraction unit 1200A via the buffer memory (BM) 1200B by using the phoneme HMM and the word dictionary stored in the speech recognition dictionary memory 1700, and then calculates likelihoods. Here, the word retrieving unit 1200C calculates a likelihood in a word and a likelihood from a speech start for each state of the phoneme HMM at each time. The likelihood is calculated each of an identification number of a calculating-object word, a speech start time of the word and a difference of a preceding word previously uttered before the word. The word retrieving unit 1200C may reduce grid hypotheses of the lower likelihoods among all of the calculated likelihoods based on the phoneme HMM and the word dictionary in order to reduce a computing throughput. The word retrieving unit 1200C outputs information on the retrieved word hypotheses and the likelihoods of the retrieved word hypotheses together with time information regarding an elapsed time from the speech start time (e.g. frame number) to the candidate determination unit 1200E and the word hypothesis refinement unit 1200F via the buffer memory (BM) 1200D.

The candidate determination unit 1200E compares the retrieved word hypotheses with topic specification information in a prescribed discourse space with reference to the conversation control unit 1300, and then determines whether or not exists a coincident word hypothesis with the topic specification information in the prescribed discourse space among the retrieved word hypotheses. If the coincident word hypothesis exists, the candidate determination unit 1200E outputs the coincident word hypothesis as a recognition result. On the other hand, if no coincident word hypothesis exists, the candidate determination unit 1200E requires the word hypothesis refinement unit 1200F to refine the retrieved word hypotheses.

An operation of the candidate determination unit 1200E will be described. Here, it is assumed that the word retrieving unit 1200C outputs plural word hypotheses (“KANTAKU (reclamation)”, “KATAKU (pretext)” and “KANTOKU (director)”) and plural likelihoods (recognition rates) for the respective word hypotheses; the prescribed discourse space relates to movies; the topic specification information of the prescribed discourse space includes “KANTOKU (director)” but neither “KANTAKU (reclamation)” nor “KATAKU (pretext)”; among the likelihoods (recognition rates) of “KANTAKU (reclamation)”, “KATAKU (pretext)” and “KANTOKU (director)”, “KANTAKU (reclamation)” is highest, “KANTOKU (director)” is lowest and “KATAKU (pretext)” is intermediate between the two.

In the above situation, the candidate determination unit 1200E compares the retrieved word hypotheses with the topic specification information in the prescribed discourse space, and then specifies the coincident word hypothesis “KANTOKU (director)” with the topic specification information to output the word hypothesis “KANTOKU (director)” to the conversation control unit 1300 as the recognition result. Processed in this manner, the word hypothesis “KANTOKU (director)” relating to the current topic “movies” is selected ahead of the word hypotheses “KANTAKU (reclamation)” and “KATAKU (pretext)” with higher likelihoods. As a result, the recognition result appropriate with the discourse context can be output.

On the other hand, if no coincident word hypothesis exists, the word hypothesis refinement unit 1200F operates to output the recognition result in response to the request from the candidate determination unit 1200E to refine the retrieved word hypotheses. The word hypothesis refinement unit 1200F refines the retrieved word hypotheses for the same words having the same speech termination time and different speech start time per each initial phonetic environment of the same words with reference to a statistical language model stored in the speech recognition dictionary memory 1700 based on the plural retrieved word hypotheses output from the word retrieving unit 1200C via the buffer memory (BM) 1200D so that one word hypothesis with the highest likelihood may be selected as a representative among all of the likelihoods calculated between the speech start and the utterance termination of the word. And then, the word hypothesis refinement unit 1200F outputs one word string of the one word hypothesis with the highest likelihood as the recognition result among all word strings of the refined word hypotheses. In the present embodiment, the initial phonetic environment of the same word to be processed is preferably defined with a three-phoneme series containing the last phoneme of the word hypothesis preceding the same word and two initial phonemes of the word hypothesis of the same word.

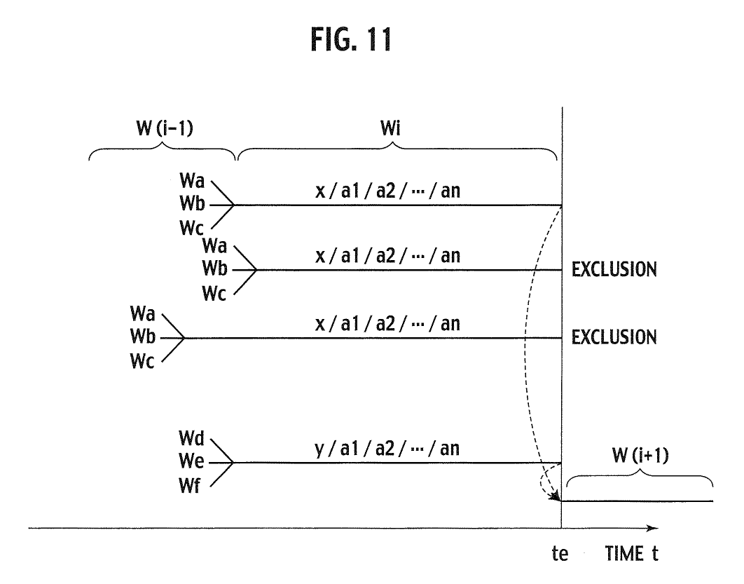

A word refinement process executed by the word hypothesis refinement unit 1200F will be described with reference to FIG. 11.

For example, it is assumed that the (i)th word Wi, which consists of a phonemic string a1, a2, . . . and an, follows the (i−1)th word W(i−1x) and six hypotheses Wa, Wb, Wc, Wd, We and Wf exist as a word hypothesis of the (i−1)th word W(i−1). It is further assumed that the last phoneme of the former three word hypotheses Wa, Wb and Wc is /x/, and the last phoneme of the latter three word hypotheses Wd, We and Wf is /y/. If three hypotheses each premised on three word hypotheses Wa, Wb and Wc and also one hypothesis premised on three word hypotheses Wd, We and Wf remain at the speech termination time te, the word hypothesis refinement unit 1200F is selected one hypothesis with the highest likelihood among the former three hypotheses with the same initial phonetic environment, and other two hypotheses are excluded.

Note that, since the initial phonetic environment of the hypothesis premised on the word hypotheses Wd, We and Wf is different from those of the other three hypotheses, that is, the last phoneme of the preceded word hypothesis is not /x/ but /y/, the hypothesis premised on the word hypotheses Wd, We and Wf is not excluded. In other words, one hypothesis is kept for each of the last phonemes of the preceding word hypotheses.

In the present embodiment, the initial phonetic environment of the word is defined with a three-phoneme series containing the last phoneme of the word hypothesis preceding the word and two initial phonemes of the word hypothesis of the word. However, the present invention is not limited to this. The initial phonetic environment of the word may be defined with a phoneme series containing a phoneme string of the preceding word hypothesis including the last phoneme of the preceding word hypothesis and at least one serial phoneme with the last phoneme of the preceding word hypothesis and a phoneme string including the first phoneme of the word hypothesis of the word.

In the present embodiment, the feature extraction unit 1200A, the word retrieving unit 1200C, the candidate determination unit 1200E and the word hypothesis refinement unit 1200F are composed of a computer such as a microcomputer. The buffer memories (BMs) 200B and 200D and the speech recognition dictionary memory 1700 are composed of a memory unit such as hard disc storage.

In the above-mentioned embodiment, the speech recognition is executed by using the word retrieving unit 1200C and the word hypothesis refinement unit 1200F. However, the present invention is not limited to this. The speech recognition unit 1200 may be composed of a phoneme comparison unit for referring to the phoneme HMM and a speech recognition unit for executing the speech recognition of a ward with reference to a statistical language model by using, for example, a One Pass DP algorithm.

In addition, in the present embodiment, the speech recognition unit 1200 is explained as a part of the conversation controller 1000. However, an independent speech recognition apparatus configured by the speech recognition unit 1200, the conversation database 1500 and the speech recognition dictionary memory 1700 may be possibly employed.

### [Operating Example of Speech Recognition Unit]

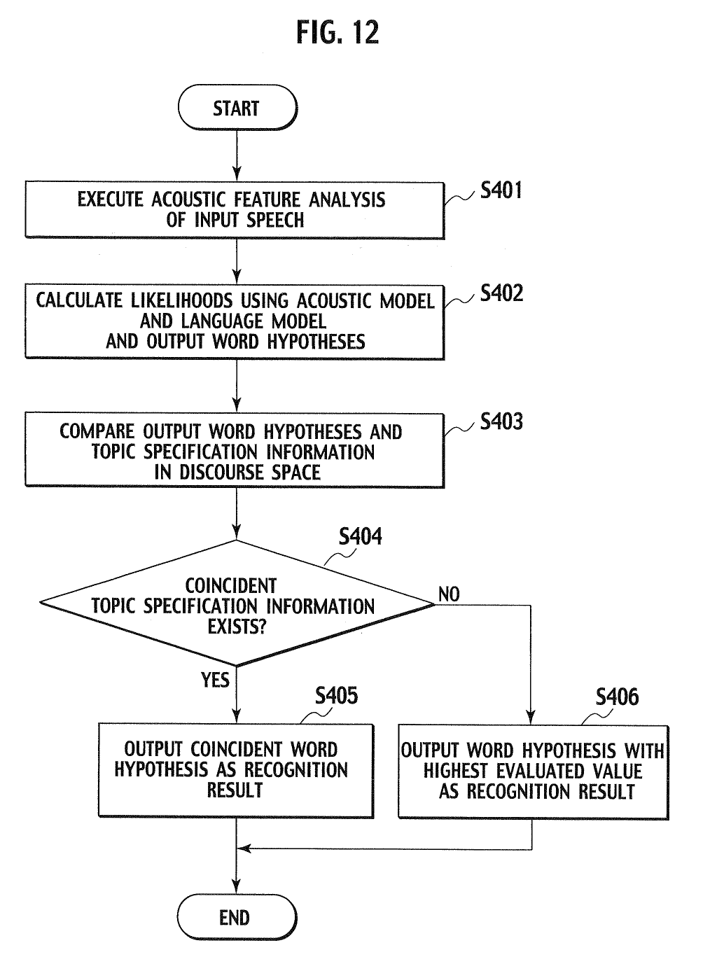

Next, operations of the speech recognition unit 1200 will be described with reference to FIG. 12. FIG. 12 is a flow chart showing process operations of the speech recognition unit 1200.

The speech recognition unit 1200 executes a feature analysis of the input speech to generate feature parameters on receiving the voice signal from the input unit 1100 (step S401). Next, the feature parameters is compared with the phoneme HMM and the language model stored in the speech recognition dictionary memory 1700, and then a certain number of word hypotheses and the likelihoods of the word hypotheses are obtained (step S402). Next, the speech recognition unit 1200 compares the obtained certain number of word hypotheses, the retrieved word hypotheses and the topic specification information in the prescribed discourse space to determine whether or not the coincident word hypothesis with the topic specification information in the prescribed discourse space exists among the retrieved word hypotheses (steps S403 and S404). If the coincident word hypothesis exists, the speech recognition unit 1200 outputs the coincident word hypothesis as the recognition result (step S405). On the other hand, if no coincident word hypothesis exists, the speech recognition unit 1200 outputs the word hypothesis with the highest likelihood as the recognition result according to the obtained likelihoods of the word hypotheses (step S406).

### [Speech Recognition Dictionary Memory]

The configuration example of the conversation controller 1000 is further described with referring back to FIG. 9 again.

The speech recognition dictionary memory 1700 stores character strings corresponding to standard voice signals. The speech recognition unit 1200, which has executed the comparison, specifies a word hypothesis for a character string corresponding to the received voice signal, and then outputs the specified word hypothesis as a character string signal to the conversation control unit 1300.

### [Sentence Analyzing Unit]

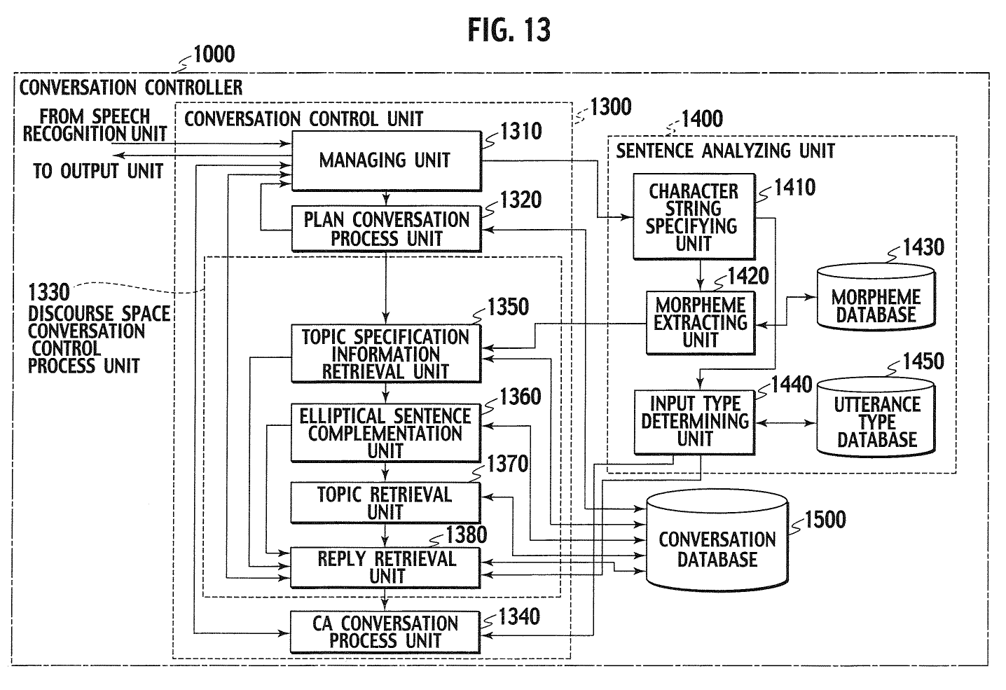

Next, a configuration example of the sentence analyzing unit 1400 will be described with reference to FIG. 13. FIG. 13 is a partly enlarged block diagram of the conversation controller 1000 and also a block diagram showing a concrete configuration example of the conversation control unit 1300 and the sentence analyzing unit 1400. Note that only the conversation control unit 1300, the sentence analyzing unit 1400 and the conversation database 1500 are shown in FIG. 13 and the other components are omitted to be shown.

The sentence analyzing unit 1400 analyses a character string specified at the input unit 1100 or the speech recognition unit 1200. In the present embodiment as shown in FIG. 13, the sentence analyzing unit 1400 includes a character string specifying unit 1410, a morpheme extracting unit 1420, a morpheme database 1430, an input type determining unit 1440 and an utterance type database 1450. The character string specifying unit 1410 segments a series of character strings specified by the input unit 1100 or the speech recognition unit 1200 into segments. Each segment is a minimum segmented sentence which is segmented in the extent to keep a grammatical meaning. Specifically, if the series of the character strings have a time interval more than a certain interval, the character string specifying unit 1410 segments the character strings there. The character string specifying unit 1410 outputs the segmented character strings to the morpheme extracting unit 1420 and the input type determining unit 1440. Note that a “character string” to be described below means one segmented character string.

### [Morpheme Extracting Unit]

The morpheme extracting unit 1420 extracts morphemes constituting minimum units of the character string as first morpheme information from each of the segmented character strings based on each of the segmented character strings segmented by the character string specifying unit 1410. In the present embodiment, a morpheme means a minimum unit of a word structure shown in a character string. For example, each minimum unit of a word structure may be a word class such as a noun, an adjective and a verb.

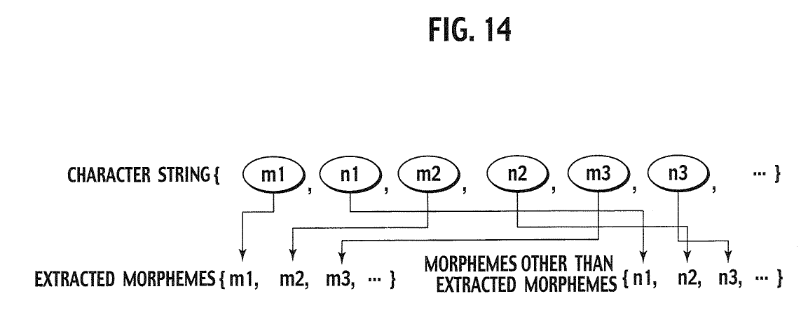

In the present embodiment as shown in FIG. 14, the morphemes are indicated as m1, m2, m3, . . . . FIG. 14 is a diagram showing a relation between a character string and morphemes extracted from the character string. The morpheme extracting unit 1420, which has received the character strings from the character string specifying unit 1410, compares the received character strings and morpheme groups previously stored in the morpheme database 1430 (each of the morpheme group is prepared as a morpheme dictionary in which a direction word, a reading, a word class and infected forms are described for each morpheme belonging to each word-class classification) as shown in FIG. 14. The morpheme extracting unit 1420, which has executed the comparison, extracts coincident morphemes (m1, m2, . . . ) with any of the stored morpheme groups from the character strings. Other morphemes (n1, n2, n3, . . . ) than the extracted morphemes may be auxiliary verbs, for example.

The morpheme extracting unit 1420 outputs the extracted morphemes to a topic specification information retrieval unit 1350 as the first morpheme information. Note that the first morpheme information is not needed to be structurized. Here, “structurizing” means classifying and arranging morphemes included in a character string based on word classes. For example, it may be data conversion in which a character string as an uttered sentence is segmented into morphemes and then the morphemes are arranged in a prescribed order such as “Subject+Object+Predicate”. Needless to say, the structurized first morpheme information doesn't prevent the operations of the present embodiment.

### [Input Type Determining Unit]

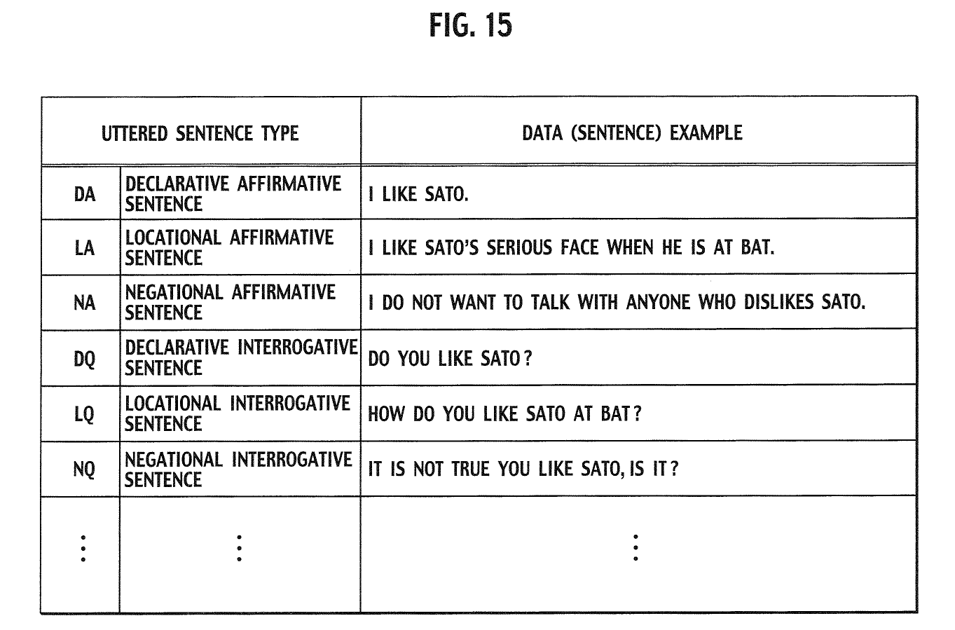

The input type determining unit 1440 determines an uttered contents type (utterance type) based on the character strings specified by the character string specifying unit 1410. In the present embodiment, the utterance type is information for specifying the uttered contents type and, for example, corresponds to “uttered sentence type” shown in FIG. 15. FIG. 15 is a table showing the “uttered sentence types”, two-alphabet codes representing the uttered sentence types, and uttered sentence examples corresponding to the uttered sentence types.

Here in the present embodiment as shown in FIG. 15, the “uttered sentence types” include declarative sentences (D: Declaration), time sentences (T: Time), locational sentences (L: Location), negational sentences (N: Negation) and so on. A sentence configured by each of these types is an affirmative sentence or an interrogative sentence. A “declarative sentence” means a sentence showing a user's opinion or notion. In the present embodiment, one example of the “declarative sentence” is the sentence “I like Sato” shown in FIG. 15. A “locational sentence” means a sentence involving a locational notion. A “time sentence” means a sentence involving a timelike notion. A “negational sentence” means a sentence to deny a declarative sentence. Sentence examples of the “uttered sentence types” are shown in FIG. 15.

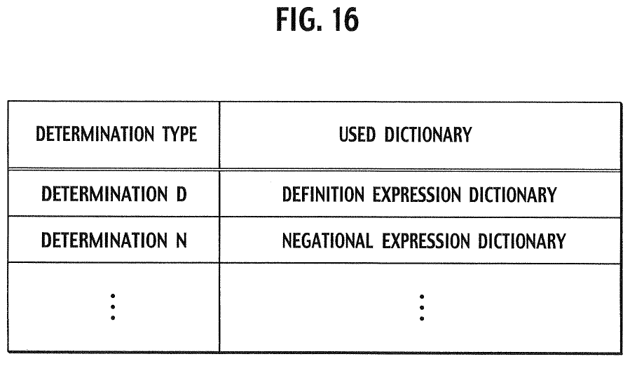

In the present embodiment as shown in FIG. 16, the input type determining unit 1440 uses a declarative expression dictionary for determination of a declarative sentence, a negational expression dictionary for determination of a negational sentence and so on in order to determine the “uttered sentence type”. Specifically, the input type determining unit 1440, which has received the character strings from the character string specifying unit 1410, compares the received character strings and the dictionaries stored in the utterance type database 1450 based on the received character string. The input type determining unit 1440, which has executed the comparison, extracts elements relevant to the dictionaries among the character strings.

The input type determining unit 1440 determines the “uttered sentence type” based on the extracted elements. For example, if the character string includes elements declaring an event, the input type determining unit 1440 determines that the character string including the elements is a declarative sentence. The input type determining unit 1440 outputs the determined “uttered sentence type” to a reply retrieval unit 1380.

### [Conversation Database]

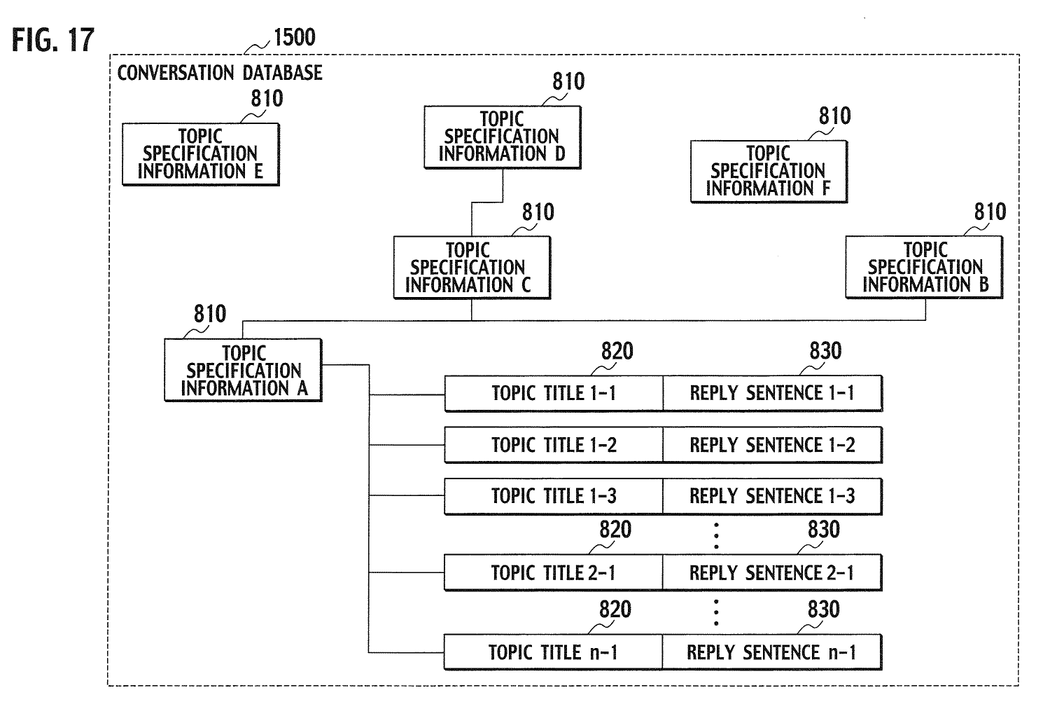

A configuration example of data structure stored in the conversation database 1500 will be described with reference to FIG. 17. FIG. 17 is a conceptual diagram showing the configuration example of data stored in the conversation database 1500.

As shown in FIG. 17, the conversation database 1500 stores a plurality of topic specification information 810 for specifying a conversation topic. In addition, topic specification information 810 can be associated with other topic specification information 810. For example, if topic specification information C (810) is specified, three of topic specification information A (810), B (810) and D (810) associated with the topic specification information C (810) are also specified.

Specifically in the present embodiment, topic specification information 810 means “keywords” which are relevant to input contents expected to be input from users or relevant to reply sentences to users.

The topic specification information 810 is associated with one or more topic titles 820. Each of the topic titles 820 is configured with a morpheme composed of one character, plural character strings or a combination thereof. A reply sentence 830 to be output to users is stored in association with each of the topic titles 820. Response types for indicating types of the reply sentences 830 are associated with the reply sentences 830, respectively.

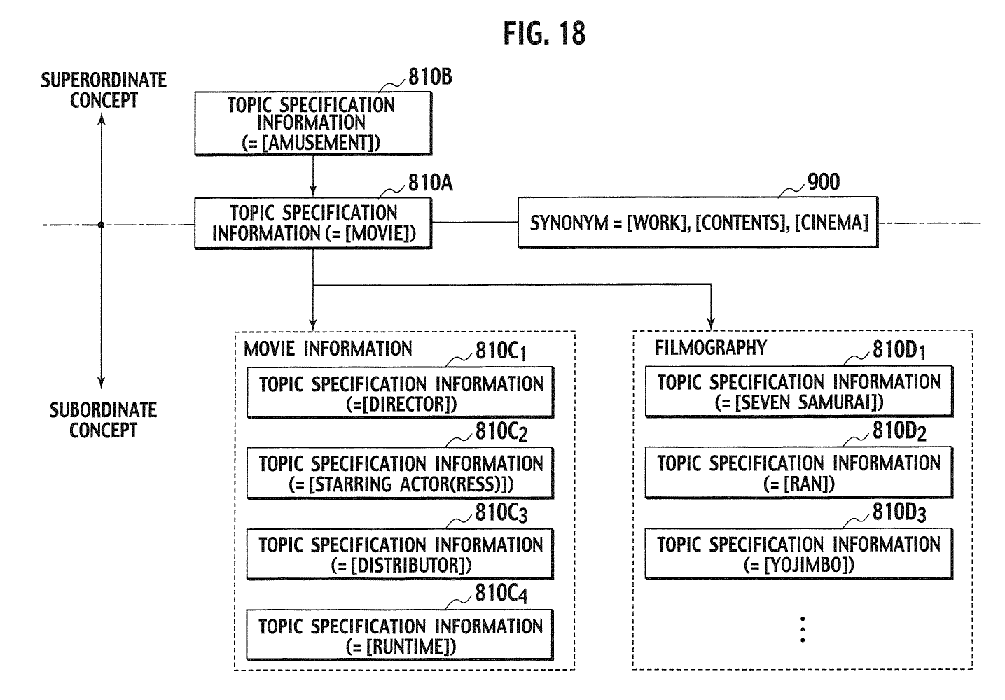

Next, an association between the topic specification information 810 and the other topic specification information 810 will be described. FIG. 18 is a diagram showing the association between certain topic specification information 810A and the other topic specification information 810B, 810C₁-810C₄ and 810D₁-810D₃ . . . . Note that a phrase “stored in association with” mentioned below indicates that, when certain information X is read out, information Y stored in association with the information X can be also read out. For example, a phrase “information Y is stored ‘in association with’ the information X” indicates a state where information for reading out the information Y (such as, a pointer indicating a storing address of the information Y, a physical memory address or a logical address in which the information Y is stored, and so on) is implemented in the information X.

In the example shown in FIG. 18, the topic specification information can be stored in association with the other topic specification information with respect to a superordinate concept, a subordinate concept, a synonym or an antonym (not shown in FIG. 18). For example as shown in FIG. 18, the topic specification information 810B (amusement) is stored in association with the topic specification information 810A (movie) as a superordinate concept and stored in a higher level than the topic specification information 810B (amusement).

In addition, subordinate concepts of the topic specification information 810A (movie), the topic specification information 810C₁ (director), 810C₂ (starring actor/actress), 810C₃ (distributor), 810C₄ (runtime), 810D₁ (“Seven Samurai”), 810D₂ (“Ran”), 810D₃ (“Yojimbo”), . . . , are stored in association with the topic specification information 810A.

In addition, synonyms 900 are associated with the topic specification information 810A. In this example, “work”, “contents” and “cinema” are stored as synonyms of “movie” which is a keyword of the topic specification information 810A. By defining these synonyms in this manner, the topic specification information 810A can be treated as included in an uttered sentence even though the uttered sentence doesn't include the keyword “movie” but includes “work”, “contents” or “cinema”.

In the conversation controller 1000 according to the present embodiment, when certain topic specification information 810 has been specified with reference to contents stored in the conversation database 1500, other topic specification information 810 and the topic titles 820 or the reply sentences 830 of the other topic specification information 810, which are stored in association with the certain topic specification information 810, can be retrieved and extracted rapidly.

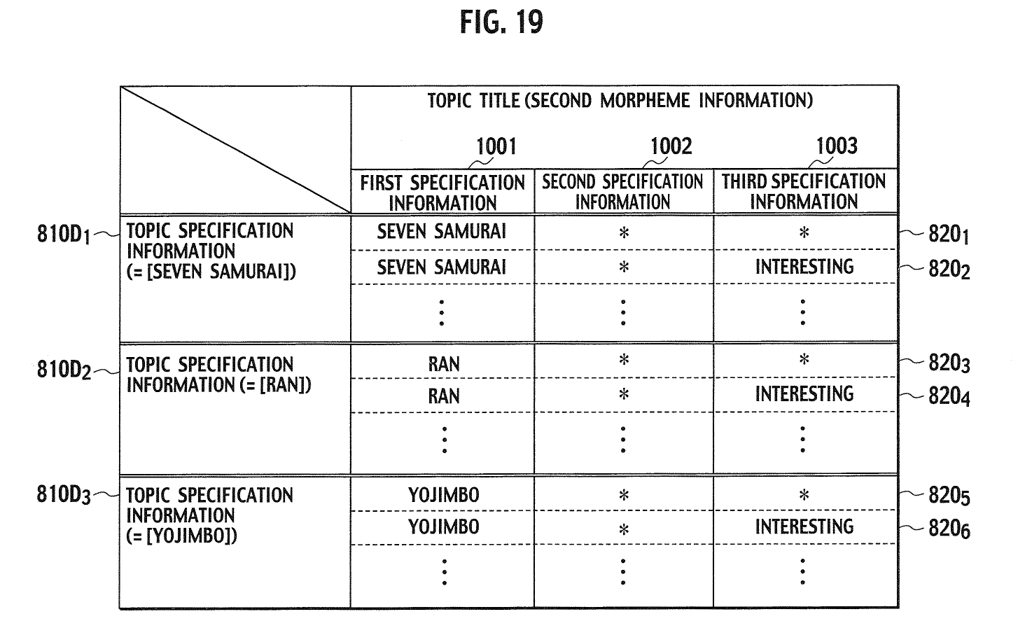

Next, data configuration examples of topic titles 820 (also referred as “second morpheme information”) will be described with reference to FIG. 19. FIG. 19 is a diagram showing the data configuration examples of the topic titles 820.

The topic specification information 810D₁, 810D₂, 810D₃, include the topic titles 8201, 8202, . . . , the topic titles 8203, 8204, . . . , the topic titles 8205, 8206, . . . , respectively. In the present embodiment as shown in FIG. 19, each of the topic titles 820 is information composed of first specification information 1001, second specification information 1002 and third specification information 1003. Here, the first specification information 1001 is a main morpheme constituting a topic. For example, the first specification information 1001 may be a Subject of a sentence. In addition, the second specification information 1002 is a morpheme closely relevant to the first specification information 1001. For example, the second specification information 1002 may be an Object. Furthermore, the third specification information 1003 in the present embodiment is a morpheme showing a movement of a certain subject, a morpheme of a noun modifier and so on. For example, the third specification information 1003 may be a verb, an adverb or an adjective. Note that the first specification information 1001, the second specification information 1002 and the third specification information 1003 are not limited to the above meanings. The present embodiment can be effected in case where contents of a sentence can be understood based on the first specification information 1001, the second specification information 1002 and the third specification information 1003 even though they are give other meanings (other ward classes).

For example as shown in FIG. 19, if the Subject is “Seven Samurai” and the adjective is “interesting”, the topic title 8202 (second morpheme information) consists of the morpheme “Seven Samurai” included in the first specification information 1001 and the morpheme “interesting” included in the third specification information 1003. Note that the second specification information 1002 of this topic title 8202 includes no morpheme and a symbol “*” is stored in the second specification information 1002 for indicating no morpheme included.

Note that this topic title 8202 (Seven Samurai; *; interesting) has the meaning of “Seven Samurai is interesting.” Hereinafter, parenthetic contents for a topic title 8202 indicate the specification information 1001, the second specification information 1002 and the third specification information 1003 from the left. In addition, when no morpheme is included in any of the first to third specification information, “*” is indicated therein.

Note that the specification information constituting the topic titles 820 is not limited to three and other specification information (fourth specification information and more) may be included.

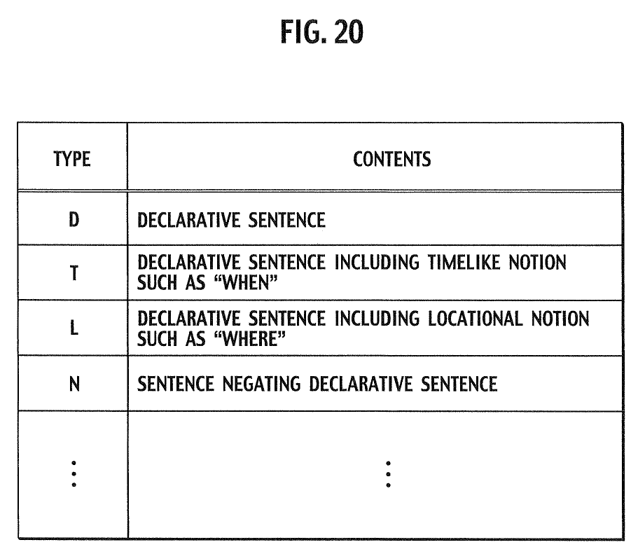

Next, the reply sentences 830 will be described with reference to FIG. 20. In the present embodiment as shown in FIG. 20, the reply sentences 830 are classified into different types (response types) such as declaration (D: Declaration), time (T: Time), location (L: Location) and negation (N: Negation) for making a reply corresponding to the uttered sentence type of the user's utterance. Note that an affirmative sentence is classified with “A” and an interrogative sentence is classified with “Q”.

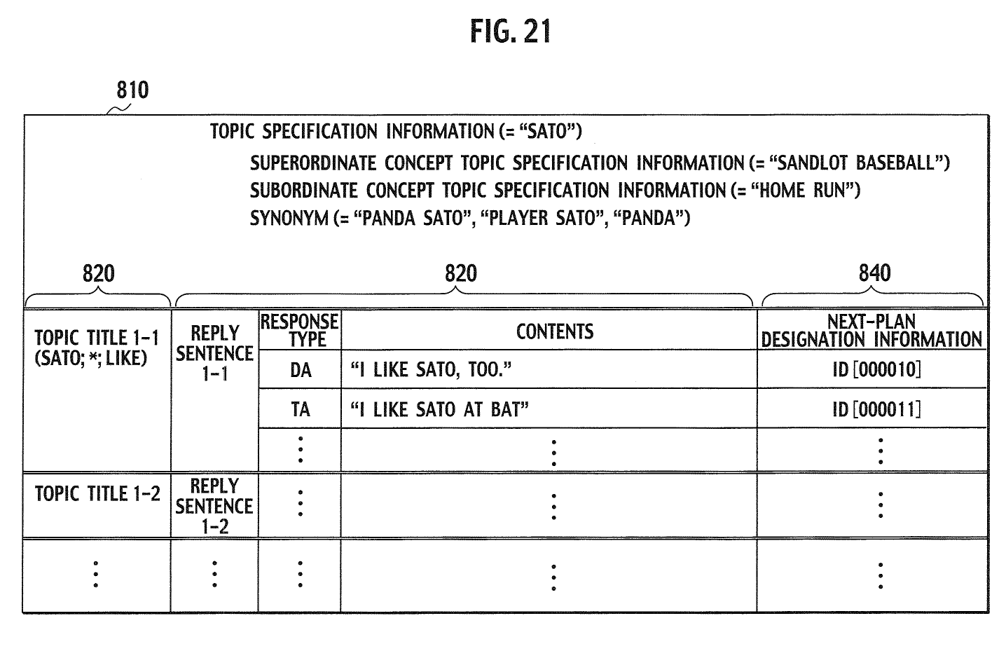

A configuration example of data structure of the topic specification information 810 will be described with reference to FIG. 21. FIG. 21 shows a concrete example of the topic titles 820 and the reply sentences 830 associated with the topic specification information 810 “Sato”.

The topic specification information 810 “Sato” is associated with plural topic titles (820) 1-1, 1-2, . . . . Each of the topic titles (820) 1-1, 1-2, . . . is associated with reply sentences (830) 1-1, 1-2, . . . . The reply sentence 830 is prepared per each of the response types 840.

For example, when the topic title (820) 1-1 is (Sato; *; like) [these are extracted morphemes included in “I like Sato”], the reply sentences (830) 1-1 associated with the topic title (820) 1-1 include (DA: a declarative affirmative sentence “I like Sato, too.”) and (TA: a time affirmative sentence “I like Sate at bat.”). The after-mentioned reply retrieval unit 1380 retrieves one reply sentence 830 associated with the topic title 820 with reference to an output from the input type determining unit 1440.

Next-plan designation information 840 is allocated to each of the reply sentences 830. The next-plan designation information 840 is information for designating a reply sentence to be preferentially output against a user's utterance in association with the each of the reply sentences (referred as a “next-reply sentence”). The next-plan designation information 840 may be any information even if a next-reply sentence can be specified by the information. For example, the information may be a reply sentence ID, by which at least one reply sentence can be specified among all reply sentences stored in the conversation database 1500.

In the present embodiment, the next-plan designation information 840 is described as information for specifying one next-reply sentence per one reply sentence (for example, a reply sentence ID). However, the next-plan designation information 840 may be information for specifying next-reply sentences per topic specification information 810 or per one topic title 820. (In this case, since plural replay sentences are designated, they are referred as a “next-reply sentence group”. However, only one of the reply sentences included in the next-reply sentence group will be actually output as the reply sentence.) For example, the present embodiment can be effected in case where a topic title ID or a topic specification information ID is used as the next-plan designation information.

### [Conversation Control Unit]

A configuration example of the conversation control unit 1300 is further described with referring back to FIG. 13.

The conversation control unit 1300 functions to control data transmitting between configuration components in the conversation controller 1000 (the speech recognition unit 1200, the sentence analyzing unit 1400, the conversation database 1500, the output unit 1600 and the speech recognition dictionary memory 1700), and determine and output a reply sentence in response to a user's utterance.

In the present embodiment shown in FIG. 13, the conversation control unit 1300 includes a managing unit 1310, a plan conversation process unit 1320, a discourse space conversation control process unit 1330 and a CA conversation process unit 1340. Hereinafter, these configuration components will be described.

### [Managing Unit]

The managing unit 1310 functions to store discourse histories and update, if needed, the discourse histories. The managing unit 1310 further functions to transmit some or entire of the stored discourse histories to a part or a whole of the discourse histories to a topic specification information retrieval unit 1350, an elliptical sentence complementation unit 1360, a topic retrieval unit 1370 or a reply retrieval unit 1380 in response to a request therefrom.

### [Plan Conversation Process Unit]

The plan conversation process unit 1320 functions to execute plans and establish conversations between a user and the conversation controller 1000 according to the plans. A “plan” means providing a predetermined reply to a user in a predetermined order.

The plan conversation process unit 1320 functions to output the predetermined reply in the predetermined order in response to a user's utterance.

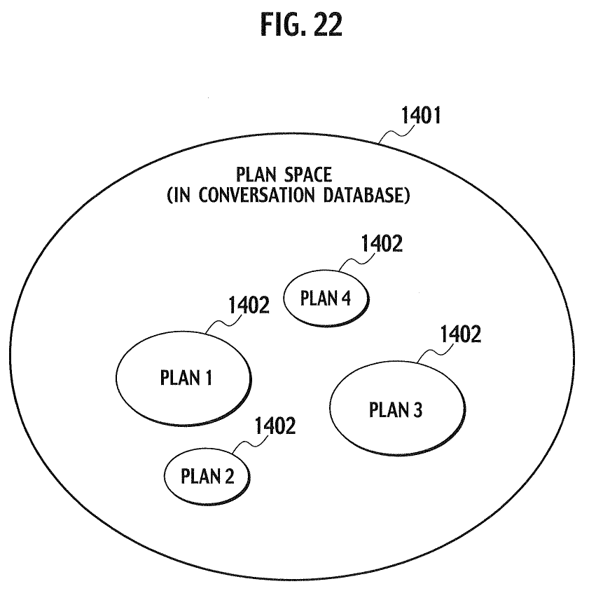

FIG. 22 is a conceptual diagram to describe plans. As shown in FIG. 22, various plans 1402 such as plural plans 1, 2, 3 and 4 are prepared in a plan space 1401. The plan space 1401 is a set of the plural plans 1402 stored in the conversation database 1500. The conversation controller 1000 selects a preset plan 1402 for a start-up on an activation or a conversation start or arbitrarily selects one of the plans 1402 in the plan space 1401 in response to a user's utterance contents in order to output a reply sentence against the user's utterance by using the selected plan 1402.

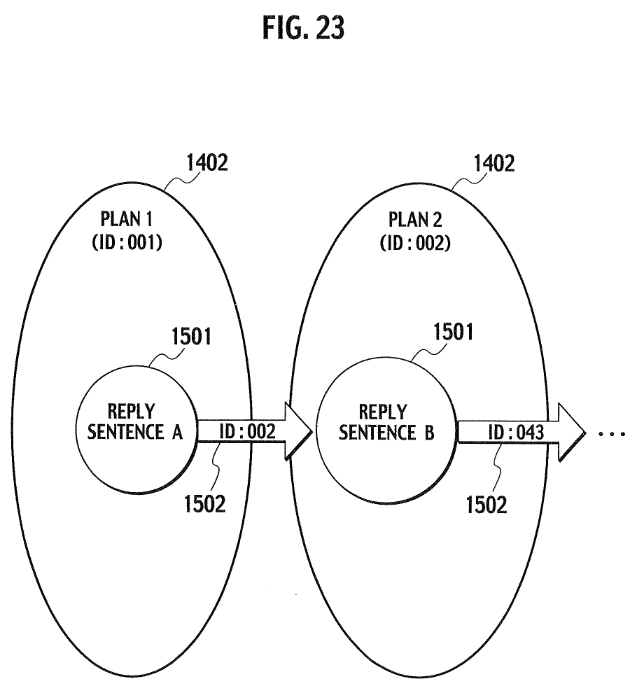

FIG. 23 shows a configuration example of plans 1402. Each plan 1402 includes a reply sentence 1501 and next-plan designation information 1502 associated therewith. The next-plan designation information 1502 is information for specifying, in response to a certain reply sentence 1501 in a plan 1402, another plan 1402 including a reply sentence to be output to a user (referred as a “next-reply candidate sentence”). In this example, the plan 1 includes a reply sentence A (1501) to be output at an execution of the plan 1 by the conversation controller 1000 and next-plan designation information 1502 associated with the reply sentence A (1501). The next-plan designation information 1502 is information [ID: 002] for specifying a plan 2 including a reply sentence B (1501) to be a next-reply candidate sentence to the reply sentence A (1501). Similarly, since the reply sentence B (1501) is also associated with next-plan designation information 1502, another plan 1402 ([ID: 043]: not shown) including the next-reply candidate sentence will be designated by next-plan designation information 1502 when the reply sentence B (1501) has output. In this manner, plans 1402 are chained via next-plan designation information 1502 and plan conversations in which a series of successive contents can be output to a user.

In other words, since contents expected to be provided to a user (an explanatory sentence, an announcement sentence, a questionnaire and so on) are separated into plural reply sentences and the reply sentences are prepared as a plan with their order predetermined, it becomes possible to provide a series of the reply sentences to the user in response to the user's utterances. Note that a reply sentence 1501 included in a plan 1402 designated by next-plan designation information 1502 is not needed to be output to a user immediately after an output of the user's utterance in response to an output of a previous reply sentence. The reply sentence 1501 included in the plan 1402 designated by the next-plan designation information 1502 may be output after an intervening conversation on a different topic from a topic in the plan between the conversation controller 1000 and the user.

Note that the reply sentence 1501 shown in FIG. 23 corresponds to a sentence string of one of the reply sentences 830 shown in FIG. 21. In addition, the next-plan designation information 1502 shown in FIG. 23 corresponds to the next-plan designation information 840 shown in FIG. 21.

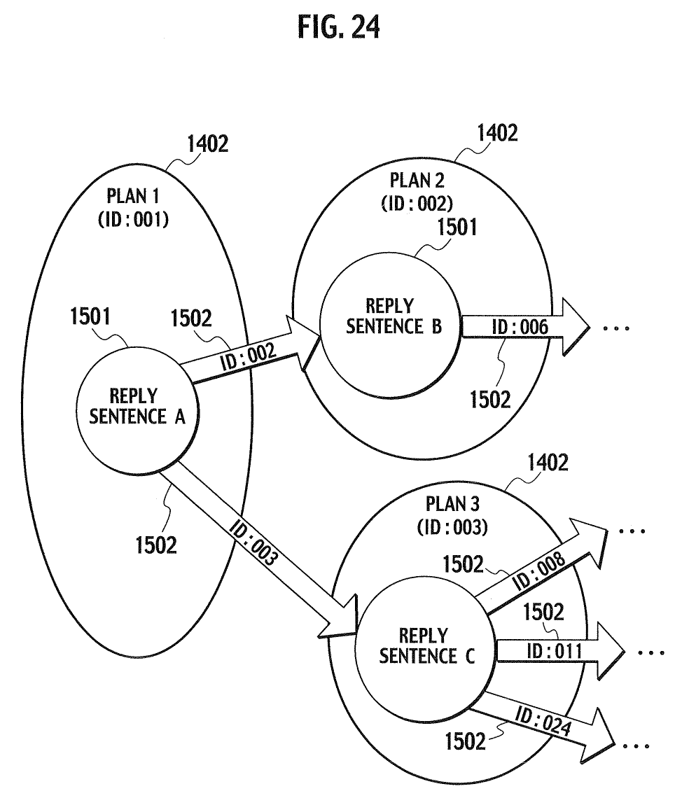

Note that linkages between the plans 1402 are not limited to form a one-dimensional geometry shown in FIG. 23. FIG. 24 shows an example of plans 1402 with another linkage geometry. In the example shown in FIG. 24, a plan 1 (1402) includes two of next-plan designation information 1502 to designate two reply sentences as next replay candidate sentences, in other words, to designate two plans 1402. The two of next-plan designation information 1502 are prepared in order that the plan 2 (1402) including a reply sentence B (1501) and the plan 3 (1402) including a reply sentence C (1501) are to be designated as plans each including a next-reply candidate sentence. Note that the reply sentences are selective and alternative, so that, when one has been output, another is not output and then the plan 1 (1501) is terminated. In this manner, the linkages between the plans 1402 is not limited to forming a one-dimensional geometry and may form a tree-diagram-like geometry or a cancellous geometry.

Note that it is not limited that how many next-reply candidate sentences each plan 1402 includes. In addition, no next-plan designation information 1502 may be included in a plan 1402 which terminates a conversation.

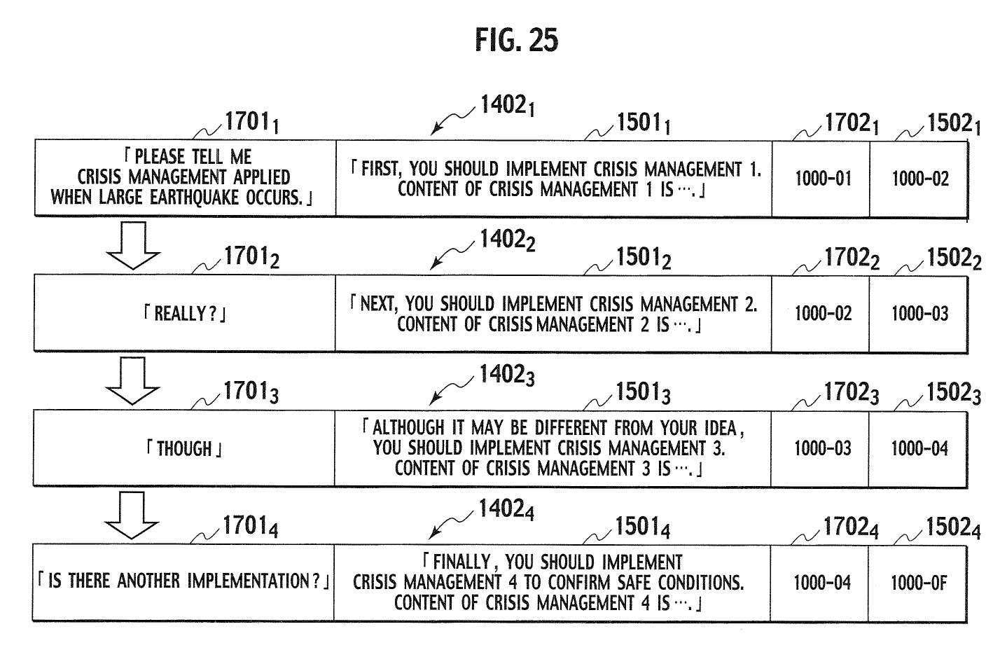

FIG. 25 shows an example of a certain series of plans 1402. As shown in FIG. 25, this series of plans 1402₁ to 1402₄ are associated with reply sentences 1501₁ to 1501₄ which notify crisis management information to a user. The reply sentences 1501₁ to 1501₄ constitute one coherent topic as a whole. Each of the plans 1402₁ to 1402₄ includes ID data 1702, to 17024 for indicating itself such as “1000-01, 1000-02”, “1000-03” and “1000-04”, respectively. Note that each value after a hyphen in the ID data is information indicating an output order. In addition, each of the plans 1402₁ to 1402₄ further includes ID data 1502, to 15024 as the next-plan designation information such as “1000-02, 1000-03”, “1000-04” and “1000-0F”, respectively. Especially, “0F” is information indicating the final plan (the last in the order).

In this example, the plan conversation process unit 1320 starts to execute this series of plans when a user has uttered's utterance has been “Please tell me a crisis management applied when a large earthquake occurs.” Specifically, the plan conversation process unit 1320 searches in the plan space 1401 and checks whether or not a plan 1402 including a reply sentence 1501₁ associated with the user's utterance “Please tell me a crisis management applied when a large earthquake occurs,” when the plan conversation process unit 1320 has received the user's utterance “Please tell me a crisis management applied when a large earthquake occurs.” In this example, a user's utterance character string 1701₁ associated with the user's utterance “Please tell me a crisis management applied when a large earthquake occurs,” is associated with a plan 1402₁.

The plan conversation process unit 1320 retrieves the reply sentence 1501₁ included in the plan 1402₁ on discovering the plan 1402₁ and outputs the reply sentence 1501₁ to the user as a reply sentence in response to the user's utterance. And then, the plan conversation process unit 1320 specifies the next-reply candidate sentence with reference to the next-plan designation information 1502₁.

Next, the plan conversation process unit 1320 executes the plan 1402₂ on receiving another user's utterance via the input unit 1100, a speech recognition unit 1200 or the like after an output of the reply sentence 1501₁. Specifically, the plan conversation process unit 1320 judges whether or not to execute the plan 1402₂ designated by the next-plan designation information 1502₁, in other words, whether or not to output the second reply sentence 1501₂. More specifically, the plan conversation process unit 1320 compares a user's utterance character string (also referred as an illustrative sentence) 1701₂ associated with the reply sentence 1501₂ and the received user's utterance, or compares a topic title 820 (not shown in FIG. 25) associated with the reply sentence 1501₂ and the received user's utterance. And then, the plan conversation process unit 1320 determines whether or not the two are related to each other. If the two are related to each other, the plan conversation process unit 1320 outputs the second reply sentence 1501₂. In addition, since the plan 1402₂ including the second reply sentence 1501₂ also includes the next-plan designation information 1502₂, the next-reply candidate sentence is specified.

Similarly, according to ongoing user's utterances, the plan conversation process unit 1320 transit into the plans 1402₃ and 1402₄ in turn and can output the third and fourth reply sentences 1501₃ and 1501₄. Note that, since the fourth reply sentence 1501₄ is the final reply sentence, the plan conversation process unit 1320 terminates plan-executions when the fourth reply sentence 1501₄ has been output.

In this manner, the plan conversation process unit 1320 can provide previously prepared conversation contents to the user in a predetermined order by sequentially executing the plans 1402₁ to 1402₄.

### [Discourse Space Conversation Control Process Unit]

The configuration example of the conversation control unit 1300 is further described with referring back to FIG. 13.

The discourse space conversation control process unit 1330 includes the topic specification information retrieval unit 1350, the elliptical sentence complementation unit 1360, the topic retrieval unit 1370 and the reply retrieval unit 1380. The managing unit 1310 totally controls the conversation control unit 1300.

A “discourse history” is information for specifying a conversation topic or theme between a user and the conversation controller 1000 and includes at least one of “focused topic specification information”, a “focused topic title”, “user input sentence topic specification information” and “reply sentence topic specification information”. The “focused topic specification information”, the “focused topic title” and the “reply sentence topic specification information” are not limited to be defined from a conversation done just before but may be defined from the previous “focused topic specification information”, the “focused topic title” and the “reply sentence topic specification information” during a predetermined past period or from an accumulated record thereof.

Hereinbelow, each of the units constituting the discourse space conversation control process unit 1330 will be described.

### [Topic Specification Information Retrieval Unit]

The topic specification information retrieval unit 1350 compares the first morpheme information extracted by the morpheme extracting unit 1420 and the topic specification information, and then retrieves the topic specification information corresponding to a morpheme in the first morpheme information among the topic specification information. Specifically, when the first morpheme information received from the morpheme extracting unit 1420 is two morphemes “Sato” and “like”, the topic specification information retrieval unit 1350 compares the received first morpheme information and the topic specification information group.

If a focused topic title 820_{focus} (indicated as 820_{focus} to be differentiated from previously retrieved topic titles or other topic titles) includes a morpheme (for example, “Sato”) in the first morpheme information, the topic specification information retrieval unit 1350 outputs the focused topic title 820_{focus} to the reply retrieval unit 1380. On the other hand, if no topic title includes the morpheme in the first morpheme information, the topic specification information retrieval unit 1350 determines user input sentence topic specification information based on the received first morpheme information, and then outputs the first morpheme information and the user input sentence topic specification information to the elliptical sentence complementation unit 1360. Note that the “user input sentence topic specification information” is topic specification information corresponding-to or probably-corresponding-to a morpheme relevant to topic contents talked by a user among morphemes included in the first morpheme information.

### [Elliptical Sentence Complementation Unit]

The elliptical sentence complementation unit 1360 generates various complemented first morpheme information by complementing the first morpheme information with the previously retrieved topic specification information 810 (hereinafter referred as the “focused topic specification information”) and the topic specification information 810 included in the final reply sentence (hereinafter referred as the “reply sentence topic specification information”). For example, if a user's utterance is “like”, the elliptical sentence complementation unit 1360 generates the complemented first morpheme information “Sato, like” by including the focused topic specification information “Sato” into the first morpheme information “like”.

In other words, if it is assumed that the first morpheme information is defined as “W” and a set of the focused topic specification information and the reply sentence topic specification information is defined as “D”, the elliptical sentence complementation unit 1360 generates the complemented first morpheme information by including an element(s) in the set “D” into the first morpheme information “W”.

In this manner, in case where, for example, a sentence constituted with the first morpheme information is an elliptical sentence which is unclear as language, the elliptical sentence complementation unit 1360 can include, by using the set “D”, an element(s) (for example, “Sato”) in the set “D” into the first morpheme information “W”. As a result, the elliptical sentence complementation unit 1360 can complement the first morpheme information “like” into the complemented first morpheme information “Sato, like”. Note that the complemented first morpheme information “Sato, like” corresponds to a user's utterance “I like Sato.”

That is, even when user's utterance contents are provided as an elliptical sentence, the elliptical sentence complementation unit 1360 can complement the elliptical sentence by using the set “D”. As a result, even when a sentence constituted with the first morpheme information is an elliptical sentence, the elliptical sentence complementation unit 1360 can complement the sentence into an appropriate sentence as language.

In addition, the elliptical sentence complementation unit 1360 retrieves the topic title 820 related to the complemented first morpheme information based on the set “D”. If the topic title 820 related to the complemented first morpheme information has been found, the elliptical sentence complementation unit 1360 outputs the topic title 820 to the reply retrieval unit 1380. The reply retrieval unit 1380 can output a reply sentence 830 best-suited for the user's utterance contents based on the appropriate topic title 820 found by the elliptical sentence complementation unit 1360.

Note that the elliptical sentence complementation unit 1360 is not limited to including an element(s) in the set “D” into the first morpheme information. The elliptical sentence complementation unit 1360 may include, based on a focused topic title, a morpheme(s) included in any of the first, second and third specification information in the topic title, into the extracted first morpheme information.

### [Topic Retrieval Unit]

The topic retrieval unit 1370 compares the first morpheme information and topic titles 820 associated with the user input sentence topic specification information to retrieve a topic title 820 best-suited for the first morpheme information among the topic titles 820 when the topic title 820 has not been determined by the elliptical sentence complementation unit 1360.

Specifically, the topic retrieval unit 1370, which has received a retrieval command signal from the elliptical sentence complementation unit 1360, retrieves the topic title 820 best-suited for the first morpheme information among the topic titles associated with the user input sentence topic specification information based on the user input sentence topic specification information and the first morpheme information which are included in the received retrieval command signal. The topic retrieval unit 1370 outputs the retrieved topic title 820 as a retrieval result signal to the reply retrieval unit 1380.

Above-mentioned FIG. 21 shows the concrete example of the topic titles 820 and the reply sentences 830 associated with the topic specification information 810 (=“Sato”). For example as shown in FIG. 21, since topic specification information 810 (=“Sato”) is included in the received first morpheme information “Sato, like”, the topic retrieval unit 1370 specifies the topic specification information 810 (=“Sato”) and then compares the topic titles (820) 1-1, 1-2, . . . associated with the topic specification information 810 (=“Sato”) and the received first morpheme information “Sato, like”.

The topic retrieval unit 1370 retrieves the topic title (820) 1-1 (Sato; *; like) related to the received first morpheme information “Sato, like” among the topic titles (820) 1-1, 1-2, based on the comparison result. The topic retrieval unit 1370 outputs the retrieved topic title (820) 1-1 (Sato; *; like) as a retrieval result signal to the reply retrieval unit 1380.

### [Reply Retrieval Unit]

The reply retrieval unit 1380 retrieves, based on the topic title 820 retrieved by the elliptical sentence complementation unit 1360 or the topic retrieval unit 1370, a reply sentence associated with the topic title 820. In addition, the reply retrieval unit 1380 compares, based on the topic title 820 retrieved by the topic retrieval unit 1370, the response types associated with the topic title 820 and the utterance type determined by the input type determining unit 1440. The reply retrieval unit 1380, which has executed the comparison, retrieves one response type related to the determined utterance type among the response types.

In the example shown in FIG. 21, when the topic title retrieved by the topic retrieval unit 1370 is the topic title 1-1 (Sato; *; like), the reply retrieval unit 1380 specifies the response type (for example, DA) coincident with the “uttered sentence type” (DA) determined by the input type determining unit 1440 among the reply sentences 1-1 (DA, TA and so on) associated with the topic title 1-1. The reply retrieval unit 1380, which has specified the response type (DA), retrieves the reply sentence 1-1 (“I like Sato, too.”) associated with the response type (DA) based on the specified response type (DA).

Here, “A” in above-mentioned “DA”, “TA” and so on means an affirmative form. Therefore, when the utterance types and the response types include “A”, it indicates an affirmation on a certain matter. In addition, the utterance types and the response types can include the types of “DQ”, “TQ” and so on. “Q” in “DQ”, “TQ” and so on means a question about a certain matter.

If the response type takes an interrogative form (Q), a reply sentence associated with this response type takes an affirmative form (A). A reply sentence with an affirmative form (A) may be a sentence for replying to a question and so on. For example, when an uttered sentence is “Have you ever operated slot machines?”, the utterance type of the uttered sentence is an interrogative form (Q). A reply sentence associated with this interrogative form (Q) may be “I have operated slot machines before,” (affirmative form (A)), for example.

On the other hand, when the response type is an affirmative form (A), a reply sentence associated with this response type takes an interrogative form (Q). A reply sentence in an interrogative form (Q) may be an interrogative sentence for asking back against uttered contents, an interrogative sentence for getting out a certain matter. For example, when the uttered sentence is “Playing slot machines is my hobby,” the utterance type of this uttered sentence takes an affirmative form (A). A reply sentence associated with this affirmative form (A) may be “Playing pachinko is your hobby, isn't it?” (an interrogative sentence (Q) for getting out a certain matter), for example.

The reply retrieval unit 1380 outputs the retrieved reply sentence 830 as a reply sentence signal to the managing unit 1310. The managing unit 1310, which has received the reply sentence signal from the reply retrieval unit 1380, outputs the received reply sentence signal to the output unit 1600.

### [CA Conversation Process Unit]

When a reply sentence in response to a user's utterance has not been determined by the plan conversation process unit 1320 or the discourse space conversation control process unit 1330, the CA conversation process unit 1340 functions to output a reply sentence for continuing a conversation with a user according to contents of the user's utterance.

The configuration example of the conversation controller 1000 is further described with referring back to FIG. 9.

### [Output Unit]

The output unit 1600 outputs the reply sentence retrieved by the reply retrieval unit 1380. The output unit 1600 may be a speaker or a display, for example. Specifically, the output unit 1600, which has received the reply sentence from the reply retrieval unit 1380, outputs voice sounds of the received reply sentence (for example, “I like Sato, too,”) based on the received reply sentence. With that, describing the configuration example of the conversation controller 1000 has ended.

### [Conversation Control Method]

The conversation controller 100 with the above-mentioned configuration puts a conversation control method in execution by operating as described hereinbelow.

Next, operations of the conversation controller 1000, more specifically the conversation control unit 1300, according to the present embodiment will be described.

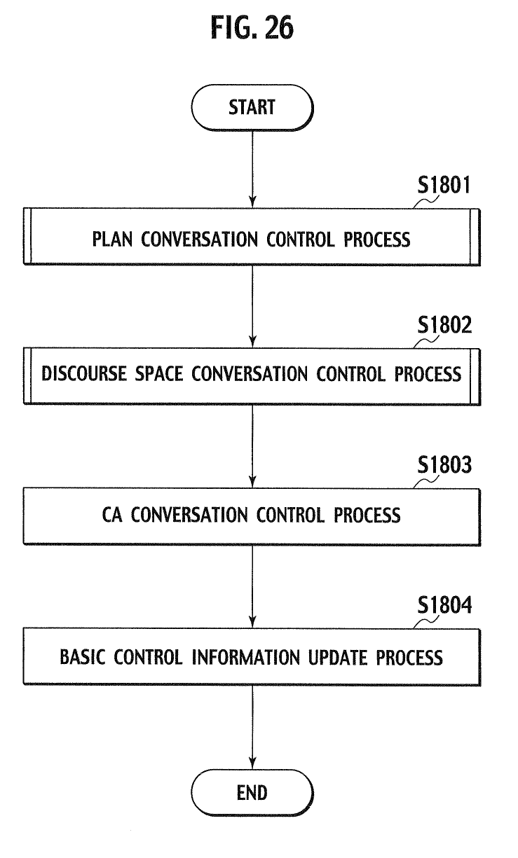

FIG. 26 is a flowchart showing an example of a main process executed by conversation control unit 1300. This main process is a process executed each time when the conversation control unit 1300 receives a user's utterance. A reply sentence in response to the user's utterance is output due to an execution of this main process, so that a conversation (an interlocution) between a user and the conversation controller 100 is established.

Upon executing the main process, the conversation controller 100, more specifically the plan conversation process unit 1320 firstly executes a plan conversation control process (S1801). The plan conversation control process is a process for executing a plan(s).

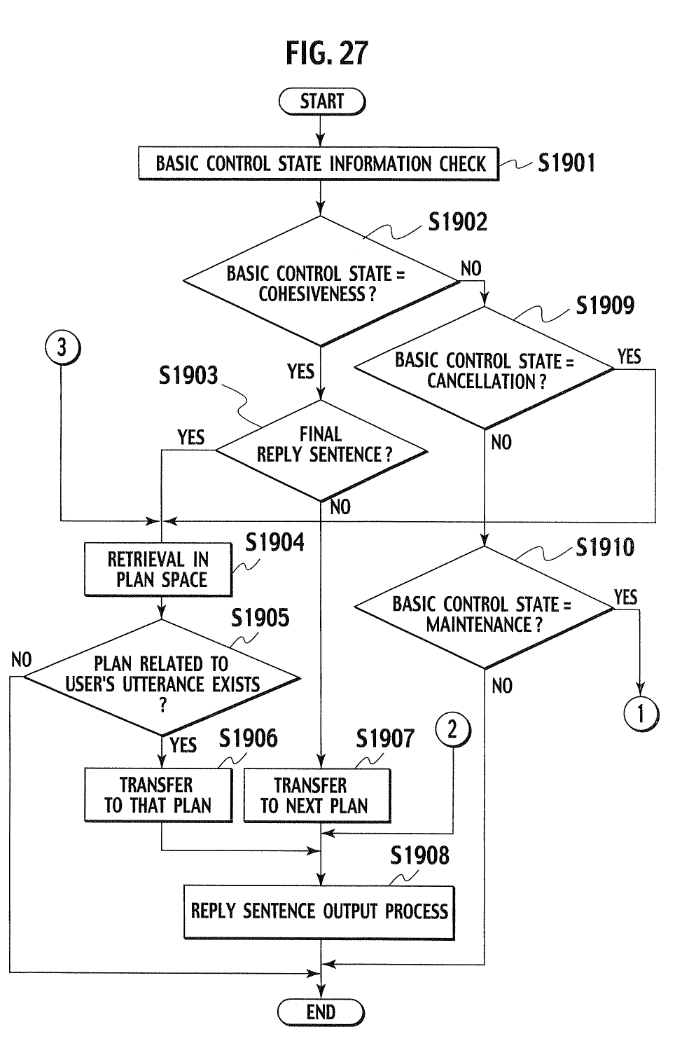

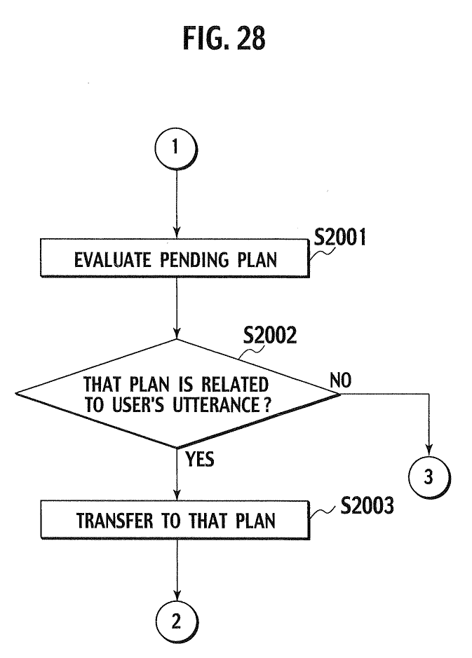

FIGS. 27 and 28 are flow charts showing an example of the plan conversation control process. Hereinbelow, the example of the plan conversation control process will be described with reference to FIGS. 27 and 28.

Upon executing the plan conversation control process, the plan conversation process unit 1320 firstly executes a basic control state information check (S1901). The basic control state information is information on whether or not an execution(s) of a plan(s) has been completed and is stored in a predetermined memory area.

The basic control state information serves to indicate a basic control state of a plan.

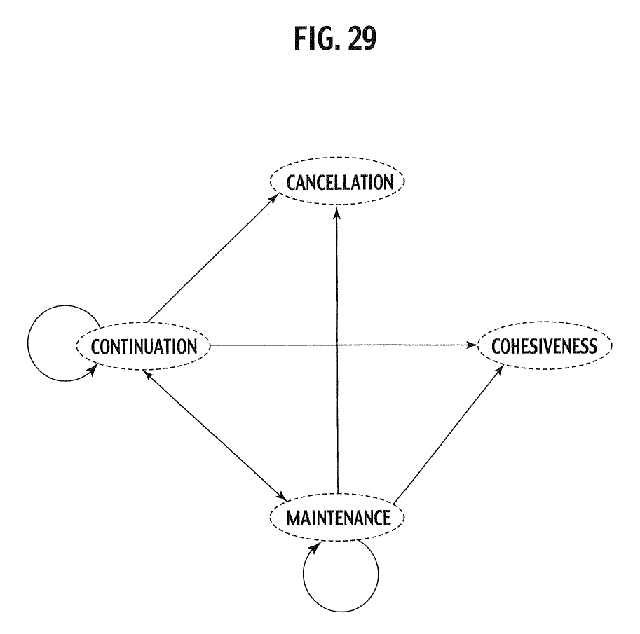

FIG. 29 is a diagram showing four basic control states which are possibly established due to a so-called scenario-type plan.

### (1) Cohesiveness

This basic control state corresponds to a case where a user's utterance is coincident with the currently executed plan 1402, more specifically the topic title 820 or the example sentence 1701 associated with the plan 1402. In this case, the plan conversation process unit 1320 terminates the plan 1402 and then transfers to another plan 1402 corresponding to the reply sentence 1501 designated by the next-plan designation information 1502.

### (2) Cancellation

This basic control state is a basic control state which is set in a case where it is determined that user's utterance contents require a completion of a plan 1402 or that a user's interest has changed to another matter than the currently executed plan. When the basic control state indicates the cancellation, the plan conversation process unit 1320 retrieves another plan 1402 associated with the user's utterance than the plan 1402 targeted as the cancellation. If the other plan 1402 exists, the plan conversation process unit 1320 start to execute the other plan 1402. If the other plan 1402 does not exist, the plan conversation process unit 1320 terminates an execution(s) of a plan(s)

### (3) Maintenance

This basic control state is a basic control state which is set in a case where a user's utterance is not coincident with the topic title 820 (see FIG. 21) or the example sentence 1701 (see FIG. 25) associated with the currently executed plan 1402 and also the user's utterance does not correspond to the basic control state “cancellation”.

In the case of this basic control state, the plan conversation process unit 1320 firstly determines whether or not to resume a pending or pausing plan 1402 on receiving the user's utterance. If the user's utterance is not adapted for resuming the plan 1402, for example, in case where the user's utterance is not related to a topic title 820 or an example sentence 1701 associated with the plan 1402, the plan conversation process unit 1320 starts to execute another plan 1402, an after-mentioned discourse space conversation control process (S1802) and so on. If the user's utterance is adapted for resuming the plan 1402, the plan conversation process unit 1320 outputs a reply sentence 1501 based on the stored next-plan designation information 1502.

In case where the basic control state is the “maintenance”, the plan conversation process unit 1320 retrieves other plans 1402 in order to enable outputting another reply sentence than the reply sentence 1501 associated with the currently executed plan 1402, or executes the discourse space conversation control process. However, if the user's utterance is adapted for resuming the plan 1402, the plan conversation process unit 1320 resumes the plan 1402.

### (4) Continuation

This state is a basic control state which is set in a case where a user's utterance is not related to reply sentences 1501 included in the currently executed plan 1402, contents of the user's utterance do not correspond to the basic control sate “cancellation” and use's intention construed from the user's utterance is not clear.

In case where the basic control state is the “continuation”, the plan conversation process unit 1320 firstly determines whether or not to resume a pending or pausing plan 1402 on receiving the user's utterance. If the user's utterance is not adapted for resuming the plan 1402, the plan conversation process unit 1320 executes an after-mentioned CA conversation control process in order to enable outputting a reply sentence for getting out a further user's utterance.

The plan conversation control process is further described with referring back to FIG. 27.

The plan conversation process unit 1320, which has referred to the basic control state, determines whether or not the basic control state indicated by the basic control state information is the “cohesiveness” (step S1902). If it has been determined that the basic control state is the “cohesiveness” (YES in step S1902), the plan conversation process unit 1320 determines whether or not the reply sentence 1501 is the final reply sentence in the currently executed plan 1402 (step S1903).

If it has been determined that the final reply sentence 1501 has been output already (YES in step S1903), the plan conversation process unit 1320 retrieves another plan 1402 related to the use's utterance in the plan space in order to determine whether or not to execute the other plan 1402 (step S1904) because the plan conversation process unit 1320 has provided all contents to be replied to the user already. If the other plan 1402 related to the user's utterance has not been found due to this retrieval (NO in step S1905), the plan conversation process unit 1320 terminates the plan conversation control process because no plan 1402 to be provided to the user exists.

On the other hand, if the other plan 1402 related to the user's utterance has been found due to this retrieval (YES in step S1905), the plan conversation process unit 1320 transfers into the other plan 1402 (step S1906). Since the other plan 1402 to be provided to the user still remains, an execution of the other plan 1402 (an output of the reply sentence 1501 included in the other plan 1402) is started.

Next, the plan conversation process unit 1320 outputs the reply sentence 1501 included in that plan 1402 (step S1908). The reply sentence 1501 is output as a reply to the user's utterance, so that the plan conversation process unit 1320 provides information to be supplied to the user.

The plan conversation process unit 1320 terminates the plan conversation control process after the reply sentence output process (step S1908).

On the other hand, if the previously output reply sentence 1501 is not determined as the final reply sentence in the determination whether or not the previously output reply sentence 1501 is the final reply sentence (step S1903), the plan conversation process unit 1320 transfers into a plan 1402 associated with the reply sentence 1501 following the previously output reply sentence 1501, i.e. the specified reply sentence 1501 by the next-plan designation information 1502 (step S1907).

Subsequently, the plan conversation process unit 1320 outputs the reply sentence 1501 included in that plan 1402 to provide a reply to the user's utterance (step 1908). The reply sentence 1501 is output as the reply to the user's utterance, so that the plan conversation process unit 1320 provides information to be supplied to the user. The plan conversation process unit 1320 terminates the plan conversation control process after the reply sentence output process (step S1908).

Here, if the basic control state is not the “cohesiveness” in the determination process in step S1902 (NO in step S1902), the plan conversation process unit 1320 determines whether or not the basic control state indicated by the basic control state information is the “cancellation” (step S1909). If it has been determined that the basic control state is the “cancellation” (YES in step S1909), the plan conversation process unit 1320 retrieves another plan 1402 related to the use's utterance in the plan space 1401 in order to determine whether or not the other plan 1402 to be started newly exists (step S1904) because a plan 1402 to be successively executed does not exist. Subsequently, the plan conversation process unit 1320 executes the processes of steps S1905 to S1908 as well as the processes in case of the above-mentioned step S1903 (YES).

On the other hand, if the basic control state is not the “cancellation” in the determination process in step S1902 (NO in step S1902) in the determination whether or not the basic control state indicated by the basic control state information is the “cancellation” (step S1909), the plan conversation process unit 1320 further determines whether or not the basic control state indicated by the basic control state information is the “maintenance” (step S1910).

If the basic control state indicated by the basic control state information is the “maintenance” (YES in step S1910), the plan conversation process unit 1320 determined whether or not the user presents the interest on the pending or pausing plan 1402 again and then resumes the pending or pausing plan 1402 in case where the interest is presented (step S2001 in FIG. 28). In other words, the plan conversation process unit 1320 evaluates the pending or pausing plan 1402 (step S2001 in FIG. 28) and then determines whether or not the user's utterance is related to the pending or pausing plan 1402 (step S2002).

If it has been determined that the user's utterance is related to that plan 1402 (YES in step S2002), the plan conversation process unit 1320 transfers into the plan 1402 related to the user's utterance (step S2003) and then executes the reply sentence output process (step S1908 in FIG. 27) to output the reply sentence 1501 included in the plan 1402. Operating in this manner, the plan conversation process unit 1320 can resume the pending or pausing plan 1402 according to the user's utterance, so that all contents included in the previously prepared plan 1402 can be provided to the user.

On the other hand, if it has been determined that the user's utterance is not related to that plan 1402 (NO in step S2002) in the above-mentioned S2002 (see FIG. 28), the plan conversation process unit 1320 retrieves another plan 1402 related to the use's utterance in the plan space 1401 in order to determine whether or not the other plan 1402 to be started newly exists (step S1904 in FIG. 27). Subsequently, the plan conversation process unit 1320 executes the processes of steps S1905 to S1908 as well as the processes in case of the above-mentioned step S1903 (YES).

If it is determined that the basic control state indicated by the basic control state information is not the “maintenance” (NO in step S1910) in the determination in step S1910, it means that the basic control state indicated by the basic control state information is the “continuation”. In this case, the plan conversation process unit 1320 terminates the plan conversation control process without outputting a reply sentence. With that, describing the plan control process has ended.

The main process is further described with referring back to FIG. 26. The conversation control unit 1300 executes the discourse space conversation control process (step S1802) after the plan conversation control process (step S1801) has been completed. Note that, if the reply sentence has been output in the plan conversation control process (step S1801), the conversation control unit 1300 executes a basic control information update process (step S1804) without executing the discourse space conversation control process (step S1802) and the after-mentioned CA conversation control process (step S1803) and then terminates the main process.

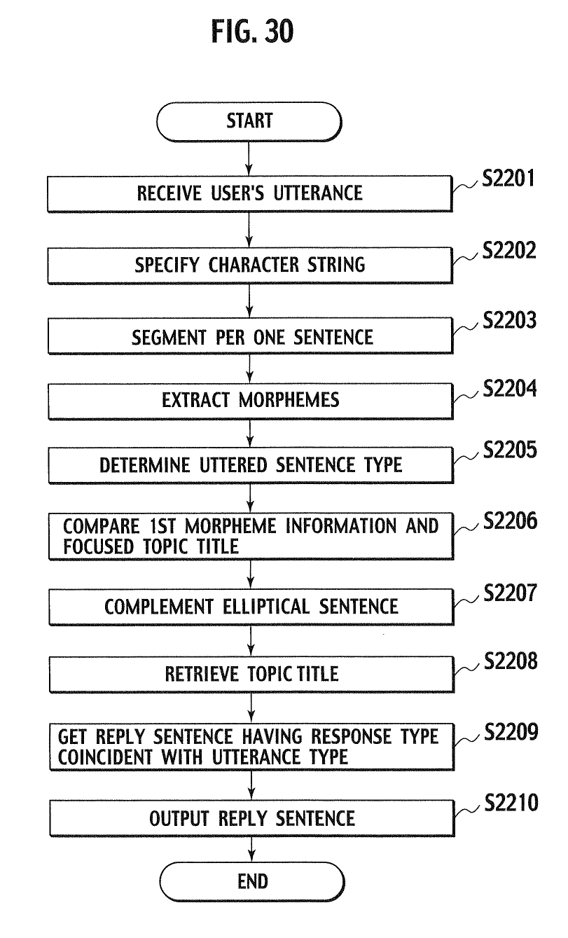

FIG. 30 is a flow chart showing an example of a discourse space conversation control process according to the present embodiment. The input unit 1100 firstly executes a step for receiving a user's utterance (step S2201). Specifically, the input unit 1100 receives voice sounds of the user's utterance. The input unit 1100 outputs the received voice sounds to the speech recognition unit 1200 as a voice signal. Note that the input unit 1100 may receive a character string input by a user (for example, text data input in a text format) instead of the voice sounds. In this case, the input unit 1100 may be a text input device such as a keyboard or a touchscreen.

Next, the speech recognition unit 1200 executes a step for specifying a character string corresponding to the uttered contents based on the uttered contents retrieved by the input unit 1100 (step S2202). Specifically, the speech recognition unit 1200, which has received the voice signal from the input unit 1100, specifies a word hypothesis (candidate) corresponding to the voice signal based on the received voice signal. The speech recognition unit 1200 retrieves a character string corresponding to the specified word hypothesis and outputs the retrieved character string to the conversation control unit 1300, more specifically the discourse space conversation control process unit 1330, as a character string signal.

And then, the character string specifying unit 1410 segments a series of the character strings specified by the speech recognition unit 1200 into segments (step S2203). Specifically, if the series of the character strings have a time interval more than a certain interval, the character string specifying unit 1410, which has received the character string signal or a morpheme signal from the managing unit 1310, segments the character strings there. The character string specifying unit 1410 outputs the segmented character strings to the morpheme extracting unit 1420 and the input type determining unit 1440. Note that it is preferred that the character string specifying unit 1410 segments a character string at a punctuation, a space and so on in a case where the character string has been input from a keyboard.

Subsequently, the morpheme extracting unit 1420 executes a step for extracting morphemes constituting minimum units of the character string as first morpheme information based on the character string specified by the character string specifying unit 1410 (step S2204). Specifically, the morpheme extracting unit 1420, which has received the character strings from the character string specifying unit 1410, compares the received character strings and morpheme groups previously stored in the morpheme database 1430. Note that, in the present embodiment, each of the morpheme groups is prepared as a morpheme dictionary in which a direction word, a reading, a word class and an inflected forms are described for each morpheme belonging to each word-class classification.

The morpheme extracting unit 1420, which has executed the comparison, extracts coincident morphemes (m1, m2, . . . ) with the morphemes included in the previously stored morpheme groups from the received character string. The morpheme extracting unit 1420 outputs the extracted morphemes to the topic specification information retrieval unit 1350 as the first morpheme information.

Next, the input type determining unit 1440 executes a step for determining the “uttered sentence type” based on the morphemes which constitute one sentence and are specified by the character string specifying unit 1410 (step S2205). Specifically, the input type determining unit 1440, which has received the character strings from the character string specifying unit 1410, compares the received character strings and the dictionaries stored in the utterance type database 1450 based on the received character strings and extracts elements relevant to the dictionaries among the character strings. The input type determining unit 1440, which has extracted the elements, determines to which “uttered sentence type” the extracted element(s) belongs based on the extracted element(s). The input type determining unit 1440 outputs the determined “uttered sentence type” (utterance type) to the reply retrieval unit 1380.

And then, the topic specification information retrieval unit 1350 executes a step for comparing the first morpheme information extracted by the morpheme extracting unit 1420 and the focused topic title 820_{focus} (step S2206).

If a morpheme in the first morpheme information is related to the focused topic title 820_{focus}, the topic specification information retrieval unit 1350 outputs the focused topic title 820_{focus} to the reply retrieval unit 1380. On the other hand, if no morpheme in the first morpheme information is related to the focused topic title 820_{focus}, the topic specification information retrieval unit 1350 outputs the received first morpheme information and the user input sentence topic specification information to the elliptical sentence complementation unit 1360 as the retrieval command signal.

Subsequently, the elliptical sentence complementation unit 1360 executes a step for including the focused topic specification information and the reply sentence topic specification information into the received first morpheme information based on the first morpheme information received from the topic specification information retrieval unit 1350 (step S2207). Specifically, if it is assumed that the first morpheme information is defined as “W” and a set of the focused topic specification information and the reply sentence topic specification information is defined as “D”, the elliptical sentence complementation unit 1360 generates the complemented first morpheme information by including an element(s) in the set “D” into the first morpheme information “W” and compares the complemented first morpheme information and all the topic titles 820 to retrieve the topic title 820 related to the complemented first morpheme information. If the topic title 820 related to the complemented first morpheme information has been found, the elliptical sentence complementation unit 1360 outputs the topic title 820 to the reply retrieval unit 1380. On the other hand, if no topic title 820 related to the complemented first morpheme information has been found, the elliptical sentence complementation unit 1360 outputs the first morpheme information and the user input sentence topic specification information to the topic retrieval unit 1370.

Next, the topic retrieval unit 1370 executes a step for comparing the first morpheme information and the user input sentence topic specification information and retrieves the topic title 820 best-suited for the first morpheme information among the topic titles 820 (step S2208). Specifically, the topic retrieval unit 1370, which has received the retrieval command signal from the elliptical sentence complementation unit 1360, retrieves the topic title 820 best-suited for the first morpheme information among topic titles 820 associated with the user input sentence topic specification information based on the user input sentence topic specification information and the first morpheme information included in the received retrieval command signal. The topic retrieval unit 1370 outputs the retrieved topic title 820 to the reply retrieval unit 1380 as the retrieval result signal.

Next, the reply retrieval unit 1380 compares, in order to select the reply sentence 830, the user's utterance type determined by the sentence analyzing unit 1400 and the response type associated with the retrieved topic title 820 based on the retrieved topic title 820 by the topic specification information retrieval unit 1350, the elliptical sentence complementation unit 1360 or the topic retrieval unit 1370 (step S2209).

The reply sentence 830 is selected in particular as explained hereinbelow. Specifically, based on the “topic title” associated with the received retrieval result signal and the received “uttered sentence type”, the reply retrieval unit 1380, which has received the retrieval result signal from the topic retrieval unit 1370 and the “uttered sentence type” from the input type determining unit 1440, specifies one response type coincident with the “uttered sentence type” (for example, DA) among the response types associated with the “topic title”.

Consequently, the reply retrieval unit 1380 outputs the reply sentence 830 retrieved in step S2209 to the output unit 1600 via the managing unit 1310 (S2210). The output unit 1600, which has received the reply sentence 830 from the managing unit 1310, outputs the received reply sentence 830.

With that, describing the discourse space conversation control process has ended and the main process is further described with referring back to FIG. 26.

The conversation control unit 1300 executes the CA conversation control process (step S1803) after the discourse space conversation control process has been completed. Note that, if the reply sentence has been output in the plan conversation control process (step S1801) or the discourse space conversation control (step S1802), the conversation control unit 1300 executes the basic control information update process (step S1804) without executing the CA conversation control process (step S1803) and then terminates the main process.

The CA conversation control process is a process in which it is determined whether a user's utterance is an utterance for “explaining something”, an utterance for “confirming something”, an utterance for “accusing or rebuking something” or an utterance for “other than these”, and then a reply sentence is output according to the user's utterance contents and the determination result. By the CA conversation control process, a so-called “bridging” reply sentence for continuing the uninterrupted conversation with the user can be output even if a reply sentence suited for the user's utterance can not be output by the plan conversation control process nor the discourse space conversation control process.

Next, the conversation control unit 1300 executes the basic control information update process (step S1804). In this process, the conversation control unit 1300, more specifically the managing unit 1310, sets the basic control information to the “cohesiveness” when the plan conversation process unit 1320 has output a reply sentence, sets the basic control information to the “cancellation” when the plan conversation process unit 1320 has cancelled an output of a reply sentence, sets the basic control information to the “maintenance” when the discourse space conversation control process unit 1330 has output a reply sentence, or sets the basic control information to the “continuation” when the CA conversation process unit 1340 has output a reply sentence.

The basic control information set in this basic control information update process is referred in the above-mentioned plan conversation control process (step S1801) to be employed for continuation or resumption of a plan.

As described the above, the conversation controller 1000 can executes a previously prepared plan(s) or can adequately respond to a topic(s) which is not included in a plan(s) according to a user's utterance by executing the main process each time when receiving the user's utterance.

In the gaming terminal 4 of the present embodiment, the input unit 1100 of the conversation controller 1000 explained above may be configured by the touchscreen 50 attached to the display 8 and the microphone 15. In addition, the output unit 1600 may be configured by the display 8 and the speaker 10. Furthermore, the speech recognition unit 1200; the conversation control unit 1300; and the character string specifying unit 1410, the morpheme extraction portion 1420 and the input type determining portion 1440 of the sentence analyzing unit 1400 may be configured by the terminal controller 90. In addition, the morpheme database 1430 and the utterance type database 1450 of the sentence analyzing unit 1400, and the speech recognition dictionary memory 1700 can be configured by the first external storage unit 99. Note that, although the conversation database 1500 can be stored also in the first external storage unit 99, it is stored in the HDD 34 of the above-mentioned server 13 in the present embodiment (see FIG. 6). And, as explained later, there are methods such as directly accessing the HDD 34 and downloading the conversation data stored in the HDD 34 at the time when using the conversation data stored in the conversation database 1500.

And, in the present embodiment, the language to be used in the roulette game can be determined through a conversation with the player by the conversation engine achieved with the above-mentioned configuration in the gaming terminal 4 by the conversation controller 1000.

Here, the speech recognition dictionary memory 1700 of the conversation controller 1000 configured by the first external storage unit 99 has word dictionaries for the plural languages in order to confirm a language type of sound messages input into the microphone 15 by the player. In addition, the morphological database 1430 of the conversation controller 1000 configured by the first external storage unit 99 has the morpheme groups for the plural languages (morpheme dictionaries). Furthermore, the utterance type database 1450 of the conversation controller 1000 configured by the first external storage unit 99 also has dictionaries of the respective utterance types for the plural languages.

In addition, “sentence” data for the plural languages are also stored in the conversation database 1500 configured by the terminal controller 90 in order to output sound messages from the speaker 10 to the player in the language selected by the player or to display the messages on the display 8. The “sentences” include a message for requesting an input (by an utterance or an operation on the display 8) of a specific phrase or sentence in the language desired to be used in the roulette game, a message for confirming the player to proceed the roulette game in the language of the input specific phrase or sentence, or the like.

The operations of the above-mentioned conversation engine of the gaming terminal 4 of the present embodiment will be explained later.

Next, contents of gaming processing executed in each of the server 13, the roulette unit 2 and the gaming terminals 4 on the roulette game machine 1 according to the present embodiment will be explained.

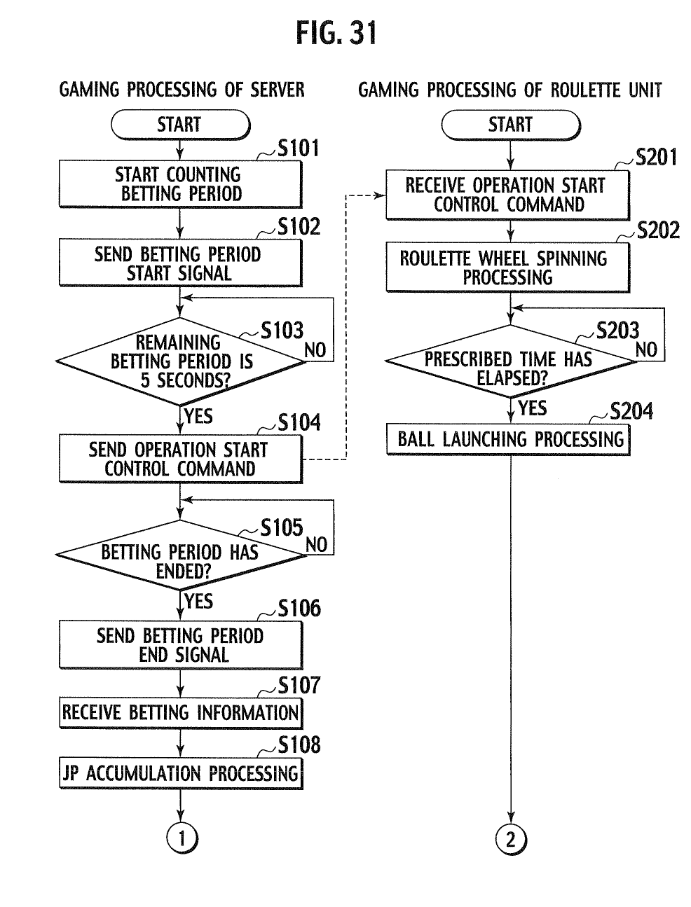

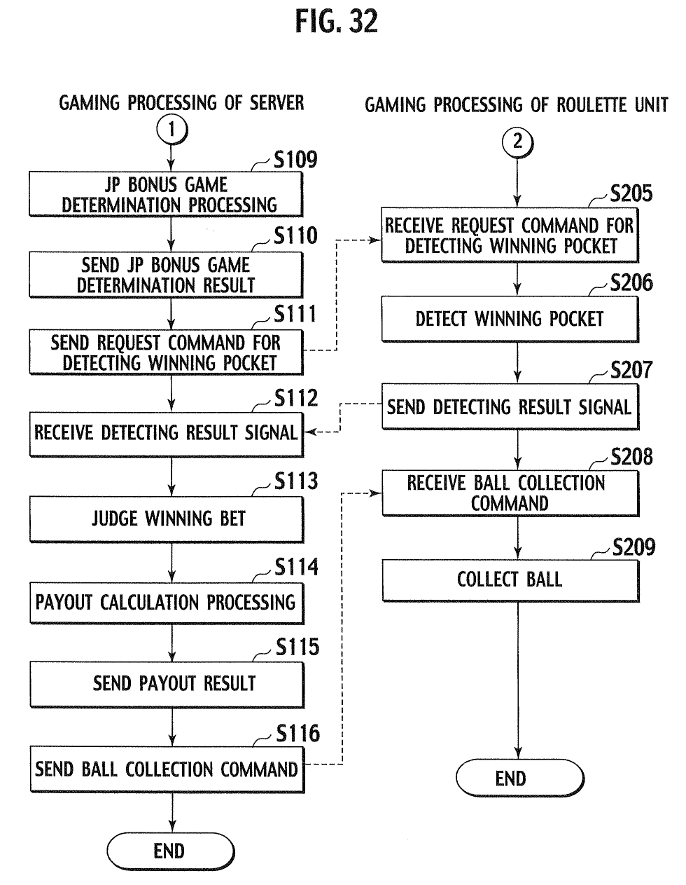

To begin with, gaming processing of the server, which is executed by the server CPU 81 of the server 13 according to the programs stored in the ROM 82, and gaming processing of the roulette unit, which is executed by the CPU 101 of the roulette unit 2 according to the programs stored in the ROM 102, will explained based on FIGS. 31 and 32. FIGS. 31 and 32 are flow charts of the gaming processings of the server and the roulette unit in the roulette gaming machine according to the present embodiment.

First, the gaming processing of the server 13 will be explained based on FIGS. 31 and 32. At first, as shown in FIG. 31, the server CPU 81 starts counting the betting period (step S101). The betting period is a period during which a player can place a bet(s). A player participating in a game can place a bet on the bet area 72 (see FIG. 5) which corresponds to the number predicted by the player during the betting period. The server CPU 81 sends a betting period start signal to the terminal CPU 91 when the betting period counting has been started (step S102).

Next, the server CPU 81 determines whether or not the remaining betting period has reached five seconds (step S103). Note that the remaining betting period is displayed on the bet time counter 69 on the display 8 at each of the gaming terminals 4 (see FIG. 5). If it is determined that it has not reached the last five seconds, the processing will be returned to the step S103. On the other hand, if it is determined that it has reached the last five seconds, the processing will proceed to the step S104.

The server CPU 81 sends a control command to the CPU 101 of the roulette unit 2 to start the operation of the roulette unit 2 (step S104). Next, the server CPU 81 determines whether or not the betting period has ended (step S105). If it is determined that the betting period has not ended (NO in step S105), the server CPU 81 suspends the processing until the betting period ends. On the other hand, if it is determined that the betting period has ended (YES in step S105), the server CPU 81 sends a betting period end signal indicating the expiry of the betting period to the terminal CPU 91 (step S106).

Next, the server CPU 81 receives the betting information (the information such as a specified bet area 72, a bet amount of chips and a betting type) input at each of the gaming terminals 4 by players from each of the terminal CPU's 91 (step S107) and stores it into the betting information storing area in the RAM 83.

Subsequently, the server CPU 81 executes a JP accumulation processing (step S108). In this JP accumulation processing, 0.30% of the total credits which have been bet at all the gaming terminals 4 and received in step S107 is accumulatively added to a JP amount stored in a “MINI” JP accumulation storing area in the RAM 83. In addition, in the JP accumulation processing, 0.20% of the total credits which have been bet at all the gaming terminals 4 and received in step S107 is accumulatively added to a JP amount stored in A “MAJOR” JP accumulation storing area in the RAM 83. Furthermore, in the JP accumulation processing, 0.15% of the total credits which have been bet at all the gaming terminals 4 and received in step S107 is accumulatively added to a JP amount stored in the “MEGA” JP accumulation storing area in the RAM 83. In addition, in the JP accumulation processing, displays in a MEGA counter 73, a MAJOR counter 74 and a MINI counter 75 are updated based on the accumulated JP amounts.

Next, as shown in FIG. 32, the server CPU 81 executes a JP bonus game determination processing (step S109). In this processing, the server CPU 81 determines whether or not to execute a JP bonus game at each of the gaming terminals 4 by using random number values sampled by a sampling circuit or the like, which of the gaming terminals 4 would win the JP (or all the gaming terminals 4 are to lose) in the case where the JP bonus game is to be executed and which JP (“MEGA”, “MAJOR” or “MINI”) is to be awarded in the case where the JP is to be awarded.

Next, the server CPU 81 sends a JP bonus game determination result to each of the gaming terminals 4 based on the process of step S109 (step S110). Subsequently, the server CPU 81 sends a control command to the CPU 101 of the roulette device 2 in order for the CPU 101 to detect the number pocket 23 into which the ball 27 has fallen into in the roulette unit 2 (step S111). Then, the server CPU 81 receives a control signal indicating the number pocket 23 into which the ball 27 has fallen from the CPU 101 of the roulette unit 2 (step S112).

Next, the server CPU 81 determines whether or not the bet placed at each of the gaming terminals 4 has won based on the betting information of each the gaming terminals 4 received in step S107 and the control signal indicating the number pocket 23 into which the ball 27 has fallen received in step S112 (step S113).

Next, the server CPU 81 executes a payout calculation processing (step S114). In the payout calculation processing, the server CPU 81 firstly specifies credits bet on the winning number for each of the gaming terminal 4 and then calculates the total payout credits to be paid out for each of the gaming terminals 4 by using odds (a credit amount to be paid out per one chip (one bet)) for each bet area 72 which is stored in an odds storing area in the ROM 82.

Next, the server CPU 81 executes a sending processing of the payout result of credits for a game based on the payout calculation processing of step S113 and the JP payout result based on the JP bonus game determination processing of step S109 (step S115). Specifically, the credit data, which corresponds to the payout credits for the game to the terminal CPU 91 of each of the winning gaming terminals 4, is output and the credit data, which corresponds to the currently accumulated JP credits, is output in the case where the JP is to be awarded. Next, the server CPU 81 sends a request command for collecting the ball 27 on the roulette wheel 22 to the CPU 101 of the roulette unit 2 (step S116). After the process of step S116, this subroutine is terminated.

Next, the gaming processing of the roulette unit 2 will be explained based on FIGS. 31 and 32. To begin with, as shown in FIG. 31, the CPU 101 receives the control command for staring the operation of the roulette unit 2 from the server CPU 81 of the server 13 (step S201).

Subsequently, the CPU 101 drives the wheel drive motor 106 to spin the roulette wheel 22 (step S202).

Next, after a prescribed time period has elapsed since the roulette wheel 22 starts spinning (YES in step S203), the CPU 101 launches the ball 27 at the time when a launching delay time has elapsed since it receives a detection signal from the pocket position detecting circuit 107 (step S204).

Next, as shown in FIG. 32, the CPU 101 receives the control command for detecting the pocket 23 into which the ball 27 has fallen from the server CPU 81 of the server 13 (step S205). Next, the CPU 101 determines which of the number pocket 23 into which the ball 27 has fallen by operating the ball sensor 105 (step S206). And then, the CPU 101 sends the detection result indicating the number pocket 23 into which the ball 27 has fallen to the server CPU 81 of the server 13 (step S207).

Next, the CPU 101 receives the request command for collecting the ball 27 from the server CPU 81 of the server 13 (step S208). Next, the CPU 101 collects the ball 27 on the roulette wheel 22 by operating the ball collecting unit 108 provided beneath the roulette wheel 22 (step S209). The collected ball 27 will be launched onto the roulette wheel 22 again by the ball launching unit 104 in the next game. After the process of step S209, this subroutine is terminated.

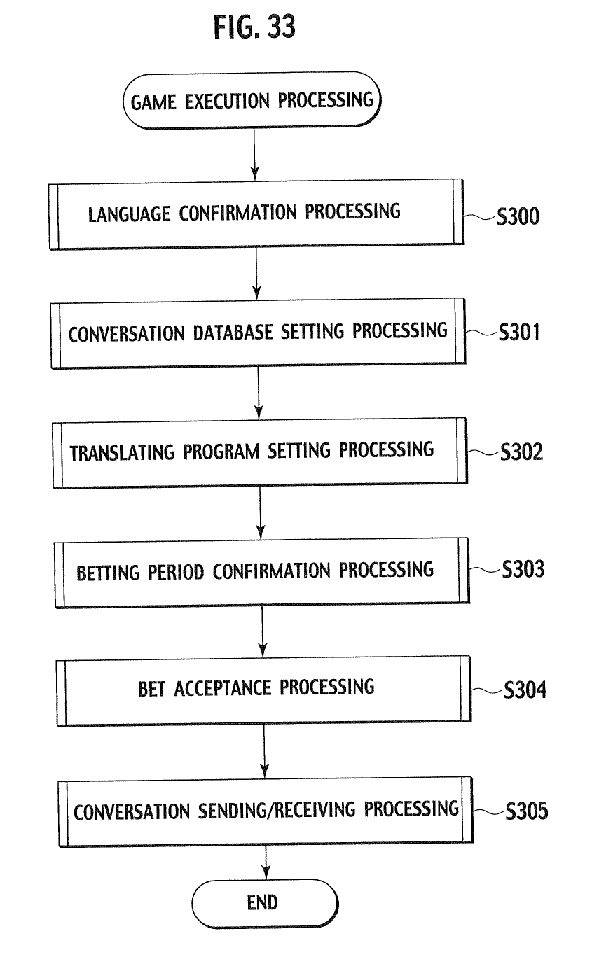

Next, processes executed by the terminal CPU 91 of the gaming terminal 4 of the roulette gaming machine 1 according to the present embodiment in accordance with the programs stored in the ROM 92 will be explained with reference to FIGS. 33 to 44.

Here, the flag F in the RAM 93 is set to a default value “1” which indicates during the betting period. In addition, a default bet screen 61 shown in FIG. 5 is displayed on the display 8 of the gaming terminal 4. In this state, as shown in FIG. 33, the terminal CPU 91 first executes language confirmation processing (step S300), then executes conversation database setting processing (step S301), then executes translating program setting processing (step S302), then executes betting period confirmation processing (step S303), then executes bet acceptance processing (step S304), and then executes conversation sending/receiving processing (step S305).

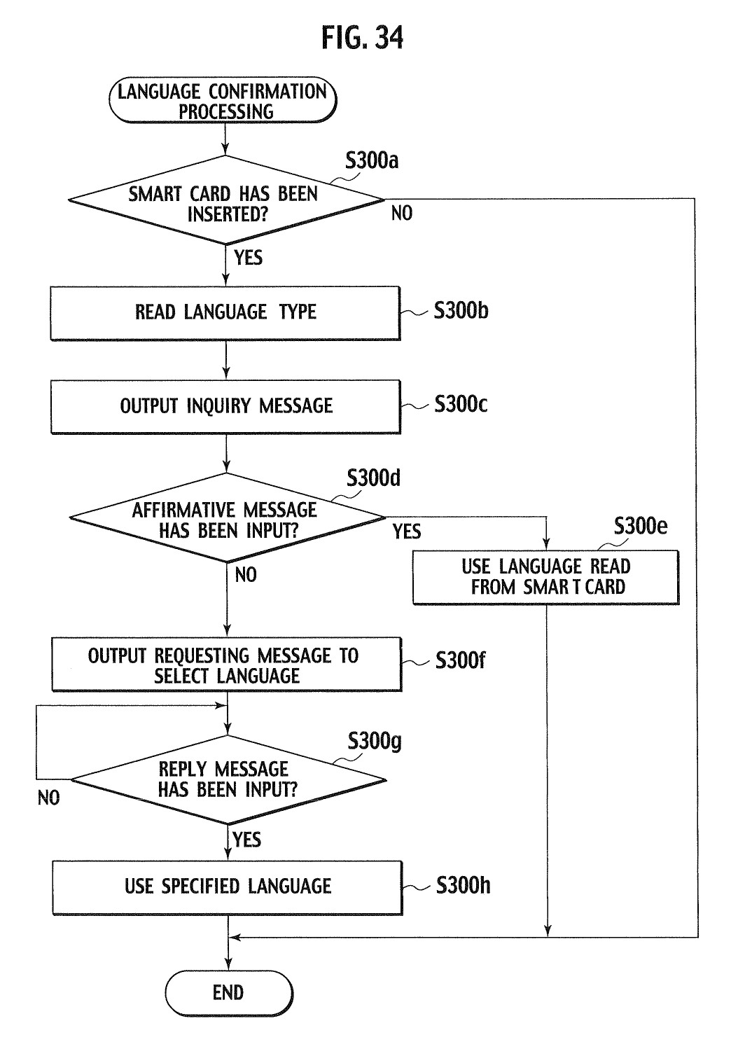

Then, in the language confirmation processing of step S300, the terminal CPU 91 confirms whether or not a new smart card has been inserted into the card reader 16 as shown in FIG. 34 (step S300a). If it is not inserted (NO in step S300a), the language confirmation processing is terminated. If it is inserted (YES in step S300a), the terminal CPU 91 reads, from the inserted smart card, a language type used in a game play by a player who possesses the smart card (step S300b).

Next, the terminal CPU 91 outputs a message inquiring whether or not a game is proceeded in the read-out language type (step S300c). The message may be output as sound from the speaker 10 via the sound input circuit 98, as texts on the display 8 via the LCD drive circuit 95 and so on.

For example, if the language type read by the card reader 16 from the smart card is English and a sound message is to be output from the speaker 10, the terminal CPU 91 outputs sound “English will be used. Is it all right?”

If the language type read by the card reader 16 from the smart card is English, the terminal CPU 91 assumes that a sound input “I want to use English. Is it all right?” have been input into the input unit 1100 of the conversation controller 1000 configured by the microphone 15, and outputs the above-mentioned sound from the speaker 10 served as the output unit 1600 (see FIG. 9) by making the conversation controller 1000 to execute corresponding processing.

In addition, if the language type read by the card reader 16 from the smart card is English, the terminal CPU 91 may output sound “English will be used. Is it all right?” from the speaker 10 according to the programs stored in the ROM 92 without using the conversation controller 1000.

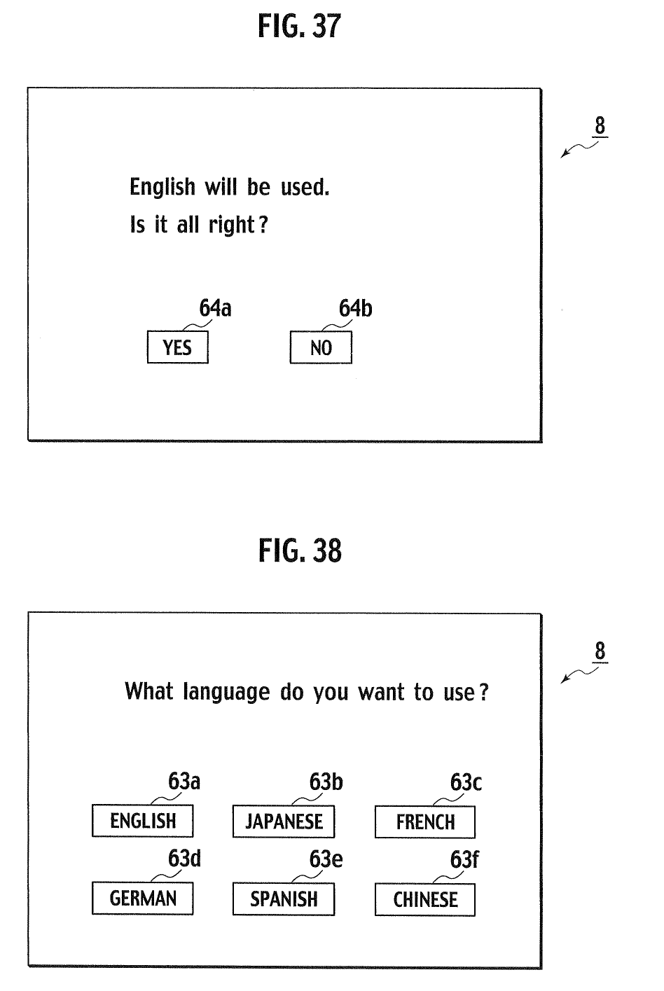

Alternatively, if the language type read by the card reader 16 from the smart card is English and a display message is to be output, the terminal CPU 91 displays sentences “English will be used. Is it all right?” on the display 8 together with “YES” and “NO”1 buttons 64a and 64b as shown in FIG. 37.

If the language type read by the card reader 16 from the smart card is English, the terminal CPU 91 assumes that character strings “I want to use English. Is it all right?” have been input into the input unit 1100 of the conversation controller 1000 configured by the touchscreen 50 on the display 8, and displays the above-mentioned sentences together with “YES” and “NO” buttons 64a and 64b on the display 8 served as the output unit 1600 by making the conversation controller 1000 to execute corresponding processing.

In addition, if the language type read by the card reader 16 from the smart card is English, the terminal CPU 91 may display sentences “English will be used. Is it all right?” on the display 8 together with “YES” and “NO” buttons 64a and 64b according to the programs stored in the ROM 92 without using the conversation controller 1000.

Next, the terminal CPU 91 determines whether or not an affirmative message has been input in response to the output message in step S300c (step S300d).

Here, if the message in step S300c has been output as sound, it can be confirmed whether or not the message has been input in response to the output message by confirming whether or not the input unit 1100 of the conversation controller 1000 configured by the microphone 15 receives an input after the message has been output in step S300c. Alternatively, if the message in step S300c has been displayed on the display 8 in English as shown in FIG. 37, it can be confirmed whether or not the message has been input in response to the output message by confirming whether or not a player's operation on the “YES” and “NO” buttons 64a and 64b displayed on the display 8 has been detected via the touchscreen 50.

In addition, it can be confirmed whether or not the input message in response to the output message in step S300c is an affirmative message by analyzing contents of the sound message input into the microphone 15 using the conversation controller 1000, or detecting which of the “YES” and “NO” buttons 64a and 64b displayed on the display 8 as shown in FIG. 37 has been operated by the player.

Then, if an affirmative message has been input (YES in step S300d), the terminal CPU 91 displays a bet screen 61 which is displayed on the display 8 during the betting period of the roulette game in the language read by the card reader 16 from the smart card (step S300e). For example, if the language type read by the card reader 16 from the smart card is English, a bet screen 61 presented in English as shown in FIG. 5 is displayed on the display 8 during the betting period of the roulette game. Subsequently, the terminal CPU 91 terminates the language confirmation processing.

On the other hand, if an affirmative message has not been input (NO in step S300d), the terminal CPU 91 outputs a message for selecting the type of language to be used for proceeding the roulette game (step S300f). The message may be output as sound from the speaker 10 via the sound output circuit 96, or as texts on the display 8 via the LCD drive circuit 95.

For example, when a sound message is to be output, the terminal CPU 91 outputs sound requesting to select the language to be used in a game from the speaker 10. For example, if the language type read by the card reader 16 from the smart card is English, sound “What language do you want to use?” is output from the speaker 10.

The requesting sound to select the language to be used in a game is output from the speaker 10 with the language type had been read by the card reader 16 from the smart card. If a sound input in the negative has been input to the input unit 1100 of the conversation controller 1000 configured by the microphone 15 in response to the inquiring sound whether or not to proceed the game play in the above-mentioned language, the terminal CPU 91 makes the conversation controller 1000 to execute corresponding processing and then outputs a processing result thereof from the speaker 10 served as the output unit 1600.

Alternatively, if a display message is to be output, the terminal CPU 91 displays a sentence and buttons for selecting the language to be used in a game on the display 8. For example, if the language type read by the card reader 16 from the smart card is English, a sentence “What language do you want to use?” is displayed together with language selection buttons 63a, 63b, 63c, 63d, 63e and 63f, each corresponding to “English”, “Japanese”, “French”, “German”, “Spanish” and “Chinese”, as shown in FIG. 38.

The sentence or the like for selecting the language to be used in a game are displayed on the display 8 with the language type read by the card reader 16 from the smart card. If an operation on a button indicating a player's rejection (e.g., the “NO” button 64b shown in FIG. 37) has been detected via the touchscreen 50, the terminal CPU 91 makes the conversation controller 1000 to execute corresponding processing and then displays a processing result thereof on the display 8 served as the output unit 1600.

Then, the terminal CPU 91 confirms whether or not a reply message in response to the output message in step S300f has been input (step S300g).

Here, if the message in step S300f has been output as sound, it can be confirmed whether or not the message has been input in response to the output by confirming whether or not the input unit 1100 of the conversation controller 1000 configured by the microphone 15 receives an input after the message has been output in step S300e. Alternatively, if the message in step S300f has been displayed on the display 8, it can be confirmed whether or not the message has been input in response to the output message by confirming whether or not a player's operation on the language selection buttons (e.g., the buttons 63a, 63b, 63c, 63d, 63e and 63f each corresponding to “English”, “Japanese”, “French”, “German”, “Spanish” and “Chinese” as shown in FIG. 38) displayed on the display 8 has been detected via the touchscreen 50.

Then, if a reply message in response to the output message in step S300f has not been input (NO in step S300g), the terminal CPU 91 repeats step S300g until a reply is input. On the other hand, if a reply message has been input (YES in step S300g), the terminal CPU 91 displays a bet screen 61 on the display 8 during the betting period of the roulette game in the language specified by the input message in step S300g (step S300h). Subsequently, the terminal CPU 91 terminates the language confirmation processing.

Here, if the message has been input as sound in step S300g, the language selected by the input message can be specified by analyzing contents of the sound message input into the microphone 15 using the conversation controller 1000. Alternatively, if the message has been input via a display screen on the display 8 in step S300g, the language selected by the input message can be specified by detecting contents of a player's operation onto the language selection buttons displayed on the display 8 by the terminal CPU 91 via the touchscreen 50.

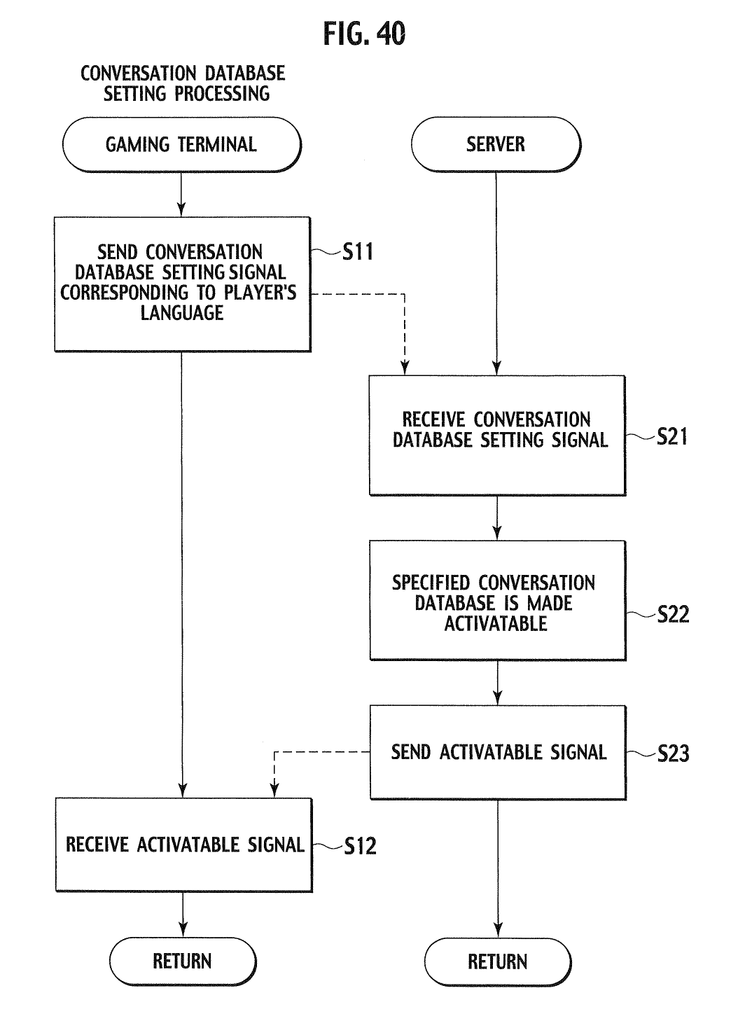

Next, the conversation database setting processing of step S301 in FIG. 33 will be explained with reference to a flow chart shown in FIG. 40.

The terminal CPU 91 of the gaming terminal 4a sends a signal for setting the conversation database corresponding to the player's language (e.g., Japanese) to the server 13 via the network based on the player's language determined in the language confirmation processing (step S11).

The server CPU 81 (see FIG. 6) of the server 13 receives the conversation database setting signal transmitted from the gaming terminal 4a (step S21) and makes a conversation database corresponding to the specified language activatable among the conversation database corresponding to plural languages in the HDD 34 (step S22).

Subsequently, the server CPU 81 sends an activatable signal indicating that the conversation database is being activatable to the gaming terminal 4a (step S23). The gaming terminal 4a receives the activatable signal (step S12). As a result, the conversation database corresponding to the player's language is made available in the gaming terminal 4a and the conversational processing using the conversation engine is made available.

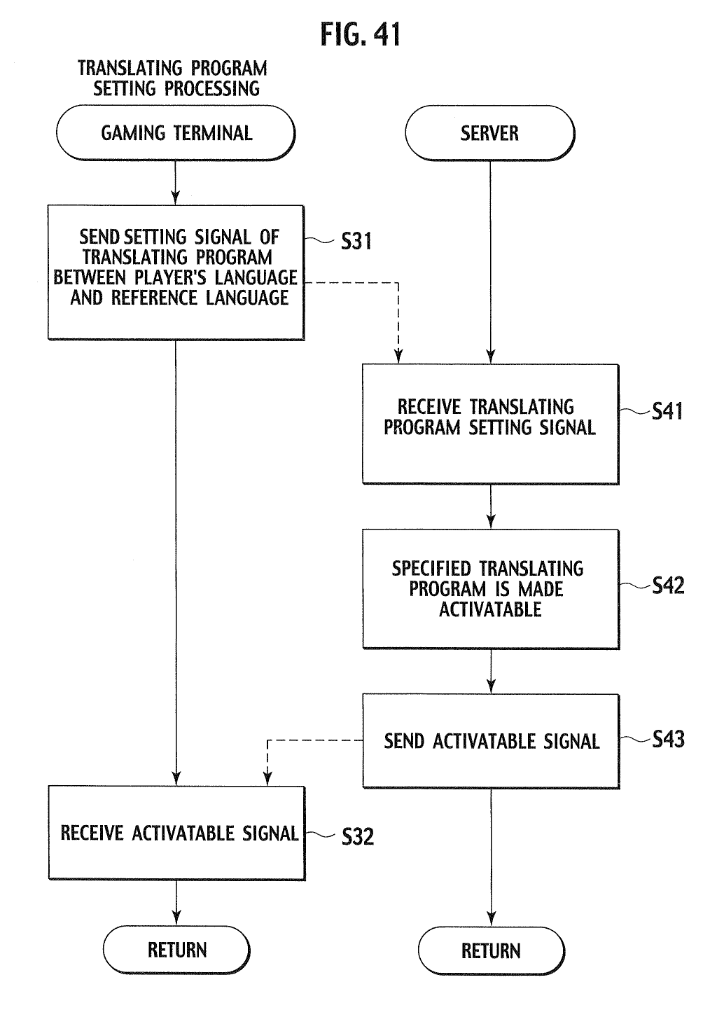

Next, the translating program setting processing of step S302 in FIG. 33 will be described with reference to a flow chart shown in FIG. 41.

The terminal CPU 91 of the gaming terminal 4a sends a setting signal of the translating program between the player's language (e.g., Japanese) and the reference language (e.g., English) to the server 13 via the network based on the player's language determined in the language confirmation processing (step S31).

The server CPU 81 (see FIG. 6) of the server 13 receives the translating program setting signal transmitted from the gaming terminal 4a (step S41) and makes a specified translating program (e.g., a “Japanese-English” translating program) activatable among translating programs corresponding to plural languages in the HDD 34 (step S42).

Subsequently, the server CPU 81 sends an activatable signal indicating that the translating program is being activatable to the gaming terminal 4a (step S43). The gaming terminal 4a receives the activatable signal (step S32). As a result, the translating program for translating the player's language into the reference language is made available in the gaming terminal 4a.

Then, conversations using the conversation engine corresponding to the player's language are made available by the above-mentioned conversation database setting processing being executed. Therefore, since conversations using the language of the player playing at each of the gaming terminals 4 (4a to 4i) are enabled, games can be processed smoothly. Furthermore, messages for each player can be translated into the player's language and displayed on the display 8 by the above-mentioned translating program setting processing being executed. Therefore, it becomes easier for the player to understand message contents.

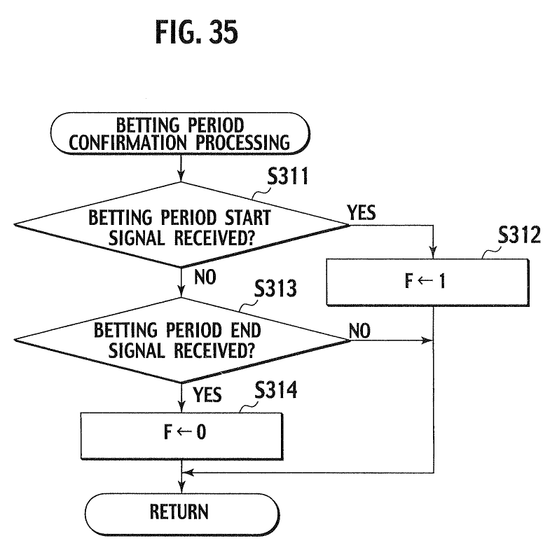

Next, the betting period confirmation processing of step S303 in FIG. 33 will be explained with reference to a flow chart shown in FIG. 35. As shown in FIG. 35, the terminal CPU 91 confirms whether or not the betting period start signal has been received from the server CPU 81 (step S311). If the betting period start signal has been received (YES in step S311), the terminal CPU 91 sets the flag F in the RAM 93 to “1” which indicates that it is under the betting period (step S312) and then terminates the betting period confirmation processing.

On the other hand, if the betting time start signal has not been received (NO in step S311), the terminal CPU 91 confirms whether or not the betting period end signal has been received from the server CPU 81 (step S313). If the betting period end signal has been received (YES in step S313), the terminal CPU 91 sets the flag F in the RAM 93 to “0” which indicates that it is not under the betting period (step S314) and then terminates the betting period confirmation processing. If the betting period end signal has not been received (NO in step S313), the terminal CPU 91 terminates the betting period confirmation processing.

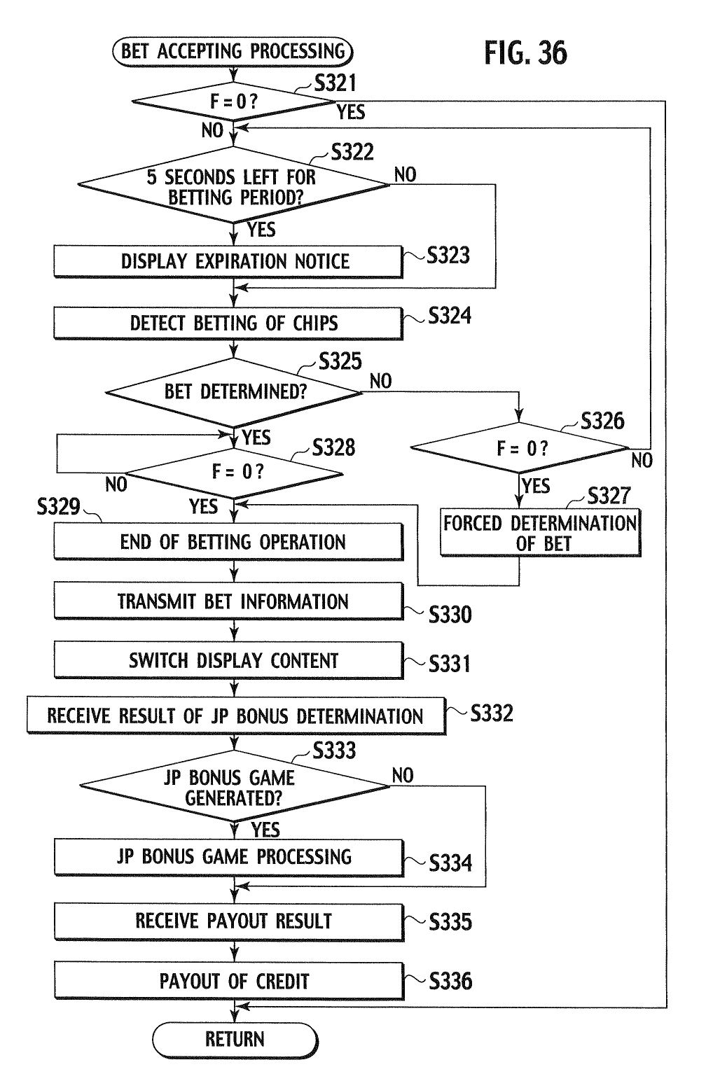

Next, in the bet accepting processing of step S304 in FIG. 33, as shown in FIG. 36, the terminal CPU 91 confirms whether or not the flag F in the RAM 93 is set to “0” (step S321). If the flag F is set to “0” (YES in step S321), the terminal CPU 91 terminates the bet accepting processing.

On the other hand, if the flag F is not set to “0” (NO in step S321), the terminal CPU 91 accepts a bet by a player. In this case, the terminal CPU 91 outputs a sound message “Bet acceptance starts.” from the speaker 10 using the conversation engine and the translating program. Specifically, the terminal CPU 91 sends a message data “Bet acceptance starts.” in the reference language (e.g., English) to the server 13 shown in FIG. 6. The server CPU 81 translates the message data into the player's language (e.g., Japanese) using the translating program (e.g., a “Japanese-English” translating program) stored in the HDD 34 and sends back the translated data to the gaming terminal 4a. Then, the terminal CPU 91 receives the translated data and converts the translated data into sound data using the conversation engine to outputs from the speaker 10. Therefore, the message “Bet acceptance starts.” is output from the speaker in the player's language (e.g., Japanese).

In addition, for example, if a player utters “Tell me how to bet! ” into the microphone 15, the conversation engine analyzes this uttered sentence using the Japanese conversation database and outputs a sound reply “Please insert medals into a medal insertion slot or press bet buttons.” from the speaker 10 in Japanese.

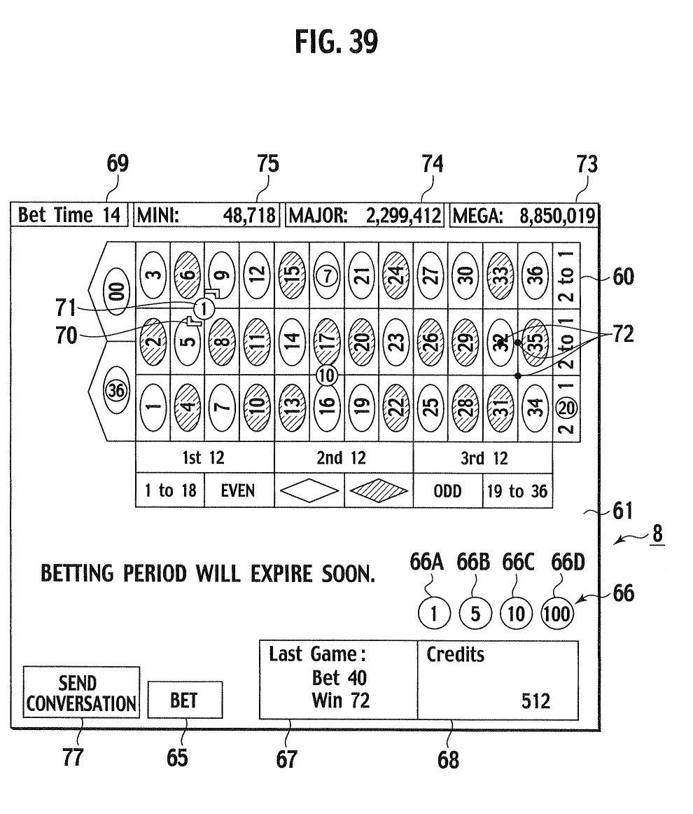

Next, the terminal CPU 91 confirms whether or not the remaining betting period has reached the last five seconds with the remaining time displayed on the bet time counter 69 being “5” (step S322). If the remaining time has reached the last 5 seconds (YES in step S322), the terminal CPU 91 displays a message to preannounce the end of the betting period on the bet screen 61 (step S323). Simultaneously, a sound message “Five seconds left for bets.” is output from the speaker 10 in the player's language. In addition, for example, if the player's language were Japanese, a sentence “Betting time will expire soon.” shown in FIG. 39 would be displayed in Japanese in the bet screen 61 on the display 8.

On the other hand, if the remaining time has not reached the last five seconds (it remains more than five seconds) (NO in step S322), the terminal CPU 91 proceeds to the step S324.

The terminal CPU 91 detects a bet placed by a player (step S324). A chip betting is detected by the player's touching on the bet area 72 in the betting board 60 or on the bet buttons 66 via the touchscreen 50. In addition, a bet can be accepted by way of a player's utterance into the microphone 15 and recognition of this utterance by the conversation engine. For example, a player makes an utterance “I will bet fifty credits.” after having selected a desired bet area 72 on the touchscreen 50. As a result, the utterance is detected via the microphone 15 and its sound data are analyzed by the conversation engine, and thereby a fifty-credit bet is confirmed. Furthermore, a reply sentence “Fifty credits have been bet!” is output from the speaker 10. After a bet with a chip(s) has been detected, a chip mark 71 with an amount of the bet chip(s) is displayed on a specified bet area 72 on the display 8.

Next, the terminal CPU 91 confirms whether or not the player's bet has been confirmed (step S325). The betting confirmation is detected by the player's touching on the bet confirmation button 65 on the display 8 via the touchscreen 50.

If it is confirmed that the player's bet has not been confirmed (NO in step S325), the terminal CPU 91 confirms whether or not the flag F in the RAM 93 is set to “0” (step S326). If the flag F is not set to “0” (NO in step S326), the terminal CPU 91 returns the processing to step S322.

On the other hand, if the flag F is set to “0” (YES in step S326), the terminal CPU 91 fixes the player's bet forcibly (step S327) and then sifts the processing to after-mentioned step 329.

Alternatively, if it is confirmed that the player's bet has been confirmed (YES in step S325), the terminal CPU 91 confirms whether or not the flag F in the RAM 93 is set to “0” or not (step S328). If the flag F is not set to “0” (NO in step S328), the terminal CPU 91 repeats step S328. On the contrary, if the flag F in the RAM 93 is set to “0” (YES in step S328), the terminal CPU 91 proceeds to step S329.

The terminal CPU 91 closes acceptation of betting operations via the touchscreen 50 (step S329). Thereafter, the terminal CPU 91 sends the player's betting information (the specified bet area 72, the number of bet chips (bet amount)) of the gaming terminal 4a to the server CPU 81 (step S330).

Next, the terminal CPU 91 changes the screen image on the display 8 (step S331). Specifically, the terminal CPU 91 firstly switches the screen image on the display 8 to the bet screen 61 including an indication of the betting period expiry.

Thereafter, the terminal CPU 91 receives the result of the JP bonus game determination processing executed by the server CPU 81 from the server CPU 81 (step S332). The result of the JP bonus game determination includes the information which indicates: whether or not to execute the JP bonus game at any of the gaming terminals 4; which of the nine gaming terminals 4 (4a to 4i) is to win the JP (or all of the gaming terminals 4 are to lose) in the case where it is determined to execute the JP bonus game; and which JP (“MEGA”, “MAJOR” or “MINI”) is to be awarded in the case of the JP winning.

Next, the terminal CPU 91 determines whether or not to execute the JP bonus game based on the result of the JP bonus game determination processing received in step S332 (step S333). In the case where it is determined to execute the JP bonus game in the gaming terminal 4a, the terminal CPU 91 executes a prescribed selection-type JP bonus game. And then, the terminal CPU 91 displays the bonus game result (whether or not the JP has been awarded) in the bet screen 61 on the display 8 (step S334) based on the determination result received in step S332.

In the case where it is determined not to execute the JP bonus game in the gaming terminal 4a in step S333, or after the processing in step S334, the terminal CPU 91 receives the payout result of credits from the server CPU 81 (step S335). Note that the payout result of credits includes the payout result for the game and the JP payout result for the JP bonus game. Here, in case of the payout of five hundred medals to be awarded for example, the terminal CPU 91 will output a sound message “Five hundred medals is awarded” from the speaker 10 in the player's language (for example, in Japanese).

Next, the terminal CPU 91 awards a payout according to the payout result received in step S335 (step S336). Specifically, the terminal CPU 91 stores, in the RAM 93, the credit data corresponding to the payout for the game and the credit data corresponding to the currently accumulated JP credits if the JP is awarded in the gaming terminal 4a. Then, when the payout button 5 has been touched, medals corresponding to the credits stored in the RAM 93 (usually, one medal per one credit) are paid out from the medal payout chute 12. Thereafter, the terminal CPU 91 terminates the bet accepting processing.

It is obvious from the above-mentioned description that the controller of the present invention is configured by the terminal CPU 91 in the roulette gaming machine 1 of the first embodiment.

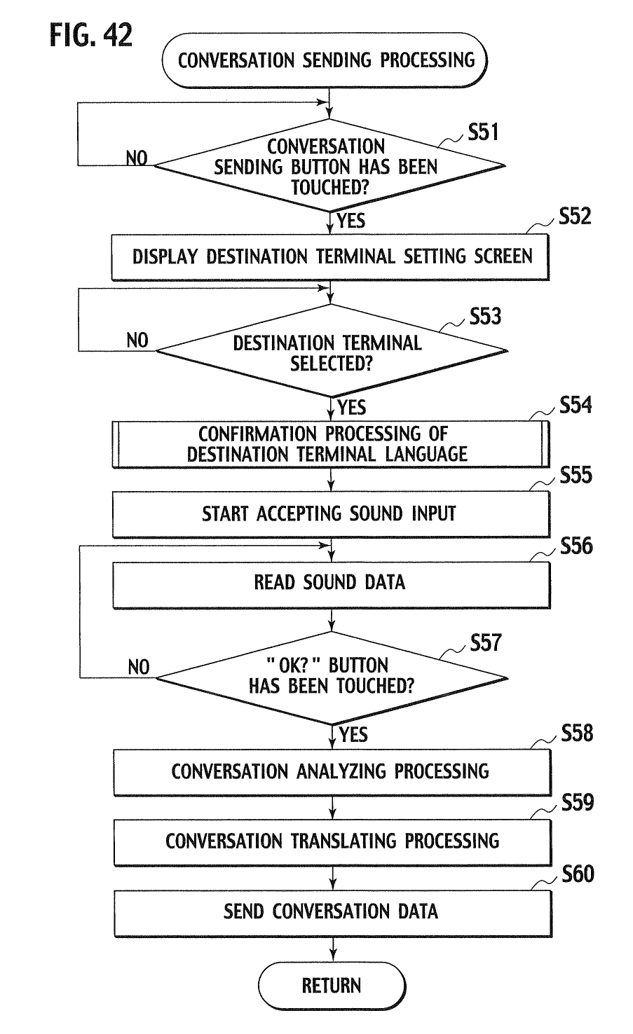

Next, the conversation sending/receiving processing of step S305 in FIG. 33 will be explained. FIG. 42 is a flow chart showing a process flow of the conversation sending processing. Note that operational procedures in the gaming terminal 4a are shown in FIG. 42. A number “1” is assigned to the gaming terminal 4a. Similarly, numbers “2” to “9” are assigned to the gaming terminals 4b to 4i. In addition, the player's language of the gaming terminal 4a is Japanese.

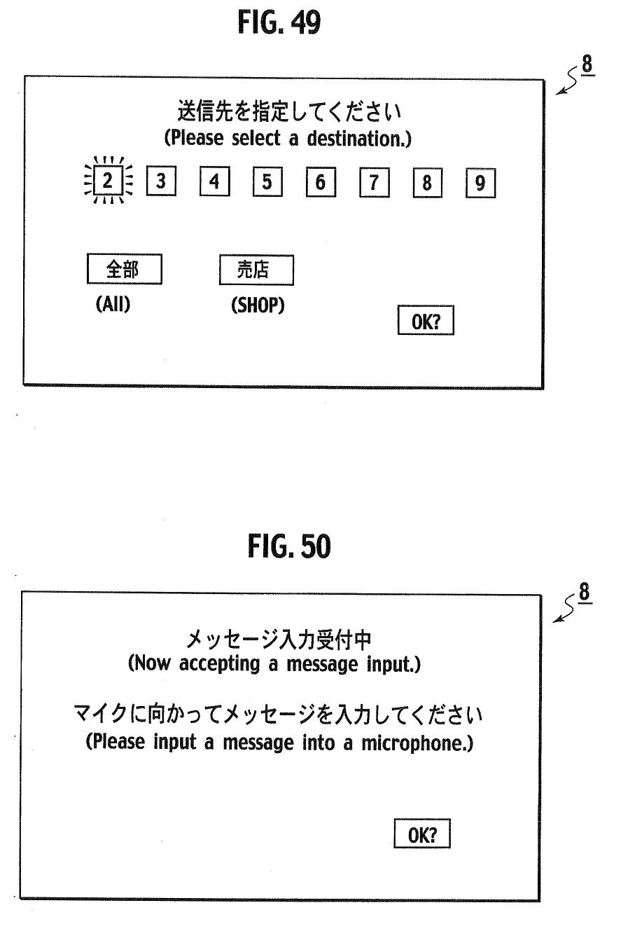

As shown in FIG. 42, the terminal CPU 91 determines whether or not the conversation send button 77 (see FIGS. 5 and 39) displayed on the display 8 has been touched (step S51). If the conversation send button 77 has been touched, a destination terminal setting screen shown in FIG. 49 is displayed (step S52). Specifically, displayed on the display 8 are “2” to “9” images for specifying a destination gaming terminal 4 (4b to 4i), an “All” image for specifying all of the gaming terminals 4 (4b to 4i), a “SHOP” image for specifying the shop terminal 86 and an “OK?” image for completing an input. Furthermore, a “Please select a destination. (in Japanese)” image is displayed.

A player can specify a conversation destination gaming terminal with reference to these images. For example, when the gaming terminal 4b numbered “2” has been specified, the terminal CPU 91 flashes the “2” image surroundingly to notify the player that the number “2” terminal has been selected by touching on the “2” image (YES in step S53).

Next, the terminal CPU 91 confirms the player's language on the gaming terminal 4b had been set as the destination (step S54). Details of this language confirmation processing will be explained later.

The terminal CPU 91 starts accepting a sound input (step S55). Specifically, the microphone 15 is made active to accept the player's conversation input. In this case, a “Now accepting a message input. (in Japanese)” image and a “Please input a message into a microphone. (in Japanese)” image are displayed on the display 8 as shown in FIG. 50. Furthermore, an “OK?” image is displayed. In this state, the player can input a conversation into the microphone 15. For example, if “This is terminal No. 1. Let me buy you something. (in Japanese)” has been uttered, the utterance is detected by the microphone 15 (step S56). The “OK?” image will be touched when the input has been completed (step S57).

If the “OK?” image has been touched (YES in step S57), the terminal CPU 91 completes the sound input. Subsequently, the input utterance is analyzed and a “[This is terminal No. 1. Let me buy you something.] (in Japanese)” image is displayed on the display 8 (step S58) as shown in FIG. 51, and furthermore, a “2” image indicating the destination gaming terminal 4b is also displayed. Concurrently, an “A message shown below has been accepted. (in Japanese)” image and an “OK?” image are also displayed to request a confirmation of the sentence. The player can confirm conversation contents had been input by himself or herself with reference to this display screen. If the displayed contents is not correct, the sound data input processing is executed again by touching a “RETRY (in Japanese)” image displayed at a lower-right corner.

Then, if the “OK?” image has been touched, the conversation contents are translated into the player's language of the destination gaming terminal 4b (step S59). Specifically, the conversation contents are translated into the player's language of the gaming terminal 4b confirmed in the process of step S54. For example, if the player's language of the gaming terminal 4b is Chinese, the “Japanese-English” and “Chinese-English” translating programs prepared in the server 13 are used to translate the sentences “This is terminal No. 1. Let me buy you something. (in Japanese)” into Chinese. Note that, if a “Japanese-Chinese” translating program were prepared, this translating program could be used.

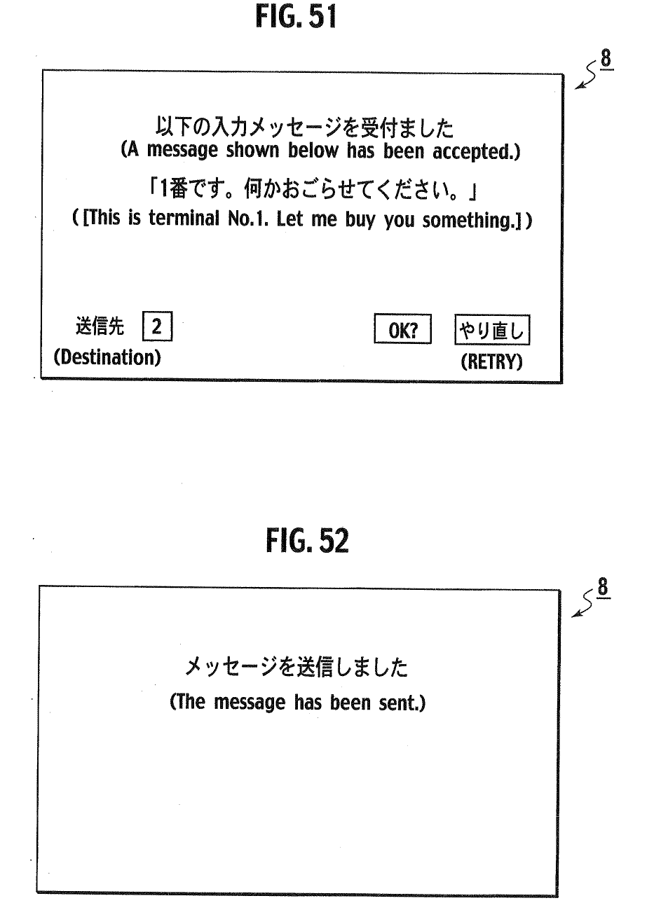

Subsequently, the sentences had been translated into Chinese are transmitted to the gaming terminal 4b via the network (step S60). After the transmission, a “The message has been sent (in Japanese)” image is displayed on the display 8 as shown in FIG. 52 to notify that the input sound by the player has been sent to the destination gaming terminal 4b. In this manner, the conversation sending processing is terminated.

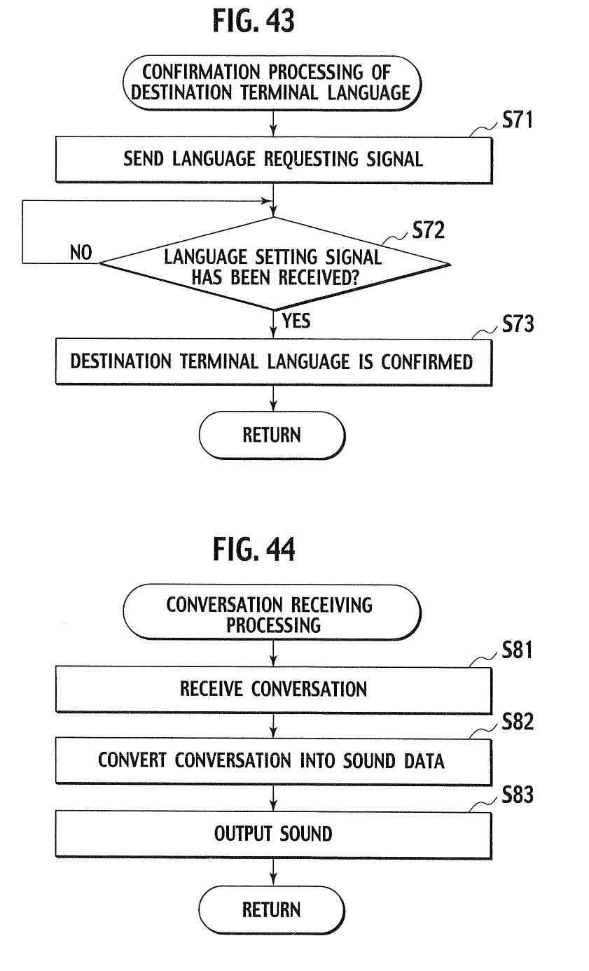

Next, the confirmation processing of the destination terminal language of step S54 in FIG. 42 will be explained with reference to a flow chart shown in FIG. 43.

The terminal CPU 91 sends a language requesting signal to the destination gaming terminal 4b (step S71). The language requesting signal is received by the gaming terminal 4b and then the gaming terminal 4b sends a player's language setting signal. For example, if the player's language on the gaming terminal 4b is Chinese, the language setting signal indicating that the language is Chinese is transmitted to the gaming terminal 4a.

Then, the terminal CPU 91 receives the language setting signal (YES in step S72) and confirms that the player's language on the destination gaming terminal 4b is Chinese (step S73). In this manner, the terminal CPU 91 can confirm the player's language on the destination gaming terminal 4b.

Next, conversation receiving processing on the gaming terminal 4b will be explained with reference to a flow chart shown in FIG. 44. When the conversation transmitted from the gaming terminal 4a has been received (step S81), the terminal CPU 91 of the gaming terminal 4b converts the conversation into sound data using the conversation engine (step S82). Then, the sound data are output from the speaker 10 (step S83).

For example, if a conversation “This is terminal No. 1. Let me buy you something. (in Chinese)” has been received, the conversation is converted into the sound data and output from the speaker 10. As a result, the player at the gaming terminal 4b can recognize the conversation contents transmitted from the gaming terminal 4a in Chinese as the player's language.

Then, if the player at the gaming terminal 4b uttered “I'll have beer. (in Chinese)” in response to the above-mentioned conversation, this utterance is converted into a conversation “I'll have beer. (in Japanese)” and transmitted to the gaming terminal 4a according to the procedures shown in FIG. 42. Sound data of the conversation are output from the speaker 10 of the gaming terminal 4a.

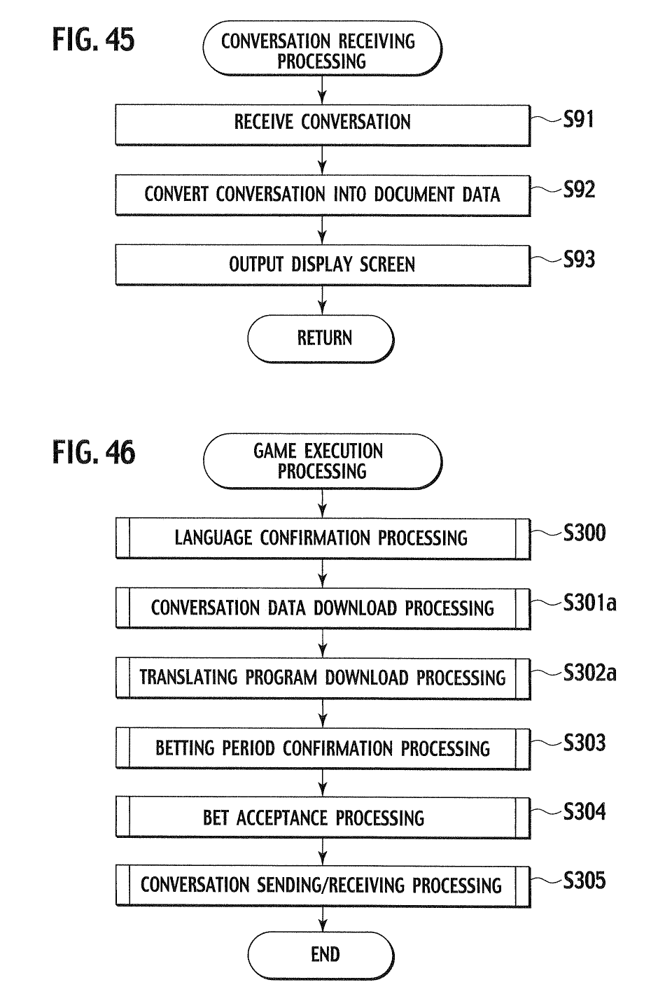

FIG. 45 is a flow chart showing alternative processes of the conversation receiving processing in the gaming terminal 4b.

When the conversation transmitted from the gaming terminal 4a has been received (step S91), the terminal CPU 91 of the gaming terminal 4b converts the conversation into document data (step S92). Then, the document data are displayed on the display 8 (step S93).

For example, if a conversation “This is terminal No. 1. Let me buy you something. (in Chinese)” is received, the conversation is converted into the document data and displayed on the display 8. As a result, the player at the gaming terminal 4b can recognize the conversation contents transmitted from the gaming terminal 4a as the document data.

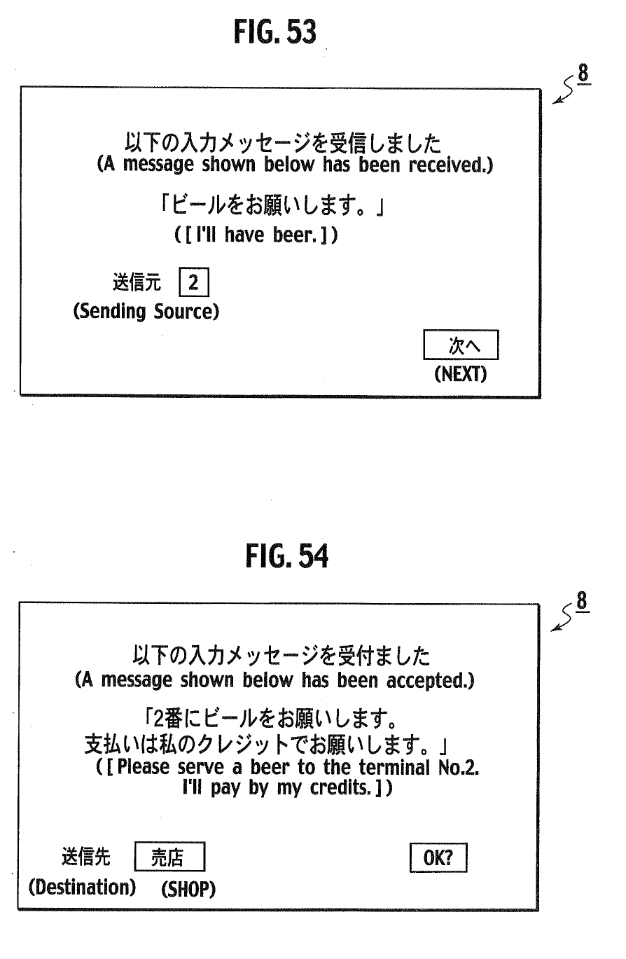

Then, if the player at the gaming terminal 4b uttered “I'll have beer. (in Chinese)” in response to the above-mentioned conversation, this utterance is converted into a conversation “I'll have beer. (in Japanese)” and transmitted to the gaming terminal 4a according to the procedures shown in FIG. 42. As shown in FIG. 53, “A message shown below has been received. [I'll have beer.] (in Japanese)” images are displayed on the display 8 of the gaming terminal 4a and a “2” image indicating a sending source is also displayed. Concurrently, a “NEXT” image is displayed at a lower-right corner to input a sound response thereto. If the “NEXT” image has been touched, the display screen shown in FIG. 49 is displayed for the above-mentioned conversation sending processing shown in FIG. 42.

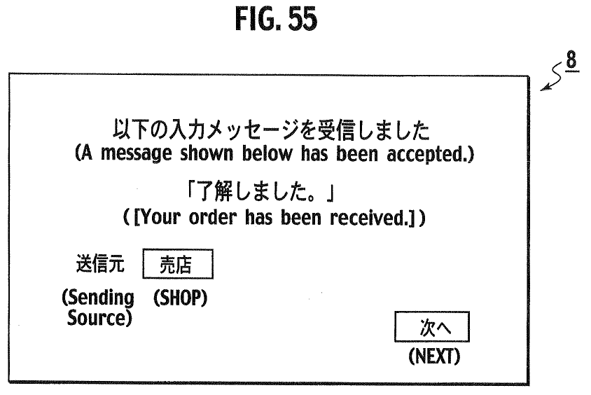

Subsequently, a conversation “Please serve a beer to the terminal No. 2. I'll pay by my credits. (in Japanese)” shown in FIG. 54 will be sent to the shop terminal 86 from the gaming terminal 4a by the above-mentioned conversation sending processing shown in FIG. 42. This conversation is sent after being translated into the language (e.g., English) of the shop terminal 86. As a result, a shop manager can recognize the conversation. Furthermore, as shown in FIG. 55, “A message shown below has been received. [Your order has been received.] (in Japanese)” images are displayed on the display 8 and a “SHOP” image indicating a sending source is also displayed. As a result, a beer is delivered to the player at the gaming terminal 4b and a beer fee is paid from the gaming terminal 4a. In this manner, a conversation between the gaming terminal 4 (4a to 4i) and the shop terminal 86 can be done.

In this manner, a player's language is confirmed by the conversation engine and a conversation with a player is done in the language in the gaming system according to the first embodiment. For example, if the player uses Japanese, information relating to a game will be given to the player as a sound message(s) in Japanese. In addition, a conversation uttered in Japanese by the player is analyzed to proceed a game. Furthermore, a message(s) on the display 8 will be displayed in the player's language. Therefore, the player can understand the sound message(s) output in the player's language and also play a game by an utterance(s) in the player's language.

In addition, since a conversation between the plural gaming terminals 4 (4a to 4i) can be sent and received, players using different languages can easily have a conversation.

Next, a second embodiment of the game execution processing will be explained. In the second embodiment, conversation data of the conversation database corresponding to the player's language are transmitted to the gaming terminal 4a among the conversation database corresponding to plural languages stored in the HDD 34 of the server 13. In addition, the translating program to be used is transmitted to the gaming terminal 4a among plural translating programs stored in the HDD 34. Then, the gaming terminal 4a downloads the conversation data and the translating program that have been transmitted to the second external storage unit 76. The terminal CPU 91 of the gaming terminal 4a executes a roulette game with the conversation data and the translating program that have been downloaded and also sends/receives a conversation to/from another gaming terminal 4 (4b to 4i).

Hereinafter, the game execution processing according to the second embodiment will be explained with reference to a flow chart shown in FIG. 46. As shown in FIG. 46, the terminal CPU 91 first executes the language identifying processing (step S300), then executes conversation data download processing (step S301a), then executes translating program download processing (step S302a), then executes the betting period confirmation processing (step S303), then executes the bet acceptance processing (step S304), and then executes the conversation sending/receiving processing (step S305).

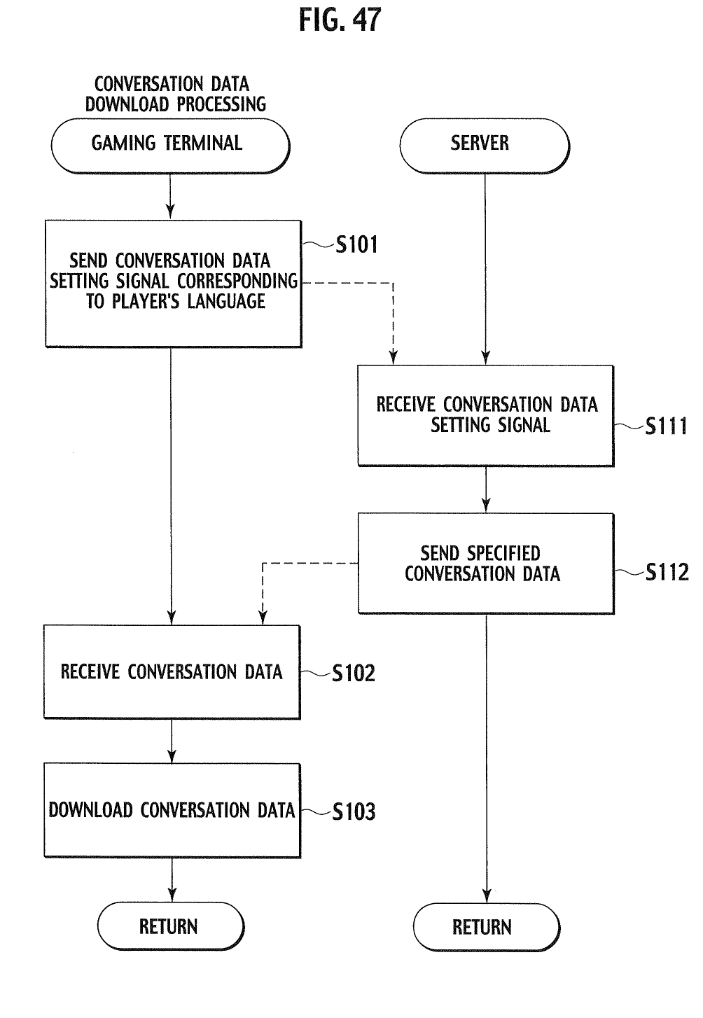

Since the language confirmation processing of step S300, the betting period confirmation processing of step S303, the bet acceptance processing of step S304 and the conversation sending/receiving processing of step S305 are similar to those of the above-described first embodiment, their description is omitted. Hereinafter, the conversation data download processing of step S301a will be explained with reference to a flow chart shown in FIG. 47.

The terminal CPU 91 of the gaming terminal 4a sends a conversation data setting signal corresponding to the player's language (e.g., Japanese) to the server 13 via the network based on the player's language determined in the language confirmation processing (step S101).

The server CPU 81 (see FIG. 6) of the server 13 receives the conversation data setting signal transmitted from the gaming terminal 4a (step S111) and then acquires the conversation data of the specified conversation database among conversation database corresponding to plural languages in the HDD 34 to send it to the gaming terminal 4a via the network (step S112).

The gaming terminal 4a receives the conversation data (step S102). Furthermore, the gaming terminal 4a downloads the received conversation data to the second external storage unit 76 (step S103).

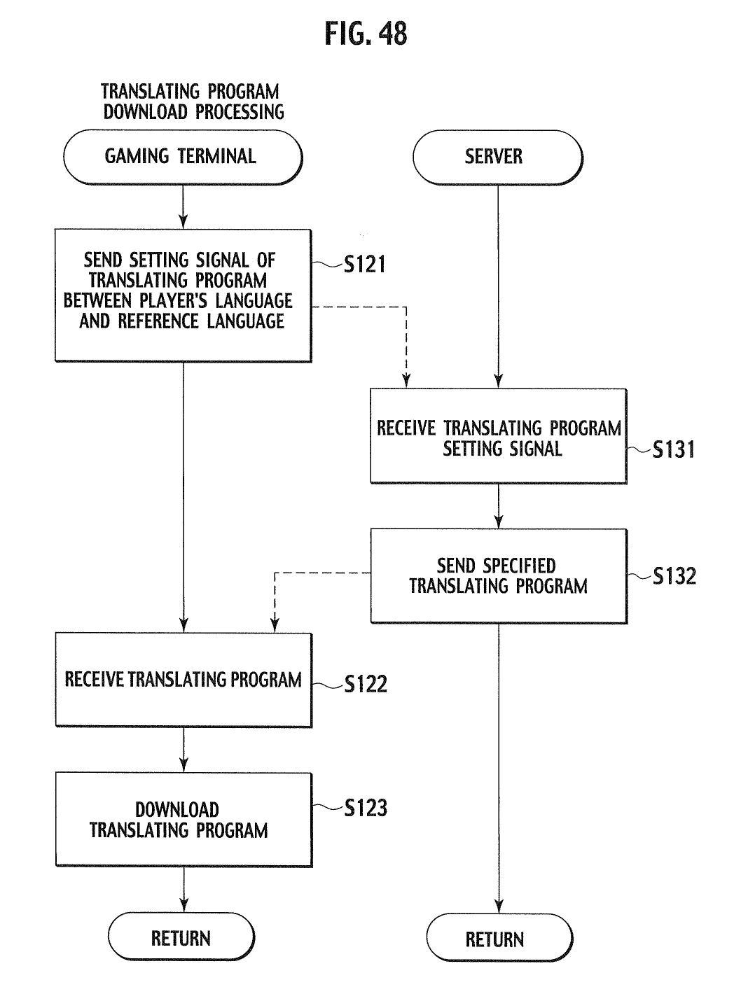

Next, the translating program download processing of step S302a in FIG. 46 will be explained with reference to a flow chart shown in FIG. 48.

The terminal CPU 91 of the gaming terminal 4a sends a setting signal of the translating program between the player's language (e.g., Japanese) and the reference language (e.g., English) to the server 13 via the network based on the player's language determined in the language confirmation processing (step S121).

The server CPU 81 (see FIG. 6) of the server 13 receives the translating program setting signal transmitted from the gaming terminal 4a (step S131) and reads out the specified translating program (e.g., a “Japanese-English” translating program) among plural translating programs in the HDD 34 to send it to the gaming terminal 4a via the network (step S132).

The gaming terminal 4a receives the translating program (step S122). Furthermore, the gaming terminal 4a downloads the received translating program to the second external storage unit 76 (step S123).

In this manner, since the conversation data used in the conversation engine is downloaded to the second external storage unit 76, a conversation with the player using this conversation data can be done. Furthermore, the translating program to be used for sending/receiving conversations between the gaming terminals 4 (4a to 4i) is similarly downloaded to the second external storage unit 76. Therefore, for example, in the case where the player's language of the gaming terminal 4a is Japanese and the player's language of the gaming terminal 4b is Chinese, a conversation input at the gaming terminal 4a is once translated into English by the translating program downloaded in the gaming terminal 4a and then the conversation which has been translated into English is transmitted to the gaming terminal 4b. Then, the conversation in English is translated into Chinese at the gaming terminal 4b by the translating program downloaded in the gaming terminal 4b to output as a sound. As a result, players using different languages can easily have a conversation.

Although embodiments of the present invention have been described as above, they are only presented as concrete examples, without particularly limiting the present invention. Concrete arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

For example, the roulette gaming machine is explained as examples in the above-mentioned first and second embodiments. However, the present invention can be applied to a gaming machine for another game such as a bingo game and a slot game.

In the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely explain the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of explanation. Additionally, although the processes in respective steps may be described using an expression common to human activities, the processes described in the present specification are executed, in principle, by a variety of devices. Furthermore, other arrangements required to execute respective steps are self-evident from the aforementioned description.

What is claimed is:

1. A gaming system comprising:
a host server; and
plural gaming terminals connected to the host server via a network, wherein
each of the gaming terminals comprises:
a display for displaying information on a game executed repeatedly,
a microphone for being input an utterance by a player,
a conversation engine for generating a reply to the input utterance by analyzing the utterance input into the microphone,
a speaker for outputting the reply generated by the conversation engine, and
a controller operable to:
(A) get the conversation engine to specify a language used by the player based on a manual operation by the player or the input utterance,
(B) execute a game according to a conversation with the player using the conversation engine corresponding to the language,
(C) receive an input of a message to be sent to another gaming terminal and translate the input message into a language used in the other gaming terminal using a translating program,
(D) send the translated message to the other gaming terminal, and
(E) provide a message sent from another gaming terminal to the player.

2. The gaming system according to claim 1, wherein
the controller is operable to convert the message sent from the other gaming terminal into sound data to output the message from the speaker.

3. The gaming system according to claim 1, wherein
the controller is operable to convert the message sent from the other gaming terminal into text data to display the message on the display.

4. A gaming system comprising:
a host server; and
plural gaming terminals connected to the host server via a network, wherein
the host server is provided with a conversation database of plural languages and plural translating programs between each of the plural language and a reference language, and
each of the gaming terminals comprises:
a display for displaying information on a game executed repeatedly,
a microphone for being input an utterance by a player,
a conversation engine for generating a reply to the input utterance by analyzing the utterance input into the microphone with reference to the conversation database,
a speaker for outputting the reply generated by the conversation engine, and
a controller operable to:
(A) get the conversation engine to specify a language used by the player based on a manual operation by the player or the input utterance,
(B) execute a game according to a conversation with the player using the conversation engine corresponding to the language,
(C) receive an input of a message to be sent to another gaming terminal and translate the input message into a language used in the other gaming terminal using the translating programs,
(D) send the translated message to the other gaming terminal, and
(E) provide a message sent from another gaming terminal to the player.

5. The gaming system according to claim 4, wherein
the controller is operable to convert the message sent from the other gaming terminal into sound data to output the message from the speaker.

6. The gaming system according to claim 4, wherein
the controller is operable to convert the message sent from the other gaming terminal into text data to display the message on the display.

7. A gaming system comprising:
a host server; and
plural gaming terminals connected to the host server via a network, wherein
the host server is provided with a conversation database of plural languages and plural translating programs between each of the plural language and a reference language, and
each of the gaming terminals comprises:
a display for displaying information on a game executed repeatedly,
a storing unit for storing conversation data stored in the conversation database and the translating programs,
a microphone for being input an utterance by a player,
a conversation engine for generating a reply to the input utterance by analyzing the utterance input into the microphone with reference to the conversation database,
a speaker for outputting the reply generated by the conversation engine, and
a controller operable to:
(A) get the conversation engine to specify a language used by the player based on a manual operation by the player or the input utterance,
(B) read out conversation data and a translating program corresponding to the player's language from the host server and store the conversation data and the translating program in the storing unit,
(C) execute a game according to a conversation with the player using the conversation engine,
(D) receive an input of a message to be sent to another gaming terminal and translate the input message into a language used in the other gaming terminal using the translating programs,
(E) send the translated message to the other gaming terminal, and
(F) provide a message sent from another gaming terminal to the player.

8. The gaming system according to claim 7, wherein
the controller is operable to convert the message sent from the other gaming terminal into sound data to output the message from the speaker.

9. The gaming system according to claim 7, wherein
the controller is operable to convert the message sent from the other gaming terminal into text data to display the message on the display.

10. A control method of a gaming system comprising:
specifying a language used by a player based on a manual operation or an input of an utterance into a microphone by a player at each of plural gaming terminals;
executing, in each of the gaming terminal, a game interactively, in which, the utterance input into the microphone is received, a reply to the input utterance is generated by a conversation engine and then the reply is output from a speaker as a sound in the game; and
translating, in case where a message is to be sent from one gaming terminal to another gaming terminal, the message input in the one gaming machine into a language used in the other gaming machine and sending the translated message to the other gaming machine.

11. The control method according to claim 10, wherein
the message sent from the other gaming terminal is converted into sound data to be output from the speaker.

12. The control method according to claim 10, wherein
the message sent from the other gaming terminal is converted into text data to be displayed on a display.
